(19) United States
(12) Patent Application Publication
(10) Pub. No.: US 2021/0062048 A1
(43) Pub. Date: Mar. 4, 2021

(54) TAPES WITH ELASTOMERIC BACKING LAYERS

(71) Applicant: 3M INNOVATIVE PROPERTIES COMPANY, St. Paul, MN (US)

(72) Inventors: Thomas B. Galush, Roseville, MN (US); David T. Amos, St. Paul, MN (US); Edward E. Cole, Woodbury, MN (US); Daniel R. Fronek, Woodbury, MN (US); Naiyong Jing, St. Paul, MN (US); Matthew J. Kryger, Hudson, WI (US); Kiu-Yuen Tse, Woodbury, MN (US); Scott A. Van Wert, St. Paul, MN (US)

(21) Appl. No.: 17/048,338

(22) PCT Filed: Apr. 11, 2019
(86) PCT No.: PCT/IB2019/052991

§ 371 Date: Oct. 16, 2020

Related U.S. Application Data
(60) Provisional application No. 62/660,727, filed on Apr. 20, 2018.

(51) Int. Cl. C09J 7/38; C09J 7/25

(52) U.S. Cl. CPC C09J 7/38; C09J 7/50; C09J 7/25

(57) ABSTRACT

Tapes including an elastomeric backing layer having two major surfaces, wherein the backing layer includes a high temperature resistant elastomer (e.g., a high consistency silicone rubber elastomer), and a pressure sensitive adhesive layer, wherein the pressure sensitive adhesive layer comprises a silicone pressure sensitive adhesive.

### BACKGROUND

Of all the thermal spray metallization processes, HVOF (High Velocity Oxygen Fuel), is widely considered to be one of the most severe due to both the heat and the impact force of the particles. Some sources report flame temperatures over 3000° C. and particle speeds over Mach 3. These extreme conditions make it difficult to provide a suitable masking solution. Hard masks, which are often made of stainless steel, can work in some HVOF spray coating applications, but are not a universal solution because of cost, long lead time to produce, lack of flexibility, mounting requirements, limited ability to create clean edge lines, etc. Some hard masks last a long time and can be reused if the shop routinely sprays the same part; however, many parts are more unique and/or the parts have a complex geometry, so in these applications metal hard masks are not a realistic solution. Because of these issues, the industry needs a reliable masking tape solution that can be used either alone or in conjunction with hard masks.

Many of the parts being coated are expensive to produce, with some costing over $100,000, so customers are very concerned about the potential of damaging the part or applying metal in areas where it could affect the use of the part.

Commercially available masking tapes sometimes fail during the substrate grit blast step; which is completed before the part can be coated. As a result, some companies will mask their parts using one tape for the grit blast step and another tape for the thermal spray process. These commercially available tapes can also fail during the HVOF spray process as well. Due to the limited confidence in existing HVOF masking tape solutions, many applicators struggle with the masking process. This process reduces productivity, increases costs, and can also cause quality issues.

A typical backing used in the thermal spray tapes available on the market today contains a metal foil or a glass/fabric scrim/cloth. The use of metal foil can limit conformability and make cutting difficult. Conformability is important for some thermal spray applications due to the complexity of the part geometry. The glass or fabric scrims/cloth can sometimes fray when cut and cause fiber contamination of the coatings.

Due to the wide variety of parts that are sprayed, many masking tape customers must keep a wide variety of tape widths on hand. An easy to cut, conformable tape, that does not fray allows the customer to easily customize the width or size of the masking tape to meet the needs of the specific application.

### SUMMARY

The present disclosure provides a tape that is conformable and easy to cut, thereby providing a product that is easily customized (e.g., with respect to widths or sizes) to meet the needs of a specific application. Such tapes include an elastomeric backing layer. In some embodiments, such tapes include a unique combination of components (e.g., backing, primer, and pressure sensitive adhesive) that can be used, for example, in a high temperature process, particularly in a thermal spray process such as HVOF.

In certain embodiments, a tape is provided that includes an elastomeric backing layer having two major surfaces, a flexible intermediate layer disposed on a first major surface of the backing layer, and a pressure sensitive adhesive layer disposed on the flexible intermediate layer (opposite the backing layer), wherein the tape has a tensile elongation of at least 100%, according to the Tensile Properties—Method B Test (in the Examples Section). The flexible intermediate layer includes a cured epoxy-based material. The backing layer includes a high consistency silicone rubber elastomer. The pressure sensitive adhesive layer includes a silicone pressure sensitive adhesive. In some embodiments, the tape further includes a release liner (e.g., a fluoropolymer-coated release liner) disposed on the pressure sensitive adhesive layer.

In certain embodiments, a tape is provided that includes an elastomeric backing layer having two major surfaces, a pressure sensitive adhesive layer disposed on a first major surface of the elastomeric backing layer, and a top layer comprising an inorganic oxide network disposed on a second major surface of the elastomeric backing layer. The backing layer includes a high temperature resistant and flame resistant elastomer (e.g., a high consistency silicone rubber elastomer). The pressure sensitive adhesive layer includes a silicone.

In certain embodiments, a tape includes an elastomeric backing layer having two major surfaces, a first pressure sensitive adhesive layer disposed on a first major surface of the elastomeric backing layer, and a second pressure sensitive adhesive layer disposed on a second major surface of the elastomeric backing layer, wherein the tape has a tensile elongation of at least 100%, according to the Tensile Properties—Method B Test (in the Examples Section). The backing layer includes a high consistency silicone rubber elastomer. The pressure sensitive adhesive layers include the same or different pressure sensitive adhesives. In some embodiments, a release liner is disposed on each of the pressure sensitive adhesive layers, which is removed upon application of the tape to a desired substrate.

The present disclosure provides tapes with significant toughness. In certain embodiments, the tapes are resistant to flames and high temperature breakdown (i.e., the high temperatures that can occur during a high temperature process). In certain embodiments, tapes of the present disclosure are also resistant to wear from grit blast, and the high velocity particles and gases and the high gas pressures that occur when used during an HVOF thermal spray coating process.

### Definitions

As used in this patent application:

The term “top” refers to the position of an element of a tape with respect to horizontially disposed upwardly facing substrate.

The term “disposed on” refers to a material that may be directly or indirectly (e.g., through an intervening tie layer) deposited on (e.g., coated on) another layer or substrate.

The term “aliphatic” refers to C1-C40, suitably C1-C30, straight or branched chain alkenyl, alkyl, or alkynyl, which may or may not be interrupted or substituted by one or more heteroatoms such as O, N, or S.

The term “cycloaliphatic” refers to cyclized aliphatic C3-C30, suitably C3-C20, groups and includes those interrupted by one or more heteroatoms such as O, N, or S. Examples include cyclopentyl, cyclohexyl, cycloheptyl, and the like.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkenyl group” means an unsaturated, linear or branched hydrocarbon group with one or more carbon-carbon double bonds, such as a vinyl group.

The term “alkynyl group” means an unsaturated, linear or branched hydrocarbon group with one or more carbon-carbon triple bonds.

The term “alkoxy” refers to refers to a monovalent group having an oxy group bonded directly to an alkyl group.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of “alkylene” groups include methylene, ethylene, propylene, 1,4-butylene, 1,4-cyclohexylene, and 1,4-cyclohexyldimethylene.

The term “aromatic” refers to C3-C40, suitably C3-C30, aromatic rings including both carboxyclic aromatic groups as well as heterocyclic aromatic groups containing one or more of the heteroatoms, O, N, or S, and fused ring systems containing one or more of these aromatic groups fused together.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. Unless otherwise specified, arylene groups often have 6 to 20 carbon atoms, 6 to 18 carbon atoms, 6 to 16 carbon atoms, 6 to 12 carbon atoms, or 6 to 10 carbon atoms.

The term “aralkyl” refers to a monovalent group that is an alkyl group substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms and an aryl portion often has 6 to 20 carbon atoms, 6 to 18 carbon atoms, 6 to 16 carbon atoms, 6 to 12 carbon atoms, or 6 to 10 carbon atoms.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” it is meant including, and limited to, whatever follows the phrase “consisting of” Thus, the phrase “consisting of” indicates that the listed elements are required or mandatory, and that no other elements may be present. By “consisting essentially of” it is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits under certain circumstances. Other embodiments may also be preferred, however, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements (e.g., preventing and/or treating an affliction means preventing, treating, or both treating and preventing further afflictions).

Herein, various sets of numerical ranges (for example, of the number of carbon atoms in a particular moiety, of the amount of a particular component, or the like) are described, and, within each set, any lower limit of a range can be paired with any upper limit of a range. Such numerical ranges also are meant to include all numbers subsumed within the range (for example, 1 to 5 includes 1, 1.5, 2, 2.75, 3, 3.80, 4, 5, and so forth).

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWING

FIG. 1 is a schematic representation of a cross-sectional view of a tape of the present disclosure (relative thicknesses of layers are not shown to scale).

FIG. 2 is a schematic representation of a cross-sectional view of a tape of the present disclosure (relative thicknesses of layers are not shown to scale).

FIG. 3 is a schematic representation of a cross-sectional view of a tape of the present disclosure (relative thicknesses of layers are not shown to scale).

FIG. 4 is a schematic representation of a cross-sectional view of a tape of the present disclosure (relative thicknesses of layers are not shown to scale).

FIG. 5 is a schematic representation of a cross-sectional view of a tape of the present disclosure (relative thicknesses of layers are not shown to scale).

FIG. 6 is a schematic representation of a cross-sectional view of a tape of the present disclosure (relative thicknesses of layers are not shown to scale).

### DETAILED DESCRIPTION

The present disclosure provides a tape that is conformable and easy to cut, thereby providing a product that is easily customized (e.g., with respect to widths or sizes) to meet the needs of a specific application. Such tapes include an elastomeric backing layer. In some embodiments, such tapes include a unique combination of components (e.g., backing, flexible intermediate layer, and pressure sensitive adhesive) that can be used, for example, in a high temperature process, particularly in a thermal spray process such as HVOF.

The tapes of the present disclosure may be used in masking applications (referred to as masking tapes), particularly in thermal spray processes (referred to as thermal spray masking tapes). The tapes may be used particularly in high temperature masking applications, with or without high impact resistance, and flame exposure applications, such as with welding splatter masking, powder coating masking (some require a grit blast step), regular grit blasting applications, etc. The tapes of the present disclosure could also be used to provide a cushion between electronic parts to improve robustness. In certain embodiments, the tapes of the present disclosure are also naturally thermal insulators.

In certain embodiments, a tape of the present disclosure has a tensile elongation of at least 100%, at least 200%, at least 300%, at least 400%, at least 500%, or at least 600%, according to the Tensile Properties—Method B Test. In certain embodiments, a tape is not quite as flexible, and may have a tensile elongation of at least 5%, at least 10%, at least 20%, at least 30%, at least 40%, at least 50%, at least 60%, at least 70%, at least 80%, or at least 90%, according to the Tensile Properties—Method B Test.

Tensile elongations of at least 100% are typically not possible in tapes that include fiber reinforcement, such as those that include fibrous scrims (e.g., nonwoven or woven fiber layers, such as glass cloths). Thus, in certain embodiments, a tape includes an elastomeric backing layer that is preferably a non-fiber reinforced backing layer. In certain embodiments, a tape of the present disclosure includes no fiber reinforcement (whether in the backing layer or other layer). In certain embodiments, a tape of the present disclosure does not include metal foils, metallized polymer films, or ceramics (e.g., ceramic sheet materials), as such layers could adversely impact the desired tensile elongation of the tapes of the present disclosure.

The backing is a highly conformable, highly abrasion resistant, tough, easy-to-cut/trim elastomeric backing layer (e.g., a silicone elastomer-containing backing), preferably that can withstand typical HVOF spray conditions (e.g., from a liquid-fueled or a gas-fueled HVOF coating system), e.g., up to 10 mils (about 250 micrometers) of spray thickness, as well as the grit-blast process that is used to roughen up the surface prior to HVOF spray coating. To “withstand typical HVOF spray conditions” means that the edges of the backing layer are not frayed and/or the thickness of the backing layer is not eroded to the extent that the tape no longer provides a masking or protective function. That is, although erosion of the backing layer may occur in an HVOF process, it is not eroded so much that the tape no longer masks or protects the desired portions of the article being sprayed.

The pressure sensitive adhesive (PSA) is preferably a high temperature PSA that offers excellent performance including the ability to withstand typical HVOF spray conditions. To “withstand typical HVOF spray conditions” means that the adhesive does not fail such that the tape no longer provides a masking or protective function. Typically, HVOF spraying is performed at angles of approximately 90 degrees (varying between 75 and 93 degrees) relative to the plane of the substrate being coated, although angles more severe may be possible (e.g., approaching directly against the edge of the tape).

Thus, in certain embodiments, the components of the tapes are selected such that a tape “withstands typical HVOF spray conditions.” One set of HVOF spray conditions is defined by the HVOF Spray Test in the Examples Section. To withstand such conditions, a tape of the present disclosure should adhere to the article, the edges of the backing layer should not be significantly damaged (e.g., fray), and/or the thickness of the backing layer should not erode to the extent that the tape no longer provides a masking and protection function (although some minor edge eroding may occur). In certain embodiments, the components of the tapes are selected such that a tape maintains its masking and protection function during exposure to the grit blast portion of the HVOF Spray Test (and the entire HVOF Spray Test) described in the Examples Section.

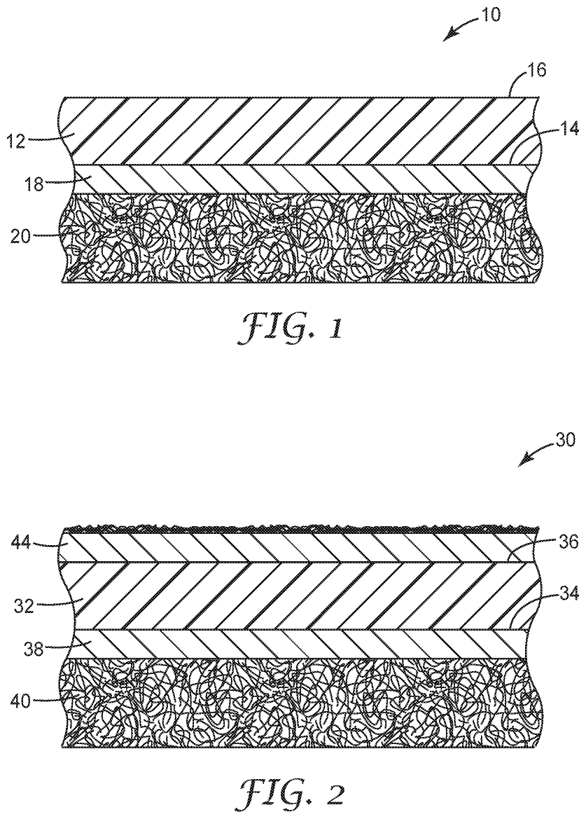

In certain embodiments, as shown in FIG. 1, a tape 10 is provided that includes an elastomeric backing layer 12 having two major surfaces 14 and 16, a flexible intermediate layer 18 disposed on a first major surface 14 of the backing layer, and a pressure sensitive adhesive layer 20 disposed on the flexible intermediate layer 18, wherein the tape has a tensile elongation of at least 100%, according to the Tensile Properties—Method B Test. In some embodiments, the tape further includes a release liner (e.g., a fluoropolymer-coated release liner) (not shown) disposed on the pressure sensitive adhesive layer 20.

In certain embodiments, as shown in FIG. 2, a tape 30 is provided that includes an elastomeric backing layer 32 having two major surfaces 34 and 36, a flexible intermediate layer 38 disposed on a first major surface 34 of the backing layer, a (first) pressure sensitive adhesive layer 40 disposed on the flexible intermediate layer 38, a release liner (not shown) disposed on the pressure sensitive adhesive layer 40, and a top layer 44 disposed directly on a second major surface 36 of the backing layer 32. Such top layer 44 may include an inorganic oxide matrix or a second pressure sensitive adhesive. If the top layer 44 includes a pressure sensitive adhesive (“top layer pressure sensitive adhesive”), the two pressure sensitive adhesives may be the same or different.

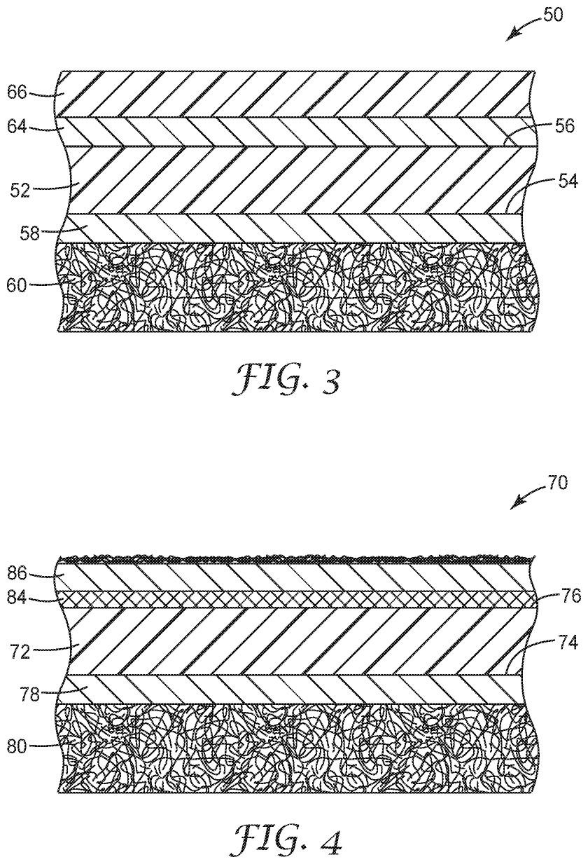

In certain embodiments, as shown in FIG. 3, a tape 50 is provided that includes an elastomeric backing layer 52 having two major surfaces 54 and 56, a first flexible intermediate layer 58 disposed on a first major surface 54 of the backing layer, a (first) pressure sensitive adhesive layer 60 disposed on the flexible intermediate layer 58, a release liner (not shown) disposed on the pressure sensitive adhesive layer 60, a second flexible intermediate layer 64 disposed directly on a second major surface 56 of the backing layer 52, and a top layer 66 disposed on the second flexible intermediate layer 64. The two flexible intermediate layers 58 and 64 may include the same or different materials. The top layer 66 may include an inorganic oxide matrix or a second pressure sensitive adhesive. If the top layer 66 includes a pressure sensitive adhesive (“top layer pressure sensitive adhesive”), the two pressure sensitive adhesives may be the same or different.

In certain embodiments, as shown in FIG. 4, a tape 70 is provided that includes an elastomeric backing layer 72 having two major surfaces 74 and 76, a flexible intermediate layer 78 disposed on a first major surface 74 of the backing layer, a (first) pressure sensitive adhesive layer 80 disposed on the flexible intermediate layer 78, a release liner (not shown) disposed on the pressure sensitive adhesive layer 80, a primer layer 84 disposed directly on a second major surface 76 of the backing layer 72, and a top layer 86 disposed on the primer layer 84. The top layer 86 may include an inorganic oxide matrix or a second pressure sensitive adhesive. If the top layer 86 includes a pressure sensitive adhesive, the two pressure sensitive adhesives may be the same or different.

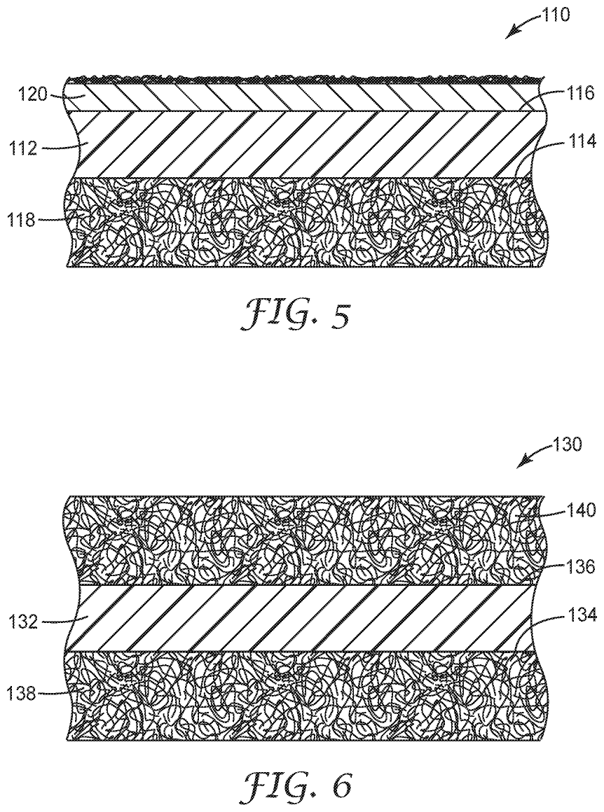

In certain embodiments, as shown in FIG. 5, a tape 110 is provided that includes an elastomeric backing layer 112 having two major surfaces 114 and 116, a pressure sensitive adhesive layer 118 disposed on a first major surface 114 of the elastomeric backing layer 112, and a top layer 120 comprising an inorganic oxide network disposed on a second major surface 116 of the elastomeric backing layer 112. The pressure sensitive adhesive layer 118 includes a silicone.

In certain embodiments, as shown in FIG. 6, a tape 130 includes an elastomeric backing layer 132 having two major surfaces 134 and 136, a first pressure sensitive adhesive layer 138 disposed on a first major surface 134 of the elastomeric backing layer 132, and a second pressure sensitive adhesive layer 140 disposed on a second major surface 136 of the elastomeric backing layer 132, wherein the tape 130 has a tensile elongation of at least 100%, according to the Tensile Properties—Method B Test. The pressure sensitive adhesive layers 138 and 140 include the same or different silicone pressure sensitive adhesives. In some embodiments, release liners (not shown) may be disposed on each of the pressure sensitive adhesive layers 138 and 140.

Tapes of the present disclosure possess significant toughness. In certain embodiments, the tapes are resistant to flames and high temperature breakdown (i.e., the high temperatures that can occur during a high temperature process (e.g., up to about 500° F.)). In certain embodiments, tapes of the present disclosure are particularly advantageous as they also possess resistance to wear from grit blast, and the high velocity particles and gases and the high gas pressures that occur when used during an HVOF thermal spray coating process.

Typically, in a high velocity oxygen fuel (HVOF) spraying process a mixture of gaseous or liquid fuel and oxygen is fed into a combustion chamber, where they are ignited and combusted continuously. The resultant hot gas emanates through a converging-diverging nozzle at, e.g., a pressure close to 1 MPa. The fuels can be gases (e.g., hydrogen, methane, propane, propylene, acetylene, natural gas) or liquids (e.g., kerosene, etc.). The jet velocity at the exit of the barrel (>1000 m/s) exceeds the speed of sound, sometimes by as much as 7 times the speed of sound. A powder feed stock is injected into the gas stream, which accelerates the powder, e.g., up to 800 m/s (Mach 2.7). The stream of hot gas and powder is directed towards the surface to be coated. The powder partially melts in the stream, and deposits on the substrate. Common powders include tungsten carbide, chromium carbide, and alumina. Such coatings typically provide corrosion resistance.

In certain embodiments, tapes of the present disclosure are particularly advantageous as they possess resistance to flames and to breakdown at high temperatures (e.g., temperatures of up to 500° F. (260° C.)).

In certain embodiments, tapes of the present disclosure are particularly advantageous as they possess resistance to flames, to breakdown at high temperatures (e.g., temperatures of up to 500° F. (260° C.)), high particle velocities (e.g., particle velocity from 800 meters per second (m/s) to 1000 m/s or even as high as 1100 m/s), and high gas velocities of up to 2130 m/s at the exit of the barrel when used during an HVOF thermal spray coating process.

In certain embodiments, tapes of the present disclosure show good aging performance. By this it is meant that over time the various adhesive properties remain generally stable, although some drop in properties over time is typically expected. In order to evaluate these properties, various heating and/or humidity conditions can be used in an attempt to accelerate and imitate the aging process. Preferably, any drop in measured adhesive properties is less than 30% (i.e., retaining at least 70% of adhesive properties) after aging for either 1 week at 150° F. (66° C.), 2 weeks at 90° F. (32° C.) and 90% relative humidity (RH), or for 4 weeks at 120° F. (49° C.). Preferably, a drop in flexible intermediate layer aging performance is shown by a drop in adhesion values of no more than 14% (i.e., retaining greater than 86% of the adhesion) after 1 week at 150° F. (66° C.). Preferably, a top layer aging performance is shown by a drop in adhesion values of no more than 23% (i.e., retaining greater than 77% of the adhesion) after aging for either 2 weeks at 90° F. (32° C.) and 90% relative humidity (RH), or 4 weeks at 120° F. (49° C.).

### Backing Layer

Backing layers of the tapes of the present disclosure include an elastomeric material. In this context, an elastomeric material is a polymer that has rubber-like properties, i.e., a material that regains its original shape when a load is removed from it. Various combinations (e.g., blends) of suitable elastomers may be used in backing layers if desired.

In certain embodiments, the backing layer of tapes of the present disclosure is flexible. In this context it is a material that does not crack according to the Cylindrical Mandrel Bend Test. In certain embodiments, the backing layer has a tensile elongation of at least 100%, at least 200%, at least 300%, at least 400%, at least 500%, or at least 600%, according to the Tensile Properties—Method C Test. In certain embodiments, the backing layer is not quite as flexible, and may have a tensile elongation of at least 5%, at least 10%, at least 20%, at least 30%, at least 40%, at least 50%, at least 60%, at least 70%, at least 80%, or at least 90%, according to the Tensile Properties—Method C Test.

In certain embodiments, materials for the backings are high temperature resistant elastomers (i.e., those elastomers that resist temperatures that can occur during a high temperature process ((e.g., up to about 500° F.)). In certain embodiments, materials for the backings are also flame resistant elastomers.

Suitable polymeric materials for the backing layer include thermoset polymers and high melt temperature thermoplastic polymers (e.g., those having a Vicat Softening Point temperature higher than that of the exposure temperature) that are also elastomeric.

Typical elastomeric materials include elastomers such as a fluoroelastomer (FKM), a fluorosilicone (FVMQ), a perfluoroelastomer (FFKM), a silicone, or a polydimethylsiloxane.

In certain embodiments, a backing layer of a tape of the present disclosure includes a high consistency silicone elastomer (i.e., a silicone rubber or silicone rubber elastomer). A high consistency silicone rubber elastomer is a common term used in the silicone rubber industry. Suitable polymers used in silicone elastomers are of the following general structure (Formula I):

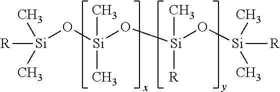

wherein each R independently represents —OH, —CH═CH₂, —CH₃, or another alkyl or aryl group, and the degree of polymerization (DP) is the sum of subscripts x and y. For high consistency silicone rubber elastomers, the DP is typically in the range of 5000 to 10,000. Thus, the molecular weight of the polymers, which are generally called gums, used in the manufacture of high consistency silicone elastomers ranges from 350,000 to 750,000 or greater. In liquid silicone rubber elastomers, the DP of the polymers used typically ranges from 10 to 1000, resulting in molecular weights ranging from 750 to 75,000. The polymer systems used in the formulation of these elastomers can be either a single polymer species or a blend of polymers containing different functionalities or molecular weights. The polymers are selected to impart specific performance attributes to the resultant elastomer products. For more information, see the article entitled “Comparing Liquid and High Consistency Rubber Elastomers: Which Is Right For You?” at http://www.mddionline.com/article/comparing-liquid-and-high-consistency-silicone-rubber-elastomers-which-right-you.

In certain embodiments, an elastomeric backing layer (e.g., silicone elastomer and optional additives, such as fillers) has a Shore A hardness of at least 40, at least 45, at least 50, or at least 55. In certain embodiments, the silicone elastomer backing layer has a Shore A hardness of up to 80, or up to 75.

In certain embodiments, an elastomeric backing layer (e.g., silicone elastomer and optional additives, such as fillers) has a toughness, which is the area under the stress-strain curve, and reported as energy per unit volume at break in megaPascals (MPa), of greater than 25 MPa or greater than 30 MPa. Generally, the higher the toughness the better, so there is no maximum, although typically an elastomeric backing layer has a toughness (i.e., an energy/volume at break) of up to 60 MPa.

In certain embodiments, an elastomeric backing layer (e.g., silicone elastomer and optional additives, such as fillers) has a tan(δ) at 10000 Hz and 20° C. of greater than 0.04, greater than 0.099, greater than 0.110, greater than 0.120, or greater than 0.130.

Typically, an elastomeric backing layer, particularly a silicone elastomer backing layer, includes an addition cured material, a condensation cured material, or a peroxide cured material. In certain embodiments, the elastomeric backing layer is an addition cured material.

In certain embodiments, the silicone elastomer backing layer is a product of a platinum-catalyzed addition cured reaction. In certain embodiments, the silicone elastomer backing layer is a product of a platinum-catalyzed addition cure reaction of a reaction mixture comprising vinyl-functional polydimethylsiloxane and a methyl hydrogen polysiloxane.

In some other embodiments, the silicone elastomer backing layer can be made using a peroxide agent as a curative (i.e., it is a peroxide cured material).

In certain embodiments, the elastomeric backing layer is a non-reticulated (i.e., non-foamed) backing layer (i.e., substantially free of cells or voids). Certain previous products included a reticulated silicone rubber backing. Adding large air holes into the backing would likely reduce the strength of the silicone; however, in certain embodiments, the elastomeric backing layer may include cells or voids (e.g., closed cells).

In certain embodiments, the elastomeric backing layer is a non-fiber reinforced backing layer. Fiber reinforced backings, such as those that include a woven or nonwoven fabric or scrim may be detrimental to performance of the tape by making the tape less conformable. Also, the presence of fibers may limit the ability of the backing layer to absorb energy because it is constrained.

In certain embodiments, the elastomeric backing layer further includes one or more fillers and/or other additives mixed therein. In certain embodiments, the elastomeric backing layer further includes a non-fibrous filler mixed therein, although nano-scale fillers may be acceptable. In certain embodiments, the elastomeric backing layer further includes an inorganic filler mixed therein. In certain embodiments, the inorganic filler includes silica, ceramic powder, metal particles, glass particles, metal oxides, or combinations thereof. In certain embodiments, the inorganic filler comprises silica. In certain embodiments, the filler is a micropowder such as polytetrafluoroethylene to improve abrasion resistance.

In certain embodiments, the elastomeric backing layer further includes a pigment (e.g., carbon black), a heat stabilizer, an accelerator, an activator, a blowing agent, an adhesion promoter, a curative, a catalyst, a photoinitiator, a desiccant, an elastomeric modifier, an extender, a flame retardant, a plasticiser, a process aid (anti-blocking, slip additive, antifogging agent, antistatic agent), an antioxidant, a stabilizer, a retarder, a tackifier, or a combination thereof.

The amount and type of such additives may be selected by one skilled in the art, depending on the intended end use of the composition.

In certain embodiments, the backing layer has a thickness of at least 5 mils (approximately 125 micrometers). In certain embodiments, the backing layer has a thickness of at least 25 mils (635 micrometers). In certain embodiments, the backing layer has a thickness of up to 80 mils (approximately 2030 micrometers).

Suitable materials for the backing layers can be obtained commercially from, for example, Momentive (Waterford, N.Y.), Wacker Chemie (Munich, Germany), and Dow Corning (Midland, Mich.).

### Flexible Intermediate Layer

The intermediate layer of tapes of the present disclosure is flexible. In this context it is a material that does not crack according to the Cylindrical Mandrel Bend Test. In certain embodiments, the intermediate layer has a tensile elongation of at least 100%, at least 200%, at least 300%, at least 400%, at least 500%, or at least 600%, according to the Tensile Properties—Method A Test.

In certain embodiments, suitable materials for use in the intermediate layer are cured epoxy-based polymeric materials that show excellent adhesion to the selected backing layer (e.g., a silicone substrate) and the selected pressure sensitive adhesive. If the adhesion is not acceptable, a tie layer, treated surface, or combination thereof may be used. Exemplary of such treatments include chemical treatment, corona treatment (e.g., air or nitrogen corona), plasma treatment, flame treatment, or actinic radiation treatment. Interlayer adhesion can also be improved with the use of a chemical composition that forms a tie layer. A combination of treatments and/or tie layers may be used if desired.

In certain embodiments, suitable cured epoxy-based polymeric materials for the flexible intermediate layer are high temperature resistant polymers (i.e., those polymers that can occur during a high temperature process ((e.g., up to about 500° F.)).

In certain embodiments, suitable epoxy-based polymeric materials for use in the flexible intermediate layer provides a barrier function (and may be referred to herein as a barrier layer). For example, a cured epoxy-based polymeric material prepared from a curable epoxy/thiol resin composition can function as a barrier coat towards plasticizer (e.g., MQ resin) migration from a pressure sensitive silicone adhesive. Other cured epoxy-based materials that can provide a barrier function are those that are immiscible with silicone materials and nonporous.

In certain embodiments, suitable cured epoxy-based materials for use in the flexible intermediate layer provides a priming function (and may be referred to herein as a primer or tie layer). That is, the cured epoxy-based polymeric material of the flexible intermediate layer can be effective as a tie layer between a backing layer and a pressure sensitive adhesive.

The flexible intermediate layer may include one or more layers of material. In certain embodiments, one layer of material can provide both barrier and primer functions. In certain embodiments, the flexible intermediate layer includes two distinct layers of materials, e.g., a primer layer and a barrier layer.

Suitable cured epoxy-based polymeric materials for the flexible intermediate layer have a high melt temperature (e.g., a Vicat Softening Point temperature higher than that of the exposure temperature). In some embodiments, it is desirable for the polymeric materials or compositions that form the flexible intermediate layers to have a relatively low viscosity and be solvent free for ease of coating and to avoid swelling of the underlying material during processing.

Cured epoxy-based materials for use in flexible intermediate layers are derived from epoxy resins. Epoxy resins are polymers and prepolymers that contain reactive epoxide groups. They may be reacted with a large variety of co-reactants, including polyfunctional amines, polyfunctional thiols, acids, acid anhydrides, phenols, and alcohols. Additionally, they can be reacted with themselves through catalytic homopolymerization.

Polyfunctional amines are typically used as hardeners for an epoxy-based material. Use of difunctional or polyfunctional amines result in a crosslinked network. Amine type and functionality can be tailored to dictate final properties (heat resistance, flexibility, mechanical durability, etc.) of the cured polymer matrix. Examples of amine hardeners are described, for example, in U.S. Pat. No. 8,618,204 (Campbell et al.) and U.S. Pat. Pub. No. 2011/0024039 (Campbell et al.).

Polyfunctional thiols can also be used as hardeners for an epoxy-based material. Similarly to polyfunctional amines, the cure results in a crosslinked network that can be tailored to dictate final properties of the cured polymer matrix.

In the case of both polyfunctional amine curatives and polyfunctional thiol curatives, the final epoxy resin can be formulated as either a one-part or two-part composition. When formulated as a one-part, the curable composition includes all components, including the epoxy resin and hardener. Typically, these formulations contain latent hardeners that show limited reactivity at room temperature but react with epoxy resins at elevated temperatures. Alternatively, they can contain latent catalysts that are heat activated to induce cure between the hardener and the reactive epoxy resin. Any additional optional additives (e.g., fillers, toughening agents, diluents, adhesion promoters, inhibitors, and the like) can be admixed into the composition as well.

Alternatively, the curable hardener/epoxy resin composition is a “two-part” composition that includes a base and an accelerator. The base includes the epoxy resin; the accelerator contains the polyamine and/or the polythiol hardeners. Any additional optional additives (e.g., fillers, toughening agents, diluents, adhesion promoters, and the like) can be admixed into either the base or the accelerator. Typically, cure inhibitors are not necessary in a two-part composition because the base and accelerant remain separate until mixing at the time of application.

Thus, in certain embodiments, the cured epoxy-based material is prepared from an epoxy/thiol resin composition, an epoxy/amine resin composition, or a combination thereof, whether they be provided as one-part or two-part compositions.

Certain epoxy-based materials show excellent adhesion to silicone surfaces due to the incorporation of silane-functionalized adhesion promoters. In certain embodiments, some surface preparation (e.g., plasma, flame, or corona treatment) of a silicone surface (e.g., of a backing layer or pressure sensitive adhesive layer) may be used to enhance adhesion. For example, the epoxy/thiol resin compositions show high adhesiveness to corona-treated silicone surfaces even months after exposure to the environment. In certain embodiments, cured polymeric materials formed from curable epoxy-based materials, particularly epoxy/thiol resin compositions, described herein have high elongation and do not detract from the flexibility of the backing layer (e.g., a silicone substrate).

In certain embodiments, the cured epoxy-based material is prepared from a curable epoxy/thiol resin composition. In certain embodiments, the curable epoxy/thiol resin composition includes: an epoxy resin component including an epoxy resin having at least two epoxide groups per molecule; a thiol component including a polythiol compound having at least two primary thiol groups; a silane-functionalized adhesion promoter; a nitrogen-containing catalyst for curing the epoxy resin component; and an optional cure inhibitor. The cure inhibitor can be a Lewis acid or a weak Bronsted acid.

The curable epoxy/thiol resin composition can be a one-part or a two-part composition.

In certain embodiments, a curable “one-part” epoxy/thiol resin composition includes all components, including the thiol curing agent, the nitrogen-containing catalyst, the silane-functionalized adhesion promoter, the cure inhibitor, and any optional additives (e.g., fillers, toughening agents, diluents, and other adhesion promoters) are admixed with the epoxy resin. The cure inhibitor can be a Lewis acid or a weak Bronsted acid. During formulation of a one-part composition, the cure inhibitor is added to the other components of the composition prior to the addition of the nitrogen-containing catalyst.

When formulated in one part, the curable one-part epoxy/thiol resin compositions of the present disclosure possess excellent storage stability at room temperature, particularly with respect to viscosity maintenance over time. In certain embodiments, the curable one-part epoxy/thiol resin compositions are stable at room temperature for a period of at least 2 weeks, at least 4 weeks, or at least 2 months. In this context, “stable” means that the epoxy/thiol composition remains in a curable form.

Additionally, the curable one-part epoxy/thiol resin compositions are curable at low temperatures. In certain embodiments, the curable one-part epoxy/thiol resin compositions are curable at a temperature of at least 50° C. In certain embodiments, the curable one-part epoxy/thiol resin compositions are curable at a temperature of up to 80° C. In certain embodiments, the curable one-part epoxy/thiol compositions are curable at a temperature of 60-65° C.

In certain embodiments, the curable epoxy/thiol resin composition is a “two-part” composition that includes a base and an accelerator. The base includes the epoxy resin component and the silane-functionalized adhesion promoter. The accelerator includes the thiol component and the nitrogen-containing catalyst. Any additional optional additives (e.g., fillers, toughening agents, diluents, and other adhesion promoters) can be admixed into either the base or the accelerator. Typically, cure inhibitors are not necessary in two-part compositions because the base and accelerant remain separate until mixing at the time of application.

When formulated in two parts, the curable two-part epoxy/thiol resin compositions of the present disclosure are stable at room temperature. In certain embodiments, the curable two-part epoxy/thiol resin compositions are stable at room temperature for a period of at least 2 weeks, at least 4 weeks, or at least 2 months. In this context, “stable” means that the epoxy/thiol composition remains in a curable form. Additionally, upon combining the two parts, the curable two-part epoxy/thiol resin compositions cure at room temperature.

In certain embodiments, selection of the epoxy resin component and the thiol component can provide a cured material that is flexible. At least one of such components is flexible. By this it is meant that the epoxy resin component and/or the thiol component (preferably, both the epoxy resin component and the thiol component) are selected to provide a cured polymeric material that is flexible, i.e., a cured polymeric material that does not crack according to the Cylindrical Mandrel Bend Test, and preferably has a tensile elongation of at least 100%, according to the Tensile Properties—Method A Test. In certain embodiments, both the epoxy resin component and the thiol component are selected to provide a cured polymeric material that does not crack according to the Cylindrical Mandrel Bend Test and has a tensile elongation of at least 100%, according to the Tensile Properties—Method A Test. Using such combination of components can preferably provide a cured polymeric material having a flexibility that approaches the elongation of silicone.

### Epoxy Resin Component

The epoxy resin component included in the curable epoxy/thiol resin compositions contains an epoxy resin that has at least two epoxy functional groups (i.e., oxirane groups) per molecule. As used herein, the term oxirane group refers to the following divalent group.

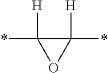 [SMILES: *C1OC1*]

The asterisks denote a site of attachment of the oxirane group to another group. If an oxirane group is at the terminal position of the epoxy resin, the oxirane group is typically bonded to a hydrogen atom.

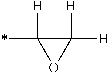 [SMILES: *C1CO1]

This terminal oxirane group is often part of a glycidyl group.

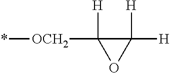

The epoxy resin includes a resin with at least two oxirane groups per molecule. For example, an epoxy compound can have 2 to 10, 2 to 6, or 2 to 4 oxirane groups per molecule. The oxirane groups are usually part of a glycidyl group.

Epoxy resins can include a single material or mixture of materials (e.g., monomeric, oligomeric, or polymeric compounds) selected to provide desired viscosity characteristics before curing and to provide desired mechanical properties after curing. If the epoxy resin includes a mixture of materials, at least one of the epoxy resins in the mixture is usually selected to have at least two oxirane groups per molecule. For example, a first epoxy resin in the mixture can have two to four or more oxirane groups and a second epoxy resin in the mixture can have one to four oxirane groups. In some of these examples, the first epoxy resin is a first glycidyl ether with two to four glycidyl groups and the second epoxy resin is a second glycidyl ether with one to four glycidyl groups.

The portion of the epoxy resin that is not an oxirane group (i.e., an epoxy resin compound minus the oxirane groups) can be aromatic, aliphatic, or a combination thereof and can be linear, branched, cyclic, or a combination thereof. The aromatic and aliphatic portions of the epoxy resin can include heteroatoms or other groups that are not reactive with the oxirane groups. That is, the epoxy resin can include halo groups, oxy groups (such as in an ether linkage group), thio groups (such as in a thio ether linkage group), carbonyl groups, carbonyloxy groups, carbonylimino groups, phosphono groups, sulfono groups, nitro groups, nitrile groups, and the like. The epoxy resin can also be a silicone-based material such as a polydiorganosiloxane-based material.

Although the epoxy resin can have any suitable molecular weight, the weight average molecular weight is usually at least 100 grams/mole, at least 150 grams/mole, at least 175 grams/mole, at least 200 grams/mole, at least 250 grams/mole, or at least 300 grams/mole. The weight average molecular weight can be up to 50,000 grams/mole or even higher for polymeric epoxy resins. The weight average molecular weight is often up to 40,000 grams/mole, up to 20,000 grams/mole, up to 10,000 grams/mole, up to 5,000 grams/mole, up to 3,000 grams/mole, or up to 1,000 grams/mole. For example, the weight average molecular weight can be in the range of 100 to 50,000 grams/mole, in the range of 100 to 20,000 grams/mole, in the range of 100 to 10,000 grams/mole, in the range of 100 to 5,000 grams/mole, in the range of 200 to 5,000 grams/mole, in the range of 100 to 2,000 grams/mole, in the range of 200 to 2,000 grams/mole, in the range of 100 to 1,000 grams/mole, or in the range of 200 to 1,000 grams/mole.

Suitable epoxy resins are typically liquid at room temperature; however, solid epoxy resins that can be dissolved in one of the other components of the composition, such as a liquid epoxy resin, can be used if desired. In most embodiments, the epoxy resin is a glycidyl ether. Exemplary glycidyl ethers can be of Formula II:

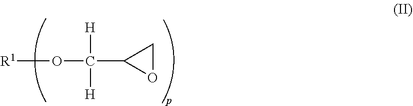

wherein R¹ is a polyvalent group that is aromatic, aliphatic, or a combination thereof. In Formula II, R¹ can be linear, branched, cyclic, or a combination thereof, and can optionally include halo groups, oxy groups, thio groups, carbonyl groups, carbonyloxy groups, carbonylimino groups, phosphono groups, sulfono groups, nitro groups, nitrile groups, and the like. Although the variable p in Formula II can be any suitable integer greater than or equal to 2, p is often an integer in the range of 2 to 10, in the range of 2 to 6, or in the range of 2 to 4.

In some embodiments, the epoxy resin is a polyglycidyl ether of a polyhydric phenol, such as polyglycidyl ethers of bisphenol A, bisphenol F, bisphenol AD, catechol, and resorcinol. In some embodiments, the epoxy resin is a reaction product of a polyhydric alcohol with epichlorohydrin. Exemplary polyhydric alcohols include butanediol, polyethylene glycol, and glycerin. In some embodiments, the epoxy resin is an epoxidised (poly)olefinic resin, epoxidised phenolic novolac resin, epoxidised cresol novolac resin, and cycloaliphatic epoxy resin. In some embodiments, the epoxy resin is a glycidyl ether ester, such as that which can be obtained by reacting a hydroxycarboxylic acid with epichlorohydrin, or a polyglycidyl ester, such as that which can be obtained by reacting a polycarboxylic acid with epichlorohydrin. In some embodiments, the epoxy resin is a urethane-modified epoxy resin. Various combinations of two or more epoxy resins can be used if desired.

In some exemplary epoxy resins of Formula II, the variable p is equal to 2 (i.e., the epoxy resin is a diglycidyl ether) and R¹ includes an alkylene (i.e., an alkylene is a divalent radical of an alkane and can be referred to as an alkane-diyl), heteroalkylene (i.e., a heteroalkylene is a divalent radical of a heteroalkane and can be referred to as a heteroalkane-diyl), arylene (i.e., a divalent radical of an arene compound), or combination thereof. Suitable alkylene groups often have 1 to 20 carbon atoms, 1 to 12 carbon atoms, 1 to 8 carbon atoms, or 1 to 4 carbon atoms. Suitable heteroalkylene groups often have 2 to 50 carbon atoms, 2 to 40 carbon atoms, 2 to 30 carbon atoms, 2 to 20 carbon atoms, 2 to 10 carbon atoms, or 2 to 6 carbon atoms with 1 to 10 heteroatoms, 1 to 6 heteroatoms, or 1 to 4 heteroatoms. The heteroatoms in the heteroalkylene can be selected from oxy, thio, or —NH— groups but are often oxy groups. Suitable arylene groups often have 6 to 18 carbon atoms or 6 to 12 carbon atoms. For example, the arylene can be phenylene, fluorenylene, or biphenylene. Group R¹ can further optionally include halo groups, oxy groups, thio groups, carbonyl groups, carbonyloxy groups, carbonylimino groups, phosphono groups, sulfono groups, nitro groups, nitrile groups, and the like. The variable p is usually an integer in the range of 2 to 4.

Some epoxy resins of Formula II are diglycidyl ethers where R¹ includes (a) an arylene group or (b) an arylene group in combination with an alkylene, heteroalkylene, or both. Group R¹ can further include optional groups such as halo groups, oxy groups, thio groups, carbonyl groups, carbonyloxy groups, carbonylimino groups, phosphono groups, sulfono groups, nitro groups, nitrile groups, and the like. These epoxy resins can be prepared, for example, by reacting an aromatic compound having at least two hydroxyl groups with an excess of epichlorohydrin. Examples of useful aromatic compounds having at least two hydroxyl groups include, but are not limited to, resorcinol, catechol, hydroquinone, p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, and 9,9-(4-hydroxyphenol)fluorene. Still other examples include the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Some commercially available diglycidyl ether epoxy resins of Formula II are derived from bisphenol A (i.e., bisphenol A is 4,4′-dihydroxydiphenylmethane). Examples include, but are not limited to, those available under the tradename EPON (e.g., EPON 1510, EPON 1310, EPON 828, EPON 872, EPON 1001, EPON 1004, and EPON 2004) from Momentive Specialty Chemicals, Inc. (Columbus, Ohio), those available under the tradename DER (e.g., DER 331, DER 332, DER 336, and DER 439) from Olin Epoxy Co. (St. Louis, Mo.), and those available under the tradename EPICLON (e.g., EPICLON 850) from Dainippon Ink and Chemicals, Inc. (Parsippany, N.J.). Other commercially available diglycidyl ether epoxy resins are derived from bisphenol F (i.e., bisphenol F is 2,2′-dihydroxydiphenylmethane). Examples include, but are not limited to, those available under the tradename DER (e.g., DER 334) from Olin Epoxy Co. (St. Louis, Mo.), those available under the tradename EPICLON (e.g., EPICLON 830) from Dainippon Ink and Chemicals, Inc. (Parsippany, N.J.), and those available under the tradename ARALDITE (e.g., ARALDITE 281) from Huntsman Corporation (The Woodlands, Tex.).

Other epoxy resins of Formula II are diglycidyl ethers of a poly(alkylene oxide) diol. These epoxy resins also can be referred to as diglycidyl ethers of a poly(alkylene glycol) diol. The variable p is equal to 2 and R¹ is a heteroalkylene having oxygen heteroatoms. The poly(alkylene glycol) portion can be a copolymer or homopolymer and often includes alkylene units having 1 to 4 carbon atoms. Examples include, but are not limited to, diglycidyl ethers of poly(ethylene oxide) diol, diglycidyl ethers of poly(propylene oxide) diol, and diglycidyl ethers of poly(tetramethylene oxide) diol. Epoxy resins of this type are commercially available from Polysciences, Inc. (Warrington, Pa.) such as those derived from a poly(ethylene oxide) diol or from a poly(propylene oxide) diol having a weight average molecular weight of 400 grams/mole, about 600 grams/mole, or about 1000 grams/mole.

Still other epoxy resins of Formula II are diglycidyl ethers of an alkane diol (R′ is an alkylene and the variable p is equal to 2). Examples include a diglycidyl ether of 1,4-dimethanol cyclohexyl, diglycidyl ether of 1,4-butanediol, and a diglycidyl ether of the cycloaliphatic diol formed from a hydrogenated bisphenol A such as those commercially available under the tradename EPONEX (e.g., EPONEX 1510) from Hexion Specialty Chemicals, Inc. (Columbus, Ohio) and under the tradename EPALLOY (e.g., EPALLOY 5001) from CVC Thermoset Specialties (Moorestown, N.J.).

For some applications, the epoxy resins chosen for use in the curable coating compositions are novolac epoxy resins, which are glycidyl ethers of phenolic novolac resins. These resins can be prepared, for example, by reaction of phenols with an excess of formaldehyde in the presence of an acidic catalyst to produce the phenolic novolac resin. Novolac epoxy resins are then prepared by reacting the phenolic novolac resin with epichlorihydrin in the presence of sodium hydroxide. The resulting novolac epoxy resins typically have more than two oxirane groups and can be used to produce cured coating compositions with a high crosslinking density. The use of novolac epoxy resins can be particularly desirable in applications where corrosion resistance, water resistance, chemical resistance, or a combination thereof is desired. One such novolac epoxy resin is poly[(phenyl glycidyl ether)-co-formaldehyde]. Other suitable novolac resins are commercially available under the tradename ARALDITE (e.g., ARALDITE GY289, ARALDITE EPN 1183, ARALDITE EP 1179, ARALDITE EPN 1139, and ARALDITE EPN 1138) from Huntsman Corporation (The Woodlands, Tex.), under the tradename EPALLOY (e.g., EPALLOY 8230) from CVC Thermoset Specialties (Moorestown, N.J.), and under the tradename DEN (e.g., DEN 424 and DEN 431) from Olin Epoxy Co. (St. Louis, Mo.).

Yet other epoxy resins include silicone resins with at least two glycidyl groups and flame retardant epoxy resins with at least two glycidyl groups (e.g., a brominated bisphenol-type epoxy resin having at least two glycidyl groups such as that commercially available from Dow Chemical Co. (Midland, Mich.) under the tradename DER 580).

In certain embodiments, preferred epoxy resin components are flexible. By this it is meant that the epoxy resin component, when combined with a thiol component (whether flexible or not) and cured, provides a cured polymer material that does not crack according to the Cylindrical Mandrel Bend Test and/or has a tensile elongation of at least 100%, according to the Tensile Properties—Method A Test. Such flexibility can be provided by a flexible epoxy compound and/or a reactive monofunctional diluent. Flexible epoxy compounds include those based on linear or cyclic aliphatic backbone structures. Also, flexibility of an epoxy compound can be increased by increasing side chain length and/or molecular weight between reactive sites.

Epoxy compounds based on linear or cyclic aliphatic structures provide flexibility and include those available under the tradenames HELOXY 71, EPON 872, and EPONEX 1510, all from Momentive Specialty Chemicals, Inc. (Columbus, Ohio). These include diglycidyl ethers of polyethers, examples of which include those available under the tradenames DER 732 and DER 736 from Olin Epoxy Co. (St. Louis, Mo.), HELOXY 84 from Momentive Specialty Chemicals, Inc., and GRILONIT F 713 from EMS-Griltech (Domat/Ems, Switzerland). Epoxies based on cashew nut oil or other natural oils also offer flexibility, examples of which include those available under the tradenames NC513 and NC 514 from Cardolite (Monmouth Junction, New Jersey) and HELOXY 505 from Momentive Specialty Chemicals, Inc. Epoxies based on diglycidyl ethers of Bisphenol A, which have pendant aliphatic groups, also can offer flexibility, an example of which is an alkyl-functionalized diglycidyl ether of Bisphenol A that is available under the tradename ARALDITE PY 4122 from Huntsman (The Woodlands, Tex.). Other examples of flexible epoxies include ethoxylated or propoxylated bisphenol A diglycidyl epoxy derivatives, examples of which are available under the tradenames RIKARESIN BPO-20E and RIKARESIN BEO-60E from New Japan Chemical Co. Ltd. (Osaka, Japan) and EP 4000S and EP 4000L from Adeka Corp. (Tokyo, Japan). Various combinations of such flexible epoxies can be used in the epoxy resin component if desired.

The epoxy resin component is often a mixture of materials. For example, the epoxy resins can be selected to be a mixture that provides the desired viscosity or flow characteristics prior to curing. For example, within the epoxy resin may be reactive diluents that include monofunctional or certain multifunctional epoxy resins. The reactive diluent should have a viscosity which is lower than that of the epoxy resin having at least two epoxy groups. Ordinarily, the reactive diluent should have a viscosity less than 250 mPa·s. The reactive diluent tends to lower the viscosity of the epoxy/thiol resin composition and often has either a branched backbone that is saturated or a cyclic backbone that is saturated or unsaturated. Preferred reactive diluents have only one functional group (i.e., oxirane group) such as various monoglycidyl ethers.

Some exemplary monofunctional epoxy resins include, but are not limited to, those with an alkyl group having 6 to 28 carbon atoms, such as (C6-C28)alkyl glycidyl ethers, (C6-C28)fatty acid glycidyl esters, (C6-C28)alkylphenol glycidyl ethers, and combinations thereof. In the event a monofunctional epoxy resin is the reactive diluent, such monofunctional epoxy resin should be employed in an amount of up to 50 parts based on the total of the epoxy resin component. An example of such diluent is a glycidyl ester of versatic acid 10, a synthetic saturated monocarboxylic acid of highly branched C10 isomers, available under the tradename CARDURA E10P GLYCIDYL ESTER from Hexion Inc. (Columbus, Ohio). Such monofunctional diluents in the epoxy resin component can be used to increase the flexibility of the cured material produced from a curable epoxy/thiol resin composition of the present disclosure.

In some embodiments, the curable epoxy/thiol resin compositions typically include at least 20 weight percent (wt-%), at least 25 wt-%, at least 30 wt-%, at least 35 wt-%, at least 40 wt-%, or at least 45 wt-%, epoxy resin component, based on a total weight of the curable epoxy/thiol resin composition. If lower levels are used, the cured composition may not contain enough polymeric material (e.g., epoxy resin) to provide desired coating characteristics. In some embodiments, the curable epoxy/thiol resin compositions include up to 80 wt-%, up to 75 wt-%, or up to 70 wt-%, epoxy resin component, based on a total weight of the curable epoxy/thiol resin composition.

### Thiol Component

A thiol is an organosulfur compound that contains a carbon-bonded sulfhydryl or mercapto (—C—SH) group. Suitable thiols (i.e., polythiols) are selected from a wide variety of compounds that have two or more thiol groups per molecule, and that function as curatives for epoxy resins.

Examples of suitable polythiols include trimethylolpropane tris(beta-mercaptopropionate), trimethylolpropane tris(thioglycolate), pentaerythritol tetrakis(thioglycolate), pentaerythritol tetrakis(beta-mercaptopropionate), dipentaerythritol poly(beta-mercaptopropionate), ethylene glycol bis(beta-mercaptopropionate), a (C1-C12)alkyl polythiol (e.g., butane-1,4-dithiol and hexane-1,6-dithiol), a (C6-C12)aromatic polythiol (e.g., p-xylenedithiol and 1,3,5-tris (mercaptomethyl) benzene). Combinations of polythiols can be used if desired.

In certain embodiments, preferred thiol components are those that are flexible. By this it is meant that the thiol component, when combined with an epoxy resin component (whether flexible or not) and cured, provides a cured polymer material that does not crack according to the Cylindrical Mandrel Bend Test and/or has a tensile elongation of at least 100%, according to the Tensile Properties—Method A Test. Such flexibility can be provided by a flexible epoxy compound and/or a reactive monofunctional diluent. Thiol compounds based on linear or cyclic aliphatic structures provide flexibility. Also, flexibility of a thiol can be increased by increasing side chain length and/or molecular weight between reactive sites. Examples of flexible thiols include Thiocure ETTMP 700, Thiocure ETTMP 1300, and Thiocure PCL4MP, all available from Bruno Bock (Marschacht, Germany). Various combinations of such flexible thiols can be used in the thiol component if desired.

In some embodiments, the curable epoxy/thiol resin compositions typically include at least 25 wt-%, at least 30 wt-%, or at least 35 wt-%, thiol component, based on a total weight of the curable epoxy/thiol resin composition. In some embodiments, the curable epoxy/thiol resin compositions include up to 70 wt-%, up to 65 wt-%, up to 60 wt-%, up to 55 wt-%, up to 50 wt-%, up to 45 wt-%, or up to 40 wt-%, thiol component, based on a total weight of the curable epoxy/thiol resin composition. Various combinations of two or more polythiols can be used if desired.

In some embodiments, the ratio of the epoxy resin component to the thiol component in the curable epoxy/thiol resin compositions of the present disclosure is from 0.5:1 to 1.5:1, or from 0.75:1 to 1.3:1 (epoxy:thiol equivalents).

Systems containing epoxy resins and thiols suitable for use in the present disclosure are disclosed in U.S. Pat. No. 5,430,112 (Sakata et al.).

### Silane-Functionalized Adhesion Promoter

Silane-functionalized adhesion promoters provide bonding to a silicone-containing material, for example, between a bulk adhesive and a silicone-containing surface. Not being bound by theory, it is theorized that the surface of a silicone polymer contains unreacted silanol functionality that can covalently bond with the silicone atoms of the functionalized silane adhesion promoter, leading to greater adhesion of the cured polymeric material (e.g., epoxy adhesive) to the surface of the silicone.

Suitable silane-functionalized adhesion promoters have the following general Formula III:

(X)ₘ—Y—(Si(R²)₃)ₙ

wherein X is an epoxy or thiol group, Y is an aliphatic group (typically, a (C2-C6)aliphatic group), m and n are independently 1-3 (typically, each of m and n is 1), and each R² is independently an alkoxy group (typically, —OMe or —OEt group). Various combinations of silane-functionalized adhesion promoters can be used if desired.

Examples of adhesion promoters of Formula III include, for example, 3-glycidoxypropyltriethoxysilane 5,6-epoxyhexyltriethoxysilane, 2-(3,4-epoxycyclohexyl)ethyltriethoxysilane, mercaptopropyltriethoxysilane, s-(octanoyl)mercaptopropyltriethoxysilane, hydroxy(polyethyleneoxy)propyltriethoxysilane, and a combination thereof.

In some embodiments, the curable epoxy/thiol resin compositions include at least 0.1 part, or at least 0.5 part, silane-functionalized adhesion promoter, based on 100 parts of the combined weights of the epoxy resin and thiol components. In some embodiments, the curable epoxy/thiol resin compositions include up to 5 parts, or up to 2 parts, based on 100 parts of the combined weights of the epoxy resin and thiol components. Various combinations of two or more silane-functionalized adhesion promoters can be used if desired.

### Nitrogen-Containing Catalyst

The epoxy/thiol resin compositions of the present disclosure include at least one nitrogen-containing catalyst. Such catalysts are typically of the heat activated class. In certain embodiments, the nitrogen-containing catalyst is capable of activation at temperatures at or above 50° C. to effect the thermal curing of the epoxy resin.

Suitable nitrogen-containing catalysts are typically solid at room temperature, and not soluble in the other components of the epoxy/thiol resin compositions of the present disclosure. In certain embodiments, the nitrogen-containing catalysts are in particle form having a particle size (i.e., the largest dimension of the particles, such as the diameter of a sphere) of at least 100 micrometers (i.e., microns).

As used herein, the term “nitrogen-containing catalyst” refers to any nitrogen-containing compound that catalyzes the curing of the epoxy resin. The term does not imply or suggest a certain mechanism or reaction for curing. The nitrogen-containing catalyst can directly react with the oxirane ring of the epoxy resin, can catalyze or accelerate the reaction of the polythiol compound with the epoxy resin, or can catalyze or accelerate the self-polymerization of the epoxy resin.

In certain embodiments, the nitrogen-containing catalysts are amine-containing catalysts. Some amine-containing catalysts have at least two groups of formula —NR³H, wherein R³ is selected from hydrogen, alkyl, aryl, alkaryl, or aralkyl. Suitable alkyl groups often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups usually have 6 to 12 carbon atom such as a phenyl or biphenyl group. Suitable alkylaryl groups can include the same aryl and alkyl groups discussed above.

The nitrogen-containing catalyst minus the at least two amino groups (i.e., the portion of the catalyst that is not an amino group) can be any suitable aromatic group, aliphatic group, or combination thereof.

Exemplary nitrogen-containing catalysts for use herein include a reaction product of phthalic anhydride and an aliphatic polyamine, more particularly a reaction product of approximately equimolar proportions of phthalic acid and diethylamine triamine, as described in British Patent 1,121,196 (Ciba Geigy AG). A catalyst of this type is available commercially from Ciba Geigy AG under the tradename CIBA HT 9506.

Yet another type of nitrogen-containing catalyst is a reaction product of: (i) a polyfunctional epoxy compound; (ii) an imidazole compound, such as 2-ethyl-4-methylimidazole; and (iii) phthalic anhydride. The polyfunctional epoxy compound may be a compound having two or more epoxy groups in the molecule as described in U.S. Pat. No. 4,546,155 (Hirose et al.). A catalyst of this type is commercially available from Ajinomoto Co. Inc. (Tokyo, Japan) under the tradename AJICURE PN-23, which is believed to be an adduct of EPON 828 (bisphenol type epoxy resin epoxy equivalent 184-194, commercially available from Hexion Specialty Chemicals, Inc. (Columbus, Ohio)), 2-ethyl-4-methylimidazole, and phthalic anhydride.

Other suitable nitrogen-containing catalysts include the reaction product of a compound having one or more isocyanate groups in its molecule with a compound having at least one primary or secondary amino group in its molecule. Additional nitrogen-containing catalysts include 2-heptadeoylimidazole, 2-phenyl-4,5-dihydroxymethylimidazole, 2-phenyl-4-methyl-5-hydroxymethylimidazole, 2-phenyl-4-benzyl-5-hydroxymethylimidazole, 2,4-diamino-8-2-methylimidazolyl-(1)-ethyl-5-triazine, or a combination thereof, as well as products of triazine with isocyanuric acid, succinohydrazide, adipohydrazide, isophtholohydrazide, o-oxybenzohydrazide, salicylohydrazide, or a combination thereof.

Nitrogen-containing catalysts are commercially available from sources such as Ajinomoto Co. Inc. (Tokyo, Japan) under the tradenames AMICURE MY-24, AMICURE GG-216 and AMICURE ATU CARBAMATE, from Hexion Specialty Chemicals, Inc. (Columbus, Ohio) under the tradename EPIKURE P-101, from T&K Toka (Chikumazawa, Miyoshi-Machi, Iruma-Gun, Saitama, Japan) under the tradenames FXR-1020, FXR-1081, and FXR-1121, from Shikoku (Marugame, Kagawa Prefecture, Japan) under the tradenames CUREDUCT P-2070 and P-2080, from Air Products and Chemicals, Inc. (Allentown, Pa.) under the tradenames ANCAMINE 2441 and 2442, from A&C Catalysts, Inc. (Linden, N.J.) under the tradenames TECHNICURE LC80 and LC100, and from Asahi Kasei Kogyo, K.K. (Japan) under the tradename NOVACURE HX-372.

Other suitable nitrogen-containing catalysts are those described in U.S. Pat. No. 5,077,376 (Dooley et al.) and U.S. Pat. No. 5,430,112 (Sakata et al.) referred to as “amine adduct latent accelerators.” Other exemplary nitrogen-containing catalysts are described, for example, in British Patent 1,121,196 (Ciba Geigy AG), European Patent Application No. 138465A (Ajinomoto Co.), and European Patent Application No. 193068A (Asahi Chemical).

In embodiments of two-part epoxy/thiol resin compositions, a variety of nitrogen-containing compounds, such as amines, can be used as catalysts. In some embodiments, the amine catalyst can be an imidazole, an imidazole-salt, an imidazoline, or a combination thereof. Aromatic tertiary amines may also be used as a catalyst, including those having the structure of Formula IV:

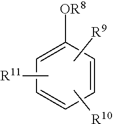

wherein: R⁸ is hydrogen or an alkyl group; R⁹, R¹⁰, and R¹¹ are, independently, hydrogen or CHNR¹²R¹³, wherein at least one of R⁹, R¹⁰, and R¹¹ is CHNR¹²R¹³; and R¹² and R¹³ are, independently, alkyl groups. In some embodiments of Formula (III), the alkyl groups of R⁸, R¹², and/or R¹³ are methyl or ethyl groups. One exemplary curative is tris-2,4,6-(dimethylaminomethyl)phenol, commercially available under the tradename ANCAMINE K54 from Evonik Industries (Essen, Germany). A second, more reactive, exemplary curative is 1,8-diazabicyclo(5.4.0)unde-7-ene (DBU) commercially available from MilliporeSigma (St. Louis, Mo.).

In some embodiments, the curable epoxy/thiol resin compositions typically include at least 1 part, at least 2 parts, at least 3 parts, at least 4 parts, or at least 5 parts, of a nitrogen-containing catalyst, per 100 parts (by weight) of the epoxy resin component. In some embodiments, the curable epoxy/thiol resin compositions typically include up to 45 parts, up to 40 parts, up to 35 parts, up to 30 parts, up to 25 parts, or up to 20 parts, of a nitrogen-containing catalyst, per 100 parts (by weight) of the epoxy resin component. Various combinations of two or more nitrogen-containing catalysts can be used if desired.

### Optional Cure Inhibitor

In embodiments of one-part epoxy/thiol resin compositions, an inhibitor is often necessary to obtain a reasonable shelf life/workability life at room temperature. The inhibitor typically retards the activity of the nitrogen-containing catalyst so that it does not proceed at an appreciable rate at room temperature. Although a cure inhibitor could be used in a two-part epoxy/thiol resin composition, it is not necessary.

Such cure inhibitors can be Lewis acids or weak Bronsted acids (i.e., Bronsted acids having a pH of 3 or higher), or a combination thereof. Such cure inhibitor is soluble in the epoxy/thiol resin composition.

In this context, a cure inhibitor that is “soluble in the epoxy/thiol resin composition” (i.e., a “soluble” cure inhibitor) refers to a compound which, when incorporated in an epoxy/thiol resin composition in an amount of 5 wt-%, produces an epoxy/thiol resin composition with at least 80% clarity and/or at least 80% transmission, as evaluated according to the Stabilizer Solubility Test in the Examples Section. In certain embodiments, the clarity of a curable epoxy/thiol resin composition that includes 5 wt-% of a “soluble” cure inhibitor is at least 85%, at least 90%, or at least 95%. In certain embodiments, the transmission of a curable epoxy/thiol resin composition that includes 5 wt-% of a “soluble” cure inhibitor is at least 85%, or at least 90%.

Such soluble cure inhibitors function as stabilizers of the nitrogen-containing catalyst. Desirably, the nitrogen-containing catalyst is stabilized against curing the epoxy resin at room temperature for a period of at least 2 weeks, at least 4 weeks, or at least 2 months.

Examples of Lewis acids include borate esters, such as that available under the tradename CUREZOL L-07N from Shikoku (Kagawa, Japan), as well as CaNO₃ and MnNO₃ available from MilliporeSigma (St. Louis, Mo.). Various combinations of Lewis acids can be used if desired.

Examples of weak Bronsted acids include barbituric acid derivatives, 1,3-cyclohexanedione, and 2,2-dimethyl-1,3-dioxane-4,6-dione from MilliporeSigma (St. Louis, Mo.). Various combinations of weak Bronsted acids can be used if desired.

Herein, barbituric acid “derivatives” include those barbituric acid compounds substituted at one or more of the 1, 3, and/or 5 N positions, or at the 1 and/or 3 N positions and optionally at the 5 N position, with an aliphatic, cycloaliphatic, or aromatic group. In certain embodiments, the barbituric acid derivatives include those of Formula V:

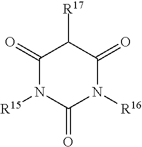

wherein one or more of the R¹⁵, R¹⁶, and R¹⁷ groups are represented by hydrogen, an aliphatic group, a cycloaliphatic group, or an aromatic group (e.g., phenyl), optionally further substituted in any position with one or more of (C1-C4)alkyl, —OH, halide (F, Br, Cl, I), phenyl, (C1-C4)alkylphenyl, (C1-C4)alkenylphenyl, nitro, or —OR¹⁸ where R¹⁸ is phenyl, a carboxylic group, a carbonyl group, or an aromatic group and R¹⁸ is optionally substituted with (C1-C4)alkyl, —OH, or halide; and further wherein at least one of the R¹⁵, R¹⁶, and R¹⁷ groups is not hydrogen. In certain embodiments, at least two of the R¹⁵, R¹⁶, and R¹⁷ groups are not hydrogen.

Examples of suitable barbituric acid derivatives include 1-benzyl-5-phenylbarbituric acid, 1-cycloheyl-5-ethylbarbituric acid (available from Chemische Fabrik Berg, Bitterfeld-Wolfen, Germany), 1,3-dimethylbarbituric acid (available from Alfa Aesar, Tewksbury, Mass.), and combinations thereof.

U.S. Pat. No. 6,653,371 (Burns et al.) teaches that a substantially insoluble solid organic acid is required for epoxy/thiol resin compositions to stabilize the composition. Surprisingly, it was found that the use of a soluble organic acid, in particular, a barbituric acid derivative that is functionalized to make it more soluble, results in better stabilization of the epoxy/thiol resin composition than the use of substantially insoluble organic acids. Also, U.S. Pat. No. 6,653,371 (Burns et al.) teaches that stabilizer effectiveness is directly affected by particle size of the stabilizing component added into the system. A benefit of using soluble barbituric acid derivatives as stabilizers is that the initial particle size does not alter stabilizer performance, at least because the stabilizer is fully dissolved throughout the curable epoxy/thiol resin compositions.

A soluble cure inhibitor is used in an epoxy/thiol resin composition in an amount that allows the epoxy/thiol resin composition to remain curable for at least 72 hours at room temperature such that there is no viscosity increase (e.g., no doubling in viscosity). Typically, this is an amount of at least 0.01 wt-%, based on the total weight of the curable epoxy/thiol resin composition.

The greater the amount of a soluble cure inhibitor used in an epoxy/thiol resin composition, generally the longer the shelf life of the curable epoxy/thiol resin composition. The greater the amount of a cure inhibitor used in an epoxy/thiol resin composition, generally the longer the time required to cure and/or the higher the temperature required to cure the curable epoxy/thiol resin composition. Thus, depending on the use of the curable composition, there is a balance between shelf life and cure time/temperature. Typically, for a reasonable shelf life, cure time, and cure temperature, the amount of soluble cure inhibitor used is up to 1 wt-%, or up to 0.5 wt-%.

### Optional Additives in the Curable Composition

In addition to the epoxy resin component, the thiol component, the silane-functionalized adhesion promoter, the nitrogen-containing catalyst, and the optional cure inhibitor, the curable composition can include other various optional additives. One such optional additive is a toughening agent. Toughening agents can be added to provide desired overlap shear, peel resistance, and impact strength. Useful toughening agents are polymeric materials that may react with the epoxy resin and that may be cross-linked. Suitable toughening agents include polymeric compounds having both a rubbery phase and a glassy phase or compounds which are capable of forming, with the epoxide resin, both a rubbery phase and a glassy phase on curing. Polymers useful as toughening agents are preferably selected to inhibit cracking of the cured epoxy composition.

Some polymeric toughening agents that have both a rubbery phase and a thermoplastic phase are acrylic core-shell polymers wherein the core is an acrylic copolymer having a glass transition temperature below 0° C. Such core polymers may include polybutyl acrylate, polyisooctyl acrylate, polybutadiene-polystyrene in a shell comprised of an acrylic polymer having a glass transition temperature above 25° C., such as polymethylmethacrylate. Commercially available core-shell polymers include those available as a dry powder under the tradenames ACRYLOID KM 323, ACRYLOID KM 330, and PARALOID BTA 731, from Dow Chemical Co. (Midland, Mich.), and KANE ACE B-564 from Kaneka Corporation (Osaka, Japan). These core-shell polymers may also be available as a predispersed blend with a diglycidyl ether of bisphenol A at, for example, a ratio of 12 to 37 parts by weight of the core-shell polymer and are available under the tradenames KANE ACE (e.g., KANE ACE MX 157, KANE ACE MX 257, and KANE ACE MX 125) from Kaneka Corporation (Japan).

Another class of polymeric toughening agents that are capable of forming, with the epoxide group-containing material, a rubbery phase on curing, are carboxyl-terminated butadiene acrylonitrile compounds. Commercially available carboxyl-terminated butadiene acrylonitrile compounds include those available under the tradenames HYCAR (e.g., HYCAR 1300X8, HYCAR 1300X13, and HYCAR 1300X17) from Lubrizol Advanced Materials, Inc. (Cleveland, Ohio) and under the tradename PARALOID (e.g., PARALOID EXL-2650) from Dow Chemical (Midland, Mich.).

Other polymeric toughening agents are graft polymers, which have both a rubbery phase and a thermoplastic phase, such as those disclosed in U.S. Pat. No. 3,496,250 (Czerwinski). These graft polymers have a rubbery backbone having grafted thereto thermoplastic polymer segments. Examples of such graft polymers include, for example, (meth)acrylate-butadiene-styrene, and acrylonitrile/butadiene-styrene polymers. The rubbery backbone is preferably prepared so as to constitute from 95 wt-% to 40 wt-% of the total graft polymer, so that the polymerized thermoplastic portion constitutes from 5 wt-% to 60 wt-% of the graft polymer.

Still other polymeric toughening agents are polyether sulfones such as those commercially available from BASF (Florham Park, N.J.) under the tradename ULTRASON (e.g., ULTRASON E 2020 P SR MICRO).

The curable composition can additionally contain a non-reactive plasticizer to modify rheological properties. Commercially available plasticizers include those available under the tradename BENZOFLEX 131 from Eastman Chemical (Kingsport, Tenn.), JAYFLEX DINA available from ExxonMobil Chemical (Houston, Tex.), and PLASTOMOLL (e.g., diisononyl adipate) from BASF (Florham Park, N.J.).

The curable composition optionally contains a flow control agent or thickener, to provide the desired rheological characteristics to the composition. Suitable flow control agents include fumed silica, such as treated fumed silica, available under the tradename CAB-O-SIL TS 720, and untreated fumed silica available under the tradename CAB-O-SIL M5, from Cabot Corp. (Alpharetta, Ga.).

In some embodiments, the curable composition optimally contains adhesion promoters other than the silane adhesion promoter to enhance the bond to the substrate. The specific type of adhesion promoter may vary depending upon the composition of the surface to which it will be adhered. Adhesion promoters that have been found to be particularly useful for surfaces coated with ionic type lubricants used to facilitate the drawing of metal stock during processing include, for example, dihydric phenolic compounds such as catechol and thiodiphenol.

The curable composition optionally may also contain one or more conventional additives such as fillers (e.g., aluminum powder, carbon black, glass bubbles, talc, clay, calcium carbonate, barium sulfate, titanium dioxide, silica such as fused silica, silicates, glass beads, and mica), pigments, flexibilizers, reactive diluents, non-reactive diluents, fire retardants, antistatic materials, thermally and/or electrically conductive particles, and expanding agents including, for example, chemical blowing agents such as azodicarbonamide or expandable polymeric microspheres containing a hydrocarbon liquid, such as those sold under the tradename EXPANCEL by Expancel Inc. (Duluth, Ga.). Particulate fillers can be in the form of flakes, rods, spheres, and the like. Additives are typically added in amounts to produce the desired effect in the resulting adhesive.

The amount and type of such additives may be selected by one skilled in the art, depending on the intended end use of the composition.

### Pressure Sensitive Adhesive

One or more layers of pressure sensitive adhesives may be used in the tapes of the present disclosure.

For example, a tape of the present disclosure may include: an elastomeric backing layer; a flexible intermediate layer disposed on a first major surface of the backing layer; a first pressure sensitive adhesive layer disposed on the flexible intermediate layer; and a top layer disposed on (directly or indirectly through a second flexible intermediate layer or a primer layer) a second major surface of the backing layer, wherein the top layer comprises a second pressure sensitive adhesive layer.

As another example, a tape of the present disclosure may include: an elastomeric backing layer; a first pressure sensitive adhesive layer disposed on a first major surface of the elastomeric backing layer; and a second pressure sensitive adhesive layer disposed on a second major surface of the elastomeric backing layer.

The pressure sensitive adhesive of each layer may be the same or different. Also, each pressure sensitive adhesive layer may include a single pressure sensitive adhesive or a blend of different pressure sensitive adhesives.

The pressure sensitive adhesive layers of the tapes of the present disclosure include a silicone pressure sensitive adhesive. Pressure sensitive silicone adhesives include two major components, a polymer or gum and a tackifying resin. The polymer is typically a high molecular weight polydimethylsiloxane or polydimethyldiphenylsiloxane, that contains residual silanol functionality (SiOH) on the ends of the polymer chain, or a block copolymer comprising polydiorganosiloxane soft segments and urea terminated hard segments. The tackifying resin is generally a three-dimensional silicate structure that is endcapped with trimethylsiloxy groups (OSiMe₃) and also contains some residual silanol functionality. Pressure sensitive silicone adhesives are described in U.S. Pat. No. 2,736,721 (Dexter). Silicone urea block copolymer pressure sensitive adhesive are described in U.S. Pat. No. 5,461,134 (Leir et al.), International Publication Nos. WO 96/034029 (Sherman et al.) and WO 96/035458 (Melancon et al.). Silicone polyoxamide pressure sensitive adhesive compositions are described in U.S. Pat. No. 7,371,464 (Sherman et al.).

In certain embodiments suitable PSA's are those silicone-containing compositions that possess high temperature shear performance. The pressure sensitive adhesive is selected to have a Peel Adhesion Strength of at least 20 ounces/inch when tested according to the Peel Adhesion Strength Test Method B and/or pass the T-Peel Adhesion Strength Test Method B (wherein “pass” is defined as having a peel rate of less than one inch per 10 seconds).

In certain embodiments, the pressure sensitive adhesive is prepared from a composition that includes 40 wt-% to 70 wt-% silicone solids and an organic solvent (e.g., xylene). In certain embodiments, the pressure sensitive adhesive is diluted with additional organic solvent (e.g., xylene) to make it easier to coat. In certain embodiments, the pressure sensitive adhesive layer includes a blend of PSA's made from these two different compositions.

Silicone pressure sensitive adhesives are typically prepared from a composition that includes a polydiorganosiloxane. Silicone pressure sensitive adhesives may be cured or crosslinked by catalysts such as peroxide curatives or metallic salts at elevated temperatures. In certain embodiments, such peroxide curatives extract Hydrogen and/or crosslink and may require high temperatures. For example, benzoyl peroxide requires a cure temperature of more than 150° C. for the catalyst to be functional.

In certain embodiments, the pressure sensitive adhesive is prepared from a platinum catalyst addition-curable composition. In certain embodiments, a silicone pressure sensitive adhesive is prepared from a composition including a crosslinker and a platinum catalyst. In certain embodiments, the pressure sensitive adhesive is prepared from a composition that includes a polydiorganosiloxane, a crosslinker, and a platinum catalyst.

Silicone adhesives prepared by addition-cure chemistry typically involve the use of a platinum or other Group VIIIB (i.e., Groups 8, 9, and 10) metal catalysts, typically, hydrosilation catalysts, to effect the curing of the silicone adhesive. Reported advantages of addition-cured silicone adhesives include reduced viscosity compared to silicone adhesives prepared via condensation chemistry, higher solids content, stable viscosity with respect to time, and lower temperature cure. Methods of preparation are disclosed in U.S. Pat. No. 5,082,706 (Tangney).

U.S. Pat. No. 5,082,706 (Tangney) describes a silicone pressure sensitive adhesive that includes a tackifying resin (often referred to as an MQ resin) containing two structural units, one of which is R—SiO (often designated as M) and the other SiO₂ (often designated as Q). The peel adhesion of silicone pressure sensitive adhesives can be controlled by controlling the amount of tackifying resin. For example, increasing the amount of tackifying resin increases the peel adhesion; however, there is typically a point at which the peel adhesion maximizes. Thus, increasing the amount of tackifying resin beyond this point can cause peel adhesion to decrease.

In certain embodiments, the pressure sensitive adhesive is prepared from a polydiorganosiloxane, including a platinum-containing catalyst available under the trade designation “SYL-OFF 4000.” Examples of such PSA are generally described in U.S. Pat. No. 6,703,120 (Ko et al.) In certain embodiments, a blend of this PSA and another PSA available under the trade designation “DOW CORNING 7657” may be used.

In some other embodiments, the silicone pressure sensitive adhesive can be made using a peroxide agent as a curative.

In certain embodiments, the pressure sensitive adhesive layer has a thickness of at least 0.1 mil (2.5 micrometers), particularly if used as a top layer pressure sensitive adhesive. In certain embodiments, the pressure sensitive adhesive layer has a thickness of at least 1 mil (25 micrometers). In certain embodiments, the pressure sensitive adhesive layer has a thickness of at least 2 mils (50 micrometers) or at least 3 mils (75 micrometers). The upper limit of the thickness of the PSA is typically controlled by cost.

### Optional Top Layer Primer

Suitable primer layers are those that adhere the top layer material to an underlying material (e.g., a backing layer or a flexible intermediate layer).

In certain embodiments, a primer layer includes a silicone. In certain embodiments, a primer layer includes a silicone produced by a condensation reaction. In certain embodiments, a primer layer is produced from a mixture that includes a polydimethylsiloxane gum, a multi-functional silicate, a catalyst (e.g., a tetra-alkyl titanate catalyst), and optionally an MQ siloxane resin.

Exemplary silicone primers are described in Canadian Patent No. 1326975 C.

In certain embodiments, a silicone primer includes a silicone-containing composition that is available under the trade designation “SR500 SILICONE PRIMER.” This composition includes 11 wt-% solids in a mixture of hexane and toluene.

In certain embodiments, a silicone primer includes an RTV (room temperature vulcanizing) silicone. RTV silicones can be based on either 1- or 2-part chompositions and can utilize either addition crosslinking (hydrosilsation) or condensation crosslinking to cure. An exemplary 2-part RTV silicone is based on a platinum cured addition reaction.

In certain embodiments, each primer layer has a thickness of at least 0.01 mil (0.25 micrometer). In certain embodiments, each primer layer has a thickness of up to 0.1 mil (2.5 micrometers).

### Top Layer Inorganic Oxide Matrix and Optional Organic Binder

In certain embodiments, a tape of the present disclosure includes a top layer disposed on (directly or indirectly) a second major surface of the backing layer (i.e., the surface opposite that on which the silicone pressure sensitive adhesive is disposed. In certain embodiments, such top layer includes an inorganic oxide matrix and an optional organic binder.

In certain embodiments, the inorganic oxide matrix includes a metal or metalloid in any of groups 2 through 15 (e.g., group 2, group 3, group 4, group 5, group 6, group 7, group 8, group 9, group 10, group 11, group 12, group 13, group 14, group 15, and combinations thereof) of the Periodic Table of the Elements.

This inorganic oxide matrix may be formed from inorganic oxide particles. For example, the inorganic oxide matrix can be formed from Al₂O₃ particles, CaCO₃ particles, TiO₂ particles, ZrO₂ particles, SiO₂ particles, iron oxide particles, clay particles, and combinations thereof.

In certain embodiments, the inorganic oxide matrix includes a silica network (preferably, a crosslinked and/or interconnected amorphous silica network). In certain embodiments, the silica network is formed from silica nanoparticles (preferably, the silica nanoparticles have a polymodal particle size distribution).

In certain embodiments, a coupling agent may be included with the nanoparticles. Examples of such coupling agents include an organic silane ester (e.g., acrylic silane ester, vinyl silane ester, amino silane ester, epoxy silane ester, hydroxyalkyl silane ester, hydroxyaryl silane ester, mercapto silane ester), metal silicate, or combinations thereof. Such coupling agents may be crosslinking agents, adhesion promoters, and/or dispersion stabilizing agents. For example, they may strengthen the inter-particle bonding and/or the interfacial adhesion to the underlying material.

In certain embodiments, if used, a coupling agent (e.g., an organic silane ester) is present in an amount of at least 0.5 wt-%, or at least 1 wt-%, or at least 2 wt-%, based on the weight of metal oxide particles (e.g., silica nanoparticles). Typically, a coupling agent is present in an amount of up to 30 wt-%, up to 20 wt-%, up to 15 wt-%, up to 10 wt-%, or up to 8 wt-%, based on the weight of metal oxide particles (e.g., silica nanoparticles).

In certain embodiments, the inorganic oxide matrix includes the product of hydrolysis and condensation of a hydrolyzable organosilicate (e.g., tetraethoxysilane (TEOS) or tetramethoxysilane (TMOS)) in the presence of hydrolyzable organosilane. Such products may be in the form of polymers or oligomers.

Coating compositions for forming the inorganic oxide matrix top layer may have a wide range of non-volatile solids contents. In certain embodiments, the coating compositions may have a solids content of at least 0.1 wt-%, at least 2 wt-%, or at least 3 wt-%. In certain embodiments, the coating compositions may have a solids content of up to 25 wt-%, up to 10 wt-%, or up to 8 wt-%.

The optimal average dry top layer thickness is dependent upon the particular composition of the top layer, but in general the average thickness of the dry top layer is at least 0.01 micron. In certain embodiments, the average thickness of the dry top layer is up to 50 microns, especially when an organic binder is present, or up to 5 microns, or up to 2 microns, or up to 0.5 micron, or up to 0.1 micron. Such thicknesses can be estimated, for example, from atomic force microscopy and/or surface profilometry.

The dry top layer described herein can be applied directly (i.e., without any intervening layers such as a primer layer) to a hydrophobic silicone rubber substrate, particularly when it is corona-treated. A dried inorganic matrix top layer is surprisingly found to adhere well to a silicone rubber substrate and to a silicone PSA, even at elevated temperatures. Not to be bound by theory, it is believed that the hydroxyl groups of inorganic top layers, exemplified by the surface silanol group of nanosilica or silica network, may chemically interact with the Si—O—Si via an transesterification process, thus resulting in multiple covalent bonds formed at the interfaces between the substrate and the inorganic oxide top layer. Such multiple covalent bonds are believed to account for the strong interfacial adhesion.

### Nanoparticles for Inorganic Oxide Matrix

In certain embodiments, the inorganic oxide matrix includes a silica network, which may be formed from silica nanoparticles.

In certain embodiments, to make the inorganic oxide matrix, an initial or coatable composition may include silica nanoparticles dispersed in an aqueous liquid medium, wherein the initial composition has a pH greater than 6. In such embodiments, the silica nanoparticles have an average particle size of less than or equal to 100 nanometers (nm). In some embodiments, the silica nanoparticles have an average particle size of less than or equal to 75 nm, less than or equal to 45 nm, less than or equal to 40 nm, less than or equal to 35 nm, less than or equal to 30 nm, less than or equal to 25 nm, less than or equal to 20 nm, less than or equal to 15 nm, or even less than 10 nm. Typically, the silica nanoparticles have an average particle size of at least 4 nm, although this is not a requirement. The average primary particle size may be determined, for example, using transmission electron microscopy. As used herein, the term “particle size” refers to the longest dimension of a particle, which is the diameter for a spherical particle. Of course, silica particles with a particle size greater than 200 nm (e.g., up to 2 micrometers in particle size) may also be included, but typically in a minor amount. The silica nanoparticles desirably have narrow particle size distributions; for example, a polydispersity of 2.0 or less, or even 1.5 or less. In some embodiments, the silica nanoparticles have a surface area greater than 150 square meters per gram (m²/g), greater than 200 m²/g, or even greater than 400 m²/g.

In some embodiments, the amount of the silica nanoparticles having an average particle size (e.g., diameter) of 40 nm or less is at least 0.1 percent by weight, and preferably at least 0.2 percent by weight, based on the total weight of the initial composition and/or coatable composition. In some embodiments, the concentration of the silica nanoparticles having a particle size (e.g., diameter) of 40 nm or less is no greater than 20 percent by weight, or even no greater than 15 percent by weight, based on the total weight of the initial composition.

The silica nanoparticles may have a polymodal particle size distribution. For example, a polymodal particle size distribution may have a first mode with a particles size in the range of from 5 to 2000 nanometers, preferably 20 to 150 nanometers, and a second mode having a second particle size in the range of from 1 to 45 nanometers, preferably 2 to 25 nanometers.

Nanoparticles (e.g., silica nanoparticles) included in the initial coatable composition to form the inorganic oxide matrix can be spherical or non-spherical with any desired aspect ratio. Aspect ratio refers to the ratio of the average longest dimension of the nanoparticles to their average shortest dimension. The aspect ratio of non-spherical nanoparticles is often at least 2:1, at least 3:1, at least 5:1, or at least 10:1. Non-spherical nanoparticles may, for example, have the shape of rods, ellipsoids, and/or needles. The shape of the nanoparticles can be regular or irregular. The porosity of coatings can typically be varied by changing the amount of regular and irregular-shaped nanoparticles in the coatable composition and/or by changing the amount of spherical and non-spherical nanoparticles in the coatable composition.

In some embodiments, the total weight of the silica nanoparticles in the in the initial coatable composition to form the inorganic oxide matrix is at least 0.1 percent by weight, typically at least 1 percent by weight, and more typically at least 2 percent by weight. In some embodiments, the total weight of the silica nanoparticles in the composition is no greater than 40 percent by weight, preferably no greater than 15 percent by weight, and more typically no greater than 7 percent by weight.

Silica sols, which are stable dispersions of silica nanoparticles in aqueous liquid media, are well-known in the art and available commercially. Non-aqueous silica sols (also called silica organosols) may also be used and are silica sol dispersions wherein the liquid phase is an organic solvent, or an aqueous mixture containing an organic solvent. In the practice of this disclosure, the silica sol is chosen so that its liquid phase is compatible with the dispersion, and is typically an aqueous solvent, optionally including an organic solvent.

In certain embodiments, the silica is fumed silica.

Silica nanoparticle dispersions (e.g., silica sols) in water, water-alcohol, alcohol or ketone solutions are available commercially, for example, under such trade names as LUDOX (marketed by E.I. du Pont de Nemours and Co., Wilmington, Del.), NYACOL (marketed by Nyacol Co., Ashland, Mass.), and NALCO (manufactured by Ondea Nalco Chemical Co., Oak Brook, Ill.). One useful silica sol is NALCO 2326, which is available as a silica sol with an average particle size of 5 nanometers, pH=10.5, and solid content 15 percent solids by weight. Other commercially available silica nanoparticles include those available under the trade designations NALCO 1115 (spherical, average particle size of 4 nm, 15 percent solids by weight dispersion, pH=10.4), NALCO 1130 spherical dispersion, average particle size of 8 nm, 30 percent solids by weight dispersion, pH=10.2), NALCO 1050 (spherical, average particle size 20 nm, 50 percent solids by weight dispersion, pH=9.0), NALCO 2327 (spherical, average particle size of 20 nm, 40 percent solids by weight dispersion, pH=9.3), NALCO 1030 (spherical, average particle size of 13 nm, 30 percent solids by weight dispersion, pH=10.2), and DVSZN004 (spherical, 45 nm, 42 percent by weight dispersion) available from Nalco Chemical Co. Useful silica nanoparticles in organic solvents such as IPA-ST, IPA-ST-L, IPA-ST-UP, EG-ST, MEK-ST and EAC-ST may also be included. They are available from Nissan Chemical America Corporation.

Acicular silica nanoparticles may also be used provided that the average silica nanoparticle size constraints described hereinabove are achieved. Useful acicular silica nanoparticles may be obtained as an aqueous suspension under the trade name SNOWTEX-UP by Nissan Chemical Industries (Tokyo, Japan). The mixture consists of 20-21% (w/w) of acicular silica, less than 0.35% (w/w) of Na₂O, and water. The particles are about 9 to 15 nanometers in diameter and have lengths of 40 to 200 nanometers. The suspension has a viscosity of less than 100 mPa at 25° C., a pH of about 9 to 10.5, and a specific gravity of about 1.13 at 20° C.

Other useful acicular silica nanoparticles may be obtained as an aqueous suspension under the trade name SNOWTEX-PS-S and SNOWTEX-PS-M by Nissan Chemical Industries, having a morphology of a string of pearls. The mixture consists of 20-21% (w/w) of silica, less than 0.2% (w/w) of Na₂O, and water. The SNOWTEX-PS-M particles are about 18 to 25 nm in diameter and have lengths of 80 to 150 nanometers. The particle size is 80 to 150 nm by dynamic light scattering methods. The suspension has a viscosity of less than 100 mPas at 25° C., a pH of about 9 to 10.5, and a specific gravity of about 1.13 at 20° C. The SNOWTEX-PS-S has a particle diameter of 10-15 nm and a length of 80-120 nm.

Low- and non-aqueous silica sols (also called silica organosols or organo-silica sols) may also be used. They are silica sol dispersions wherein the liquid phase is an organic solvent (e.g., isopropanol, methanol, or methyl ethyl ketone) or an aqueous organic solvent. In the practice of the present disclosure, the silica nanoparticle sol is chosen so that its liquid phase is compatible with the intended coating composition. Such organo-silica sols are available from Nissan Chemical America Corp., Houston, Tex.

Silica sols having a pH of at least 8 can also be prepared according to the methods described in U.S. Pat. No. 5,964,693 (Brekau et al.).

The initial coatable composition to form the inorganic oxide matrix may be acidified by addition of inorganic acid until it has a pH of less than or equal to 4, typically less than 3, or even less than 2, thereby providing the coatable composition. Useful inorganic acids (i.e., mineral acids) include, for example, hydrochloric acid, nitric acid, sulfuric acid, phosphoric acid, perchloric acid, chloric acid, and combinations thereof. Typically, the inorganic acid is selected such that it has a pKa of less than or equal to two, less than one, or even less than zero, although this is not a requirement. Without wishing to be bound by theory, it is believed that some agglomeration of the silica nanoparticles occurs as the pH falls, resulting in a dispersion comprising agglomerated nanoparticles.

### Amino Silane Ester Coupling Agent for Inorganic Oxide Matrix

In certain embodiments, an amino silane ester may be used in combination with silica nanoparticles (e.g., nanosilica dispersions and organo-silica sols).

The amino-substituted organosilane ester or ester equivalent bears on the silicon atom at least one ester or ester equivalent group, preferably 2, or more preferably 3 groups. Ester equivalents are well known to those skilled in the art and include compounds such as silane amides (RNR′Si), silane alkanoates (RC(O)OSi), Si—O—Si, SiN(R)—Si, SiSR and RCONR′Si. These ester equivalents may also be cyclic such as those derived from ethylene glycol, ethanolamine, ethylenediamine and their amides. R and R′ are defined as in the “ester equivalent” definition in the Summary. Another such cyclic example of an ester equivalent is shown in Formula VI:

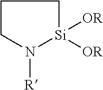

In this cyclic compound of Formula VI, R′ is as defined in the preceding sentence except that it may not be aryl. 3-Aminopropyl alkoxysilanes are well known to cyclize on heating and these RNHSi compounds would be useful in this invention. Preferably the amino-substituted organosilane ester or ester equivalent has ester groups such as methoxy that are easily volatilized as methanol so as to avoid leaving residue at the interface that may interfere with bonding. The amino-substituted organosilane must have at least one ester equivalent; for example, it may be a trialkoxysilane. For example, the amino-substituted organosilane may have the formula (Z2N-L-SiX′X″X′″), where Z is hydrogen, alkyl, or substituted aryl or alkyl including amino-substituted alkyl; where L is a divalent straight chain (C1-C12)alkylene or may comprise a (C3-C8)cycloalkylene, 3-8 membered ring heterocycloalkylene, (C2-C12)alkenylene, (C4-C8)cycloalkenylene, 3-8 membered ring heterocycloalkenylene or heteroarylene unit. L may be divalent aromatic or may be interrupted by one or more divalent aromatic groups or heteroatomic groups. The aromatic group may include a heteroaromatic. The heteroatom is preferably nitrogen, sulfur or oxygen. L is optionally substituted with (C1-C4)alkyl, (C2-C4)alkenyl, (C2-C4)alkynyl, (C1-C4)alkoxy, amino, (C3-C6)cycloalkyl, 3-6 membered heterocycloalkyl, monocyclic aryl, 5-6 membered ring heteroaryl, (C1-C4)alkylcarbonyloxy, (C1-C4)alkyloxycarbonyl, (C1-C4)alkylcarbonyl, formyl, (C1-C4)alkylcarbonylamino, or (C1-C4)aminocarbonyl. L is further optionally interrupted by —O—, —S—, —N(Rc)-, —N(Rc)-C(O)—, —N(Rc)-C(O)—O—, —O—C(O)—N(Rc)-, —N(Rc)-C(O)—N(Rd)-, —O—C(O)—, —C(O)—O—, or —O—C(O)—O—. Each of Rc and Rd, independently, is hydrogen, alkyl, alkenyl, alkynyl, alkoxyalkyl, aminoalkyl (primary, secondary or tertiary), or haloalkyl; and each of X′, X″ and X′″ is a (C1-C18)alkyl, halogen, (C1-C8)alkoxy, (C1-C8)alkylcarbonyloxy, or amino group, with the proviso that at least one of X′, X″, and X″ is a labile group. Further, any two or all of X′, X″ and X′″ may be joined through a covalent bond. The amino group may be an alkylamino group.

Examples of amino-substituted organosilanes include 3-aminopropyltrimethoxysilane (SILQUEST A-1110); 3-aminopropyltriethoxysilane (SILQUEST A-1100); 3-(2-aminoethyl)aminopropyltrimethoxysilane (SILQUEST A-1120); SILQUEST A-1130, (aminoethylaminomethyl)phenethyltrimethoxysilane; (aminoethylaminomethyl)phenethyltriethoxysilane; N-(2-aminoethyl)-3-aminopropylmethyldimethoxysilane (SILQUEST A-2120), bis-(y-triethoxysilylpropyl) amine (SILQUEST A-1170); N-(2-aminoethyl)-3-aminopropyltributoxysilane; 6-(aminohexylaminopropyl)trimethoxysilane; 4-aminobutyltrimethoxysilane; 4-aminobutyltriethoxysilane; p-(2-aminoethyl)phenyltrimethoxysilane; 3-aminopropyltris(methoxyethoxyethoxy)silane; 3-aminopropylmethyldiethoxysilane; oligomeric aminosilanes such as DYNASYLAN 1146, 3-(N-methylamino)propyltrimethoxysilane; N-(2-aminoethyl)-3-aminopropylmethyldimethoxysilane; N-(2-aminoethyl)-3-aminopropylmethyldiethoxysilane; N-(2-aminoethyl)-3-aminopropyltrimethoxysilane; N-(2-aminoethyl)-3-aminopropyltriethoxysilane; 3-aminopropylmethyldiethoxysilane; 3-aminopropylmethyldimethoxysilane; 3-aminopropyldimethylmethoxysilane; 3-aminopropyldimethylethoxysilane; 4-aminophenyltrimethoxy silane; 3-phenylaminopropyltrimethoxy silane; 2,2-dimethoxy-1-aza-2-silacyclopentane-1-ethanamine; 2,2-diethoxy-1-aza-2-silacyclopentane-1-ethanamine; 2,2-diethoxy-1-aza-2-silacyclopentane; and 2,2-dimethoxy-1-aza-2-silacyclopentane.

Additional “precursor” compounds such as a bis-silyl urea [RO)₃Si(CH₂)NR]₂C═O are also examples of amino-substituted organosilane ester or ester equivalents that liberate amine by first dissociating thermally.

The amino-substituted organosilane ester or ester equivalent is preferably introduced diluted in an organic solvent such as ethyl acetate or methanol or methyl acetate. One preferred amino-substituted organosilane ester or ester equivalent is 3-aminopropyl methoxy silane (H₂N—(CH₂)₃—Si(OMe)₃), or its oligomers.

One such oligomer is SILQUEST A-1106, manufactured by Osi Specialties (GE Silicones) of Paris, France. The amino-substituted organosilane ester or ester equivalent reacts with the fluoropolymer in a process described further below to provide pendent siloxy groups that are available for forming siloxane bonds with other antireflection layers to improve interfacial adhesion between the layers. The coupling agent thus acts as an adhesion promoter between the layers.

### Epoxy Silane Ester Coupling Agent for Inorganic Oxide Matrix

In certain embodiments, an epoxy silane ester may be used in combination with silica nanoparticles (e.g., nanosilica dispersions and organo-silica sols).

Examples of such as epoxy-functional compounds include those of Formulas (VII), (VIII), (IX), and (X):

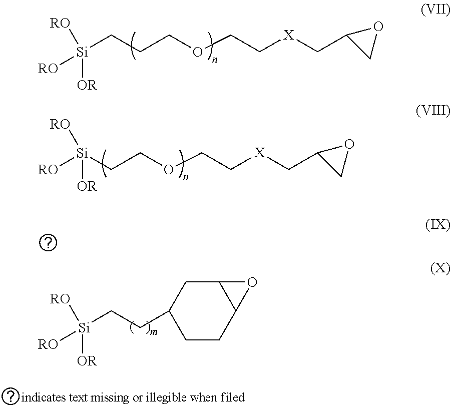

wherein:
X═CH₂, O, S, or NHC(O)R;
each R is independently —C₂H₅, —C₃H₇, or —C₄H₉;
n=0 to 10; and
m=1 to 4.

### Acrylic and Vinyl Silane Ester Coupling Agents for Inorganic Oxide Matrix

In certain embodiments, an acrylic silane ester or vinyl silane esters may be used in combination with silica nanoparticles (e.g., nanosilica dispersions and organo-silica sols). Such polymerizable alkoxysilyl-containing ethylenically unsaturated monomers may be used for anchoring the primer layer.

Examples of such monomers include those of the following general Formulas (XI), (XII), and (XIII):

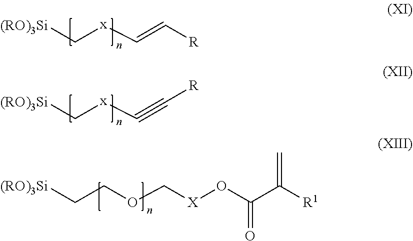

wherein for Formulas (XI) and (XII):
each R is independently H, —CH₃, —C₂H₅, —C₃H₇, or —C₄H₉;
X═CH₂ or 0; and
n=0 to 10;

wherein for Formula (XIII):
each R is independently H, —CH₃, —C₂H₅, —C₃H₇, or —C₄H₉;
R¹ is —CH₃ or H;
X═CH₂, O, S, or NHC(O)R²;
R² is independently —C₂H₅, —C₃H₇, or —C₄H₉; and
n=0 to 10.

Examples of suitable polymerizable alkoxysilyl-functional (meth)acrylates include 3-(methacryloyloxy)propyl]trimethoxysilane (i.e., 3-(trimethoxysilyl)propyl methacrylate, available under the tradename A174 from Momentive Performance Materials, Waterford, N.Y.), 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, and combinations thereof.

An organic peroxide exemplified by benzoyl peroxide, Luperox 101, Luperox 130, or a UV curable initiator may be included. Useful free-radical photoinitiators include, for example, benzoin ethers such as benzoin methyl ether and benzoin isopropyl ether, substituted benzoin ethers (e.g., anisoin methyl ether), substituted acetophenones (e.g., 2,2-dimethoxy-2-phenylacetophenone), substituted alpha-ketols (e.g., 2-methyl-2-hydroxypropiophenone), benzophenone derivatives (e.g., benzophenone), and acylphosphine oxides. Exemplary commercially available photoinitiators include photoinitiators under the tradename IRGACURE (e.g., IRGACURE 651, IRGACURE 184, and IRGACURE 819) or DAROCUR (e.g., DAROCUR 1173, DAROCUR 4265) from Ciba Specialty Chemicals, Tarrytown, N.Y., and under the tradename LUCIRIN (e.g., LUCIRIN TPO) from BASF, Parsippany, N.J.

### Metal Silicate Coupling Agents for Inorganic Oxide Matrix

In certain embodiments, a metal silicate may be used in combination with silica nanoparticles (e.g., nanosilica dispersions and organo-silica sols). Examples of suitable metal silicates include lithium silicate, sodium silicate, potassium silicate, or combinations thereof.

In certain embodiments of an inorganic oxide matrix top layer, a metal silicate is present in an amount of at least 1 wt-%, or at least 5 wt-%, based on the total weight of the dried inorganic oxide matrix top layer. In certain embodiments, a metal silicate is present in an amount of up to 30 wt-%, or up to 20 wt-%, based on the total weight of the dried inorganic matrix top layer.

### Optional Additives for Inorganic Oxide Matrix

In certain embodiments, a polyvalent metal cation salt may be combined with (e.g., dissolved in) an acidified nanoparticle-containing composition thereby providing the initial coatable composition to form the inorganic oxide matrix. Suitable metal cations contained in the metal salts may have a charge of n+, wherein n represents an integer ≥2 (e.g., 2, 3, 4, 5, or 6), for example.

In certain embodiments, at least one titanium compound, and optionally at least one other metal compound, may be combined with (e.g., dissolved in) an acidified nanoparticle-containing composition thereby providing the initial coatable composition to form the inorganic oxide matrix. Useful titanium compounds include, for example, TiOSO₄.2H₂O, TiOSO₄.H₂SO₄.xH₂O, TiOCl₂, and TiCl₄. Optional metal compound(s) (and any metal cations contained therein) may include a metal (or metal cation), other than titanium, in any of groups 2 through 15 (e.g., group 2, group 3, group 4, group 5, group 6, group 7, group 8, group 9, group 10, group 11, group 12, group 13, group 14, group 15, and combinations thereof) of the Periodic Table of the Elements.

In certain embodiments of a dried inorganic oxide matrix, a polyvalent metal cation salt is present in an amount of at least 1 wt-%, at least 3 wt-%, or at least 5 wt-%, based on the total weight of the dried inorganic matrix top layer. In certain embodiments, a polyvalent metal cation salt is present in an amount of up to 20 wt-%, or up to 10 wt-%, based on the total weight of the dried inorganic matrix top layer.

In certain embodiments, a polyvalent metal compound may be combined with (e.g., dissolved in) an acidic nanoparticle dispersion to reinforce the network of inorganic oxide matrix and/or enhance interfacial adhesion to other materials in the layer. Suitable metal cations contained in the metal compounds may have a charge of n+, wherein n represents an integer ≥2 (e.g., 2, 3, 4, 5, or 6), for example. Examples of useful metal compounds include copper compounds (e.g., CuCl₂ or Cu(NO₃)₂), platinum compounds (e.g., H₂PtCl₆), aluminum compounds (e.g., Al(NO₃)₃.9H₂O), zirconium compounds (e.g., ZrCl₄ or ZrOCl₂.8H₂O), zinc compounds (e.g., Zn(NO₃)₂.6H₂O), iron compounds (e.g., FeCl₃.6H₂O or FeCl₂), tin compounds (e.g., SnCl₂ and SnCl₄.5H₂O), nickel compounds (e.g., NiCl₂), and combinations thereof.

Coatable compositions useful for forming an inorganic oxide matrix may further include one or more optional additives such as, for example, colorant(s), surfactant(s), thickener(s), thixotrope(s), or leveling aid(s). Optional other ingredients

### Useful Inorganic Polymers/Oligomers for Inorganic Oxide Matrix

In certain embodiments, the inorganic oxide matrix includes the product of hydrolysis and condensation of a hydrolyzable organosilicate (e.g., tetraethoxysilane (TEOS) or tetramethoxysilane (TMOS)) in the presence of hydrolyzable organosilane. Such products may be in the form of polymers or oligomers.

In certain embodiments, the hydrolyzable organosilane is represented by Formula XIV:

Si(OR²)₃

wherein each R¹ and R² is independently a (C1-C4)alkyl.

The ratio of a hydrolysable organosilicate to an organosilane can be in a range of 100:0 to 70:30, preferably in a ratio of 100:0 to 85:15, and more preferably in a ratio of 100:0 to 92:8.

### Optional Organic Binder

In certain embodiments, the top layer further includes an organic binder in combination with the inorganic oxide matrix.

In certain embodiments, the organic binder is present in an amount of at least 1 wt-%, at least 3 wt-%, or at least 5 wt-%, based on the total weight of the top layer. In certain embodiments, the organic binder is present in an amount of up to 30 wt-%, or up to 20 wt-%, based on the total weight of the top layer.

In certain embodiments, the organic binder includes one or more polymers such as a cured polyepoxy, polyurethane, poly(meth)acrylate, silicone, polyimide, or polyimide-amide. Such organic polymers may be thermally or UV cured.

### Release Liner

Tapes of the present disclosure also optionally include a release liner disposed on the pressure sensitive adhesive layer. For those embodiments that include two pressure sensitive adhesive layers (a first and a second pressure sensitive adhesive layer), a release liner is typically disposed on each of the pressure sensitive adhesive layers (a first and a second release liner, respectively). In such embodiments, the release liners may be the same or different. In embodiments in which the top layer includes a pressure sensitive adhesive, the release liner disposed thereon may be referred to as the top layer release liner.

In certain embodiments, the release liner includes a fluoropolymer-coated release liner. In certain embodiments, the fluoropolymer is a fluorosilicone polymer or a fluoroether polymer. In certain embodiments, the fluoropolymer is a fluorosilicone polymer.

Generally, any known fluorosilicone polymer having at least two crosslinkable reactive groups, e.g., two ethylenically-unsaturated organic groups, may be used as the fluorosilicone polymer. In some embodiments, the fluorosilicone polymer includes two terminal crosslinkable groups, e.g., two terminal ethylenically unsaturated groups. In some embodiments, the fluorosilicone polymer includes pendant functional groups, e.g., pendant ethylenically unsaturated organic groups.

A number of useful, commercially available, fluorosilicone polymers are available from Dow Corning Corp. (Midland, Mich.) under the SYL-OFF series of trade designations including, e.g., SYL-OFF Q2-7785 and SYL-OFF 7786. Other fluorosilicone polymers are commercially available from Momentive (Columbus, Ohio), Shin-Etsu Chemical Company (Japan) and Wacker Chemie (Germany). Additional fluorosilicone polymers are described as component (e) at column 5. Line 67 through column 7, line 27 of U.S. Pat. No. 5,082,706 (Tangney).

Functional fluorosilicone polymers are particularly useful in forming release coating compositions when combined with a suitable crosslinking agent. Suitable crosslinking agents are generally known. Exemplary crosslinking agents include organohydrogensiloxane crosslinking agents, i.e. siloxane polymers containing silicon-bonded hydride groups. Suitable hydride functional, silicone crosslinking agents include those available under the trade designations SYL-OFF 7488, SYL-OFF 7048 and SYL-OFF 7678 from Dow Corning Corp. Suitable hydride-functional, fluorosilicone crosslinking agents include those available under the trade designations SYL OFF Q2-7560 and SL-7561 from Dow Corning Corp. Other useful crosslinking agents are disclosed in U.S. Pat. No. 5,082,706 (Tangney) and U.S. Pat. No. 5,578,381 (Hamada et al.).

In certain embodiments, the fluoropolymer is a fluoroether polymer, such as a perfluoropolyether and a fluoroether diacrylate polymer. Suitable release liners are described in U.S. Pat. No. 4,472,480 (Olson), which describes a liner comprising an insoluble polymer of polymerized, film-forming monomer having a polymerizable functionality greater than 1 and a perfluoropolyether segment which is a plurality of perfluoroalkylene oxide, —CₐF₂ₐO—, repeating units, where subscript a in each such unit is independently an integer from 1 to 4, which segment preferably has a number average molecular weight of 500 to 20,000.

In certain embodiments, the release liner has a thickness of 2 mils (50 micrometers)+/−0.025 mil (0.64 micrometer).

In certain embodiments, the release liner is a fluoropolymer-coated polyester release liner. An exemplary fluoropolymer-coated polyester release liner, having a thickness of about 50 micrometers, is available under the trade designation “3M SECONDARY LINER 5932.”

### EMBODIMENTS

The following embodiments are intended to be illustrative of the present disclosure and not limiting.

Embodiment 1 is a tape comprising: an elastomeric backing layer having two major surfaces, wherein the backing layer comprises a high consistency silicone elastomer; a flexible intermediate layer disposed on a first major surface of the backing layer, wherein the flexible intermediate layer comprises a cured epoxy-based material; and a (first) pressure sensitive adhesive layer disposed on the flexible intermediate layer, wherein the pressure sensitive adhesive layer comprises a silicone pressure sensitive adhesive; wherein the tape has a tensile elongation of at least 100%, according to the Tensile Properties—Method B Test (in the Examples Section).

Embodiment 2 is the tape of embodiment 1 which is a masking tape (preferably a thermal spray masking tape).

Embodiment 3 is the tape of embodiment 1 or 2 which has a tensile elongation of at least 200% (or at least 300%, at least 400%, at least 500%, or at least 600%), according to the Tensile Properties—Method B Test.

Embodiment 4 is the tape of any of embodiments 1 to 3 wherein the elastomeric backing layer has a Shore A hardness of at least 40 (or at least 45, at least 50, or at least 55).

Embodiment 5 is the tape of any of embodiments 1 to 4 wherein the elastomeric backing layer has a Shore A hardness of up to 80 (or up to 75).

Embodiment 6 is the tape of any of embodiments 1 to 5 wherein the elastomeric backing layer has a toughness (i.e., an energy/volume at break) of greater than 25 MPa (or greater than 30 MPa).

Embodiment 7 is the tape of any of embodiments 1 to 6 wherein the elastomeric backing layer has a toughness (i.e., an energy/volume at break) of up to 60 MPa.

Embodiment 8 is the tape of any of embodiments 1 to 7 wherein the elastomeric backing layer has a tan(δ) at 10000 Hz and 20° C. of greater than 0.04 (or greater than 0.099, greater than 0.110, greater than 0.120, or greater than 0.130).

Embodiment 9 is the tape of any of embodiments 1 to 8 wherein the elastomeric backing layer is an addition cured material, a condensation cured material, or a peroxide cured material.

Embodiment 10 is the tape of embodiment 9 wherein the elastomeric backing layer is a peroxide cured material.

Embodiment 11 is the tape of embodiment 10 wherein the elastomeric backing layer is an addition cured material.

Embodiment 12 is the tape of embodiment 10 wherein the elastomeric backing layer is a platinum-catalyzed addition cured material.

Embodiment 13 is the tape of embodiment 12 wherein the elastomeric backing layer comprises a product of a platinum-catalyzed addition cure reaction of a reaction mixture comprising vinyl-functional polydimethylsiloxane and a methyl hydrogen polysiloxane.

Embodiment 14 is the tape of any of embodiments 1 to 9 wherein the elastomeric backing layer is a non-fiber reinforced backing layer.

Embodiment 15 is the tape of any of embodiments 1 to 14 wherein the elastomeric backing layer is a non-reticulated (i.e., non-foamed) backing layer (i.e., substantially free of cells or voids).

Embodiment 16 is the tape of any of embodiments 1 to 14 wherein the elastomeric backing layer comprises cells or voids (e.g., closed cells).

Embodiment 17 is the tape of any of embodiments 1 to 16 wherein the elastomeric backing layer further comprises an inorganic filler mixed within the silicone elastomer.

Embodiment 18 is the tape of any of embodiments 1 to 17 wherein the elastomeric backing layer further comprises a pigment, a heat stabilizer, a filler (e.g., a micropowder for abrasion resistance), or a combination thereof.

Embodiment 19 is the tape of any of embodiments 1 to 18 wherein the flexible intermediate layer provides a barrier function.

Embodiment 20 is the tape of any of embodiments 1 to 19 wherein the flexible intermediate layer provides a priming function.

Embodiment 21 is the tape of any of embodiments 1 to 20 wherein the flexible intermediate layer comprises one or more layers.

Embodiment 22 is the tape of embodiment 21 wherein the flexible intermediate layer comprises one layer.

Embodiment 23 is the tape of embodiment 21 wherein the flexible intermediate layer comprises two layers.

Embodiment 24 is the tape of embodiment 23 wherein the two layers of the flexible intermediate layer comprises a primer layer and a barrier layer.

Embodiment 25 is the tape of any of embodiments 1 to 24 wherein the flexible intermediate layer comprises a primer layer comprising a cured epoxy-based material.

Embodiment 26 is the tape of any of embodiments 1 to 25 wherein the flexible intermediate layer comprises a barrier layer comprising a cured epoxy-based material.

Embodiment 27 is the tape of any of embodiments 1 to 26 wherein the cured epoxy-based material is prepared from a curable epoxy/thiol resin composition, a curable epoxy/amine resin composition, or a combination thereof.

Embodiment 28 is the tape of embodiment 27 wherein the epoxy-based material is prepared from a curable epoxy/thiol resin composition.

Embodiment 29 is the tape of embodiment 28 wherein the curable epoxy/thiol resin composition comprises: an epoxy resin component comprising an epoxy resin having at least two epoxide groups per molecule; a thiol component comprising a polythiol compound having at least two primary thiol groups; a silane-functionalized adhesion promoter; a nitrogen-containing catalyst for curing the epoxy resin component; and an optional cure inhibitor.

Embodiment 30 is the tape of any of embodiments 26 to 29 wherein the epoxy-based material is selected to provide a cured polymeric material that does not crack according to the Cylindrical Mandrel Bend Test and has a tensile elongation of at least 100%, according to the Tensile Properties—Method A Test.

Embodiment 31 is the tape of any of embodiments 1 to 30 wherein the silicone pressure sensitive adhesive is prepared from a composition comprising a polydiorganosiloxane.

Embodiment 32 is the tape of embodiment 31 wherein the silicone pressure sensitive adhesive is prepared from a composition comprising a peroxide curative.

Embodiment 33 is the tape of embodiment 32 wherein the silicone pressure sensitive adhesive is prepared from a composition comprising a platinum catalyst and an optional crosslinker.

Embodiment 34 is the tape of any of embodiments 1 to 33 further comprising a release liner disposed on the pressure sensitive adhesive layer.

Embodiment 35 is the tape of embodiment 34 wherein the release liner comprises a fluoropolymer-coated polyester release liner.

Embodiment 36 is the tape of embodiment 35 wherein the fluoropolymer comprises a fluorosilicone polymer.

Embodiment 37 is the tape of any of embodiments 1 to 36 further comprising a top layer disposed directly on a second major surface of the backing layer, wherein the top layer comprises an inorganic oxide matrix or a second pressure sensitive adhesive layer comprising a silicone pressure sensitive adhesive.

Embodiment 38 is the tape of any of embodiments 1 to 36 further comprising:

a second flexible intermediate layer disposed on the second major surface of the backing layer, wherein the second flexible intermediate layer comprises a cured epoxy-based material; and

a top layer disposed on the second flexible intermediate layer, wherein the top layer comprises an inorganic oxide matrix or a second pressure sensitive adhesive layer comprising a silicone pressure sensitive adhesive.

Embodiment 39 is the tape of any of embodiments 1 to 36 further comprising:

a primer layer disposed on a second major surface of the backing layer; and

a top layer disposed on the primer layer, wherein the top layer comprises an inorganic oxide matrix or a second pressure sensitive adhesive layer comprising a silicone pressure sensitive adhesive.

Embodiment 40 is the tape of embodiment 39 wherein the primer layer comprises a silicone.

Embodiment 41 is the tape of embodiment 40 wherein the silicone comprises a room temperature vulcanizing silicone based on a platinum cured addition reaction.

Embodiment 42 is the tape of any of embodiments 37 to 41 wherein the top layer comprises an inorganic oxide matrix and an optional organic binder.

Embodiment 43 is the tape of embodiment 42 wherein the inorganic oxide matrix is formed from Al₂O₃ particles, CaCO₃ particles, TiO₂ particles, ZrO₂ particles, Sift particles, iron oxide particles, clay particles, and combinations thereof.

Embodiment 44 is the tape of embodiment 42 or 43 wherein the inorganic oxide matrix comprises a silica network (preferably, a crosslinked and/or interconnected amorphous silica network).

Embodiment 45 is the tape of embodiment 44 wherein the silica network is formed from silica nanoparticles (preferably, the silica nanoparticles have a polymodal particle size distribution).

Embodiment 46 is the tape of embodiment 45 wherein the silica network is formed from silica nanoparticles and a coupling agent.

Embodiment 47 is the tape of embodiment 42 wherein the inorganic oxide matrix comprises the product of hydrolysis and condensation of a hydrolyzable organosilicate in the presence of hydrolyzable organosilane.

Embodiment 48 is the tape of any of embodiments 42 to 47 wherein the top layer further comprises an organic binder.

Embodiment 49 is the tape of embodiment 48 wherein the organic binder is present in an amount of at least 1 wt-% (or at least 3 wt-%, at least 5 wt-%), based on the total weight of the top layer.

Embodiment 50 is the tape of embodiment 48 or 49 wherein the organic binder is present in an amount of up to 30 wt-% (or up to 20 wt-%), based on the total weight of the top layer.

Embodiment 51 is the tape of any of embodiments 48 to 50 wherein the organic binder comprises a cured polyepoxy, polyurethane, poly(meth)acrylate, silicone, polyimide, polyimide-amide.

Embodiment 52 is the tape of any of embodiments 37 to 41 wherein the pressure sensitive adhesive layer is a first pressure sensitive adhesive layer and wherein the top layer comprises a second pressure sensitive adhesive comprising a silicone pressure sensitive adhesive.

Embodiment 53 is the tape of embodiment 52 wherein the second pressure sensitive adhesive layer comprises a silicone pressure sensitive adhesive the same as the silicone pressure sensitive adhesive of the first pressure sensitive adhesive layer.

Embodiment 54 is the tape of embodiment 52 or 53 wherein the top layer pressure sensitive adhesive comprises a silicone pressure sensitive adhesive prepared from a composition comprising a polydiorganosiloxane and a peroxide curative.

Embodiment 55 is the tape of embodiment 52 or 53 wherein the top layer silicone pressure sensitive adhesive is prepared from a composition comprising a polydiorganosiloxane, a platinum catalyst, and an optional crosslinker.

Embodiment 56 is the tape of any of embodiments 52 to 55 further comprising a release liner disposed on the top layer pressure sensitive adhesive.

Embodiment 57 is the tape of embodiment 56 wherein the top layer release liner comprises a fluoropolymer-coated polyester release liner.

Embodiment 58 is the tape of embodiment 57 wherein the fluoropolymer comprises a fluorosilicone polymer.

Embodiment 59 is a tape comprising: an elastomeric backing layer having two major surfaces, wherein the backing layer comprises a high temperature resistant and flame resistant elastomer; a pressure sensitive adhesive layer disposed on a first major surface of the elastomeric backing layer, wherein the pressure sensitive adhesive layer comprises a silicone pressure sensitive adhesive; and a top layer comprising an inorganic oxide network disposed on a second major surface of the elastomeric backing layer.

Embodiment 60 is the tape of embodiment 59 which has a tensile elongation of at least 5% (or at least 10%, at least 20%, at least 30%, at least 40%, at least 50%, at least 60%, at least 70%, at least 80%, at least 90%, at least 100%, at least 200%, at least 300%, at least 400%, at least 500%, or at least 600%), according to the Tensile Properties—Method B Test.

Embodiment 61 is the tape of embodiment 60 which has a tensile elongation of at least 100% (or at least 200%, at least 300%, at least 400%, at least 500%, or at least 600%), according to the Tensile Properties—Method B Test.

Embodiment 62 is the tape of any of embodiments 59 to 61 which is a masking tape (preferably a thermal spray masking tape).

Embodiment 63 is the tape of any of embodiments 59 to 62 wherein the high temperature resistant and flame resistant elastomer comprises a fluoroelastomer (FKM), a fluorosilicone (FVMQ), a perfluoroelastomer (FFKM), a silicone, or a polydimethylsiloxane.

Embodiment 64 is the tape of embodiment 63 wherein the high temperature resistant and flame resistant elastomer comprises a high consistency silicone elastomer.

Embodiment 65 is the tape of any of embodiments 59 to 64 wherein the top layer comprises an inorganic oxide matrix and an optional organic binder.

Embodiment 66 is the tape of embodiment 65 wherein the inorganic oxide matrix is formed from Al₂O₃ particles, CaCO₃ particles, TiO₂ particles, ZrO₂ particles, Sift particles, iron oxide particles, clay particles, and combinations thereof.

Embodiment 67 is the tape of embodiment 65 or 66 wherein the inorganic oxide matrix comprises a silica network (preferably, a crosslinked and/or interconnected amorphous silica network).

Embodiment 68 is the tape of embodiment 67 wherein the silica network is formed from silica nanoparticles (preferably, the silica nanoparticles have a polymodal particle size distribution).

Embodiment 69 is the tape of embodiment 68 wherein the silica network is formed from silica nanoparticles and a coupling agent.

Embodiment 70 is the tape of embodiment 65 wherein the inorganic oxide matrix comprises the product of hydrolysis and condensation of a hydrolyzable organosilicate in the presence of hydrolyzable organosilane.

Embodiment 71 is the tape of any of embodiments 65 to 70 wherein the top layer further comprises an organic binder.

Embodiment 72 is the tape of embodiment 71 wherein the organic binder is present in an amount of at least 1 wt-% (or at least 3 wt-%, at least 5 wt-%), based on the total weight of the top layer.

Embodiment 73 is the tape of embodiment 71 or 72 wherein the organic binder is present in an amount of up to 30 wt-% (or up to 20 wt-%), based on the total weight of the top layer.

Embodiment 74 is the tape of any of embodiments 71 to 73 wherein the organic binder comprises a cured polyepoxy, polyurethane, poly(meth)acrylate, silicone, polyimide, polyimide-amide.

Embodiment 75 is a tape comprising: an elastomeric backing layer having two major surfaces, wherein the backing layer comprises a high consistency silicone elastomer; a first pressure sensitive adhesive layer disposed on a first major surface of the elastomeric backing layer, wherein the first pressure sensitive adhesive layer comprises a silicone pressure sensitive adhesive; and a second pressure sensitive adhesive layer disposed on a second major surface of the elastomeric backing layer, wherein the second pressure sensitive adhesive layer comprises a silicone pressure sensitive adhesive; wherein the tape has a tensile elongation of at least 100%, according to the Tensile Properties—Method B Test (in the Examples Section).

Embodiment 76 is the tape of embodiment 75 further comprising a release liner disposed on each of the pressure sensitive adhesive layers.

Embodiment 77 is the tape of embodiment 75 or 76 which is a masking tape (preferably a thermal spray masking tape).

Embodiment 78 is the tape of any of embodiments 75 to 77 which has a tensile elongation of at least 200% (or at least 300%, at least 400%, at least 500%, or at least 600%), according to the Tensile Properties—Method B Test.

Embodiment 79 is the tape of any of embodiments 1 to 78 wherein the tape possesses resistance to flames and high temperature breakdown.

Embodiment 80 is the tape of embodiment 79 wherein the tape possesses resistance to flames, high temperature breakdown, high velocity particles and gases, and high gas pressures that occur when used during an HVOF thermal spray coating process.

### EXAMPLES

Objects and advantages of various embodiments of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Materials

| Designation | Description |
|---|---|
| Silicone | An uncured silicone rubber material, believed to be a platinum catalyst- |
| Rubber 1 | containing, filled, addition curable, high consistency silicone rubber, was |
| | obtained and provided to Alpha Associates, Incorporated, Lakewood, NJ |
| | who then processed and heat cured it to provide a sheet material having |
| | a nominal thickness of either 0.040 inch (1.0 millimeter) or 0.025 inch |
| | (0.64 millimeters), a nominal Shore A hardness of about 62, a tensile |
| | strength at break of 1300 pounds/square inch (9.0 megapascals), an |
| | elongation at break of 780%, a modulus of about 190 pounds/square |
| | inch (1.3 megapascals) at 50% elongation, and a tear strength of 49.0 |
| | kiloNewtons/meter was obtained from Alpha Associates, Inc., |
| | Lakewood, NJ. |
| Silicone | An uncured silicone rubber material, believed to be a peroxide-containing, |
| Rubber 2 | filled, high consistency silicone rubber, was obtained under the product |
| | designation SLM15029 from Wacker Chemical Corporation, Adrian, MI |
| | and provided to Alpha Associates, Incorporated, Lakewood, NJ who then |
| | processed and heat cured it to provide a sheet materials having a nominal |
| | thickness of 0.026 inch (0.66 millimeters), a nominal Shore A hardness |
| | of about 58, a tensile strength at break of 1500 pounds/square inch (10.3 |
| | megapascals), an elongation at break of 640%, a modulus of 220 |
| | pounds/square inch (1.5 megapascals) at 50% elongation, and a tear |
| | strength of 39.0 kiloNewtons/meter. |
| Silicone | An uncured silicone rubber material, believed to be a platinum catalyst- |
| Rubber 3 | containing, filled, addition curable, high consistency silicone rubber, was |
| | obtained from Momentive Performance Materials, Incorporated, Waterford, |
| | NY, and provided to Alpha Associates, Incorporated, Lakewood, NJ who |
| | then processed and heat cured it to provide a sheet material having a |
| | nominal thickness of 0.040 inch (1.0 millimeter), a nominal Shore A |
| | hardness of about 72, a tensile strength at break of 1200 pounds/square |
| | inch (8.3 megapascals), an elongation at break of 700%, a modulus of 286 |
| | pounds/square inch (2.0 megapascals) at 50% elongation, and a tear |
| | strength of 56.0 kiloNewtons/meter. |
| Silicone | An uncured silicone rubber material, believed to be a platinum catalyst- |
| Rubber 4 | containing, filled, addition curable, high consistency silicone rubber, was |
| | obtained from Momentive Performance Materials, Incorporated, Waterford, |
| | NY, and provided to Alpha Associates, Incorporated, Lakewood, NJ who |
| | then processed and heat cured to provide a sheet material having a |
| | nominal thickness of 0.040 inch (1.0 millimeter), a nominal Shore A |
| | hardness of 77, a tensile strength at break of 1047 pounds/square inch (7.2 |
| | megapascals), an elongation at break of 600%, a modulus of 344 pounds/ |
| | square inch (2.4 megapascals) at 50% elongation, and a tear strength of |
| | 52.0 kiloNewtons/meter, was obtained from Alpha Associates, |
| | Incorporated, Lakewood, NJ. |
| Silicone | A cured silicone rubber material, believed to be based on a platinum |
| Rubber 5 | catalyst-containing, filled, addition curable, high consistency silicone |
| | rubber, having a nominal thickness of 0.076 inch (1.9 millimeters), a |
| | nominal Shore A hardness of about 65, a tensile strength at break of 1230 |
| | pounds/square inch (8.5 megapascals), an elongation at break of 740%, a |
| | modulus of 230 pounds/square inch (1.6 megapascals) at 50% elongation, |
| | and a tear strength of 51.0 kiloNewtons/meter, was obtained from |
| | Momentive Performance Materials, Incorporated, Waterford, NY. |
| Silicone | A cured silicone rubber material, believed to be based on a platinum |
| Rubber 6 | catalyst-containing, filled, addition curable, high consistency silicone |
| | rubber, having a nominal thickness of 0.076 inch (1.9 millimeters), a |
| | nominal Shore A hardness of about 69, a tensile strength at break of 1425 |
| | pounds/square inch (9.8 megapascals), an elongation at break of 410%, a |
| | modulus of 250 pounds/square inch (1.7 megapascals) at 50% elongation, |
| | and a tear strength of 20.3 kiloNewtons/meter, was obtained from |
| | Momentive Performance Materials, Incorporated, Waterford, NY. |
| Silicone | A cured silicone rubber material, believed to be based on a platinum |
| Rubber 7 | catalyst-containing, filled, addition curable, high consistency silicone |
| | rubber, having a nominal thickness of 0.076 inch (1.9 millimeters), a |
| | nominal Shore A hardness of about 64, a tensile strength at break of 1280 |
| | pounds/square inch (8.8 megapascals), an elongation at break of 625%, a |
| | modulus of 204 pounds/square inch (1.4 megapascals) at 50% elongation, |
| | and a tear strength of 30.3 kiloNewtons/meter, was obtained from |
| | Momentive Performance Materials, Incorporated, Waterford, NY. |
| Silicone | A cured silicone rubber material, believed to be based on a platinum |
| Rubber 8 | catalyst-containing, filled, addition curable, high consistency silicone |
| | rubber, having a nominal thickness of 0.080 inch (2.0 millimeters), a |
| | nominal Shore A hardness of about 62, a tensile strength at break of 1490 |
| | pounds/square inch (10.3 megapascals), an elongation at break of 730%, a |
| | modulus of 167 pounds/square inch (1.2 megapascals) at 50% elongation, |
| | and a tear strength of 37.2 kiloNewtons/meter, was obtained from |
| | Momentive Performance Materials, Incorporated, Waterford, NY. |
| Silicone | A cured silicone rubber material, believed to be based on a platinum |
| Rubber 9 | catalyst-containing, addition curable, high consistency silicone rubber, |
| | was processed and heat cured to provide a sheet material having a |
| | nominal thickness of 0.075 inch (1.9 millimeters), a nominal Shore A |
| | hardness of 50, a tensile strength at break of 1700 pounds/square inch |
| | (11.6 megapascals), an elongation at break of 1035%, a modulus of 154 |
| | pounds/square inch (1.1 megapascals) at 50% elongation, and a tear |
| | strength of 40.6 kiloNewtons/meter, available under the trade designation |
| | ELASTOSIL R+4000/50, was obtained from Wacker Chemical |
| | Corporation, Adrian, MI. |
| Silicone | A cured silicone rubber material, believed to be based on a platinum |
| Rubber 10 | catalyst-containing, addition curable, high consistency silicone rubber, |
| | was processed and heat cured to provide a sheet material having a |
| | nominal thickness of 0.075 inch (1.9 millimeters), a nominal Shore A |
| | hardness of 61, a tensile strength at break of 1615 pounds/square inch |
| | (11.1 megapascals), an elongation at break of 900%, a modulus of 230 |
| | pounds/square megapascals) at 50% elongation, and a tear strength of |
| | 46.6 kiloNewtons/meter, available under the trade designation |
| | ELASTOSIL R+4000/60, was obtained from Wacker Chemical . |
| | Corporation, Adrian, MI |
| Silicone | A cured silicone rubber material, believed to be based on a platinum |
| Rubber 11 | catalyst-containing, addition curable, liquid silicone rubber, was |
| | processed and heat cured to provide a sheet material having a nominal |
| | thickness of 0.074 inch (1.9 millimeters), a nominal Shore A hardness |
| | of 52, a tensile strength at break of 1760 pounds/square inch (12.1 |
| | megapascals), an elongation at break of 600%, a modulus of 130 |
| | pounds/square inch (0.9 megapascals) at 50% elongation, and a tear |
| | strength of 23.8 kiloNewtons/meter, available under the trade |
| | designation ELASTOSIL LR 3003/50 A-B, from Wacker Chemical |
| | Corporation, Adrian, MI. |
| Silicone | A cured sheet of rubber material was obtained using the RTV Silicone |
| Rubber 12 | composition described in Table 14 in Example 11 below with the |
| | following modifications. No cure inhibitor was employed. The uncured |
| | composition was cured using the process described in the test method |
| | ″Tensile Properties—Method A″ below with the following modifications. |
| | The U-shaped rubber spacer had a nominal thickness of 0.040 inch (1.0 |
| | millimeter) and curing was done at room temperature (72° F. (22° C.)) for |
| | 24 hours. A transparent sheet material having a nominal thickness of 0.040 |
| | inch (1.0 millimeter), a nominal Shore A hardness of 46, a tensile strength |
| | at break of 980 pounds/square inch (6.8 megapascals), an elongation at |
| | break of 340%, a modulus of 150 pounds/square inch (1.0 megapascals) at |
| | 50% elongation, and a tear strength of 26.0 kiloNewtons/meter |
| | was obtained. |
| PY4122 | A flexible, difunctional bis-phenol A based epoxy resin having an epoxy |
| | equivalent weight of 313 to 390 grams/equivalent and the majority (at least |
| | 60 weight %) of which is 2,2′-[(1-methylethylidene)bis[4,1-phenyleneoxy |
| | [1-(butoxymethyl)ethylene]oxymethylene]]bisoxirane, available under the |
| | trade designation ARALDITE PY 4122 Resin from Huntsman Corporation, |
| | The Woodlands, TX. |
| | 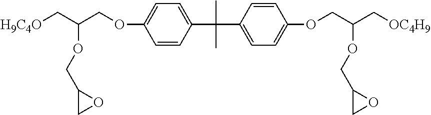 |
| MX150 | A liquid bisphenol A-based epoxy resin containing 40 weight % of |
| | polybutadiene (PBd)-acrylic core-shell rubber (CSR) particles, the |
| | composition having an epoxy equivalent weight of between 297 and 323 |
| | grams/equivalent and a viscosity of between 4000 and 33000 centipoise at |
| | 50° C., available under the trade designation KANE ACE MX-150 from |
| | Kaneka Corporation, Tokyo, Japan. |
| EPON 828 | A difunctional bis-phenol A/epichlorohydrin derived liquid epoxy resin |
| | having an epoxide equivalent weight of 185 to 192 grams/equivalent, |
| | available under the trade designation EPON 828 from Hexion |
| | Incorporated, Columbus, OH. |
| CE10P | The glycidyl ester of versatic acid 10, a synthetic saturated |
| | monocarboxylic acid of highly branched C10 isomers having an epoxy |
| | equivalent weight of approximately 240 grams / mole, available under |
| | the trade designation CARDURA E10P GLYCIDYL ESTER from |
| | Hexion Incorporated, Columbus, OH. |
| ETTMP | Ethoxylated-trimethylolpropane tris (3-mercaptopropionate), a |
| | trifunctional polythiol curing agent having a molecular weight of |
| | approximately 700 grams/mole, available under the trade designation |
| | THIOCURE ETTMP 700 from Evans Chematics, Teaneck, NJ. |
| PEMP | Pentaerythitol tetra(3-mercaptopropionate), a tetrafunctional polythiol |
| | curing agent having a molecular weight of 489 grams/mole, available |
| | under the trade designation THIOCURE PETMP from Evans Chematics, |
| | Teaneck, NJ. |
| K54 | 2,4,6-Tri(dimethylaminomethyl)phenol, a curing catalyst, available under |
| | the trade designation ANCAMINE K-54 from Evonik Industries, Essen, |
| | Germany. |
| K61B | An amine salt catalyst/curing agent composed of tris- |
| | (dimethylaminomethyl)phenol tri (2-ethyl hexoate) available under the |
| | trade designation ANCAMINE K61B from Evonik Corporation, |
| | Allentown, PA. |
| DBU | 1,8-Diazabicyclo(5.4.0)unde-7-ene, a curing catalyst, available from |
| | MilliporeSigma, St. Louis, MO. |
| BPBA | 1-Benzyl-5-phenyl barbituric acid, a substituted barbituric acid derivative |
| | having a molecular weight of 294.3 grams/mole, available from Chemische |
| | Fabrik Berg GmbH, Bitterfeld-Wolfen, Germany. This was employed as a |
| | 5 weight % solution in EPON 828. |
| OFS6040 | Glycidylpropyl trimethoxysilane, an adhesion promoter available under the |
| | trade designation XIAMETER OFS-6040 SILANE from Dow Corning |
| | Corporation, Midland, MI. |
| L07N | A pale yellow liquid containing a mixture of bisphenol A/epichlorohydrin |
| | derived epoxy resin, phenol novolac resin, and a borate ester compound, |
| | having a viscosity of 24 to 32 Pascal-seconds and a specific gravity of |
| | 1.15 grams/cubic centimeter at 20° C., which is described as an adduct |
| | stabilizer which may be used to provide improved storage stability to |
| | epoxy resins, available under the trade designation SHIKOKU |
| | CUREDUCT L-07N from Shikoku Chemicals Corporation, Marugame, |
| | Kagawa Prefecture, Japan. |
| FXR-1081 | A modified aliphatic polyamine latent curing agent and curing |
| | accelerator/catalyst provided as a white powder having an amine value of |
| | 110 to 120, an average particle size of 4 micrometers, and a softening |
| | point between 115 and 125° C., available under the trade designation |
| | FUJICURE FXR-1081 from T&K Toka Corporation, Iruma-Gun, |
| | Saitama, Japan. |
| TMPMP | Trimethylolpropane tris(3-mercaptopropionate), a trifunctional polythiol, |
| | curing agent having a molecular weight of 399 grams/mole, a hydrogen |
| | equivalent weight of 136-140 grams/equivalent, a rotational viscosity of |
| | 150 millipascal-seconds, available under the trade designation |
| | THIOCURE TMPMP from Evans Chematics, Teaneck, NJ. |
| GPM-800LO | A mercaptan terminated liquid curing agent having a mercaptan value of 3 |
| | to 4 milliequivalents/gram and a pH of 3 to 5, available under the trade |
| | designation GABEPRO GPM-800LO from Gabriel Performance Products |
| | Limited Liability Company, Akron, OH. |
| BYK 378 | A solvent free, polyether-modified poly(dimethylsiloxane) silicone surface |
| | additive, having a density of 1.02 grams/cubic centimeter at 20° C. and |
| | refractive index of 1.440 at 68° F., available under the trade designation |
| | BYK 378 from BYK USA, Wallingford, CT. |
| RTV Part A | A transparent material containing polydimethylsiloxane with vinyl groups, |
| | polydimethylsiloxane, and platinum catalyst, having a density of |
| | approximately 1.08 grams/cubic centimeter at 25° C., a dynamic viscosity |
| | of 40,000 to 70,000 millipascal-seconds at 23° C., available under the |
| | trade designation ELASTOSIL RTV M4641 PART A, from Wacker |
| | Chemical Corporation, Adrian, MI. |
| RTV Part B | A colorless material containing polydimethylsiloxane with functional |
| | groups. having a density of approximately 0.97 grams/cubic centimeter |
| | at 25° C., a dynamic viscosity of 500 to 1000 millipascal-seconds at |
| | 23° C., available under the trade designation ELASTOSIL RTV M4641 |
| | PART B, from Wacker Chemical Corporation, Adrian, MI. |
| Cure | A transparent liquid cure inhibitor containing vinyl-terminated |
| Inhibitor | polydimethylsiloxane plus auxiliary, having a density of approximately |
| | 0.97 grams/cubic centimeter at 25° C., a dynamic viscosity of 800 to |
| | 1200 millipascal-seconds at 23° C., available under the trade |
| | designation INHIBITOR PT 88, from Wacker Chemical Corporation, |
| | Adrian, MI. |
| IPA | Isopropyl alcohol, 99.5% minimum assay, available from VWR Analytical, |
| | Radnor, PA. |
| Organo- | A milky-white sol-gel dispersion of fumed silica in isopropanol, with a pH |
| Silica Sol | value of between 2.0 and 4.0, a density at 20° C. of between 0.96 and 1.02 |
| | grams/ cubic centimeter, a particle diameter range (by BET) of 10 to 15 |
| | nanometers, and a nominal SiO2 content of between 30% and 31%, |
| | available under the trade designation ORGANOSILICASOL IPA-ST, |
| | from Nissan Chemical America Corporation, Houston, TX. |
| N2326 | Ammonia-stabilized colloidal silica, 15 weight percent solids, a particle |
| | size of 5 nanometers, and a pH of 9, available under the trade designation |
| | NALCO 2326 from the Nalco Water Division of Ecolab Incorporated, |
| | Naperville, IL. |
| N1115 | Sodium-stabilized colloidal silica, 15 weight percent solids, a particle |
| | diameter of 4 nanometers, and a pH of 10.5, available under the trade |
| | designation NALCO 1115 from the Nalco Water Division of Ecolab |
| | Incorporated, Naperville, IL. |
| APS-1 | Gamma-aminopropyltrimethoxysilane, a clear colorless liquid, having a |
| | density at 20° C. of 0.95 grams/cubic centimeter and a refractive index |
| | at 25° C. of 1.420, available under the trade designation SILQUEST |
| | A-1100, from Momentive Performance Materials Incorporated, |
| | Waterford, NY. |
| APS-2 | 3 -aminopropyltriethoxy silane, available from Gelest Incorporated, |
| | Morrisville, PA. |
| OFS6040 | Glycidylpropyl trimethoxysilane, an adhesion promoter available under the |
| | trade designation XIAMETER OFS-6040 SILANE from Dow Corning |
| | Corporation, Midland, MI. |
| ES | (3-Glycidoxypropyl)trimethoxysilane, available from Gelest Incorporated, |
| | Morrisville, PA. |
| VS | Vinyltrimethoxysilane, available from Gelest Incorporated, Morrisville, PA. |
| TMOS | Tetramethoxysilane (TMOS) 98%, available from Alfa Aesar, Tewksbury, |
| | MA. |
| Release | A 0.002 inch (50 micrometer) thick polyester film having a silicone |
| Liner | coating on one side (believed to be fluorosilicone) and exhibiting a |
| | release force of 15 grams/inch, available under the trade designation |
| | SILFLU S 50 M 1R88001 CLEAR, from Siliconature Limited Liability |
| | Company, Chicago, IL. |
| Silicone PSA | A silicone pressure sensitive adhesive containing polysiloxane gum and |
| | resin, provided as a toluene solution having 61 weight % silicone solids |
| | and a viscosity of 85,000 centipoise at 25° C., available under the trade |
| | designation SILGRIP PSA810, from Momentive Performance Materials |
| | Incorporated, Waterford, NY, 12188. |
| Silicone | A silicone resin solution having 60 weight % silicone solids in toluene, a |
| Resin | density of 1.05 grams/cubic centimeter, and a viscosity of 11 centipoise at |
| | 25° C., available under the trade designation SILGRIP SR545 RESIN, |
| | from Momentive Performance Materials Incorporated, Waterford, NY. |
| DBPO | A white, free flowing powder containing 77 weight % dibenzoyl peroxide |
| | with the remainder being absorbed water, available under the trade |
| | designation LUPEROX A75 from Arkema Incorporated, King of Prussia, |
| | PA 19406. |
| SR500 | A silicone primer solution containing the tetraethyl ester of silicic acid and |
| | octamethylcyclotetrasiloxane at 9 to 13 weight % solids in a solvent |
| | system that is primarily hexanes and a lesser amount of toluene, having a |
| | density of 0.71 grams/cubic centimeter and a viscosity of between 2 and |
| | 10 centipoise at 25° C., available under the trade designation SILGRIP |
| | SR500, from Momentive Performance Materials, Incorporated, |
| | Waterford, NY. |
| 91022 | An adhesive transfer tape having a 0.002 inch (51 micrometer) thick |
| | silicone adhesive on a 0.002 inch (51 micrometer) thick, white colored |
| | polyester liner with differential release, available under the trade |
| | designation 3M ADHESIVE TRANSFER TAPE 91022 from 3M |
| | Company, St. Paul, MN. |
| CT 1 | A silicone coated, fiberglass tape having a nominal thickness of 0.020 inch |
| | (0.51 millimeters) and engineered for gas fueled HVOF, available under |
| | the trade designation HVMT ORANGE from Green Belting Industries |
| | Limited, Buffalo, NY. |
| CT 2 | A high temperature Thermal Spray masking tape constructed of glass cloth |
| | and silicone rubber and designed for severe HVOF applications, available |
| | under the trade designation DeWAL DW 500-40 from Rogers Corporation, |
| | Narragansett, RI. |
| CT 3 | A high temperature Thermal Spray masking tape containing a laminate of |
| | glass cloth, blue silicone rubber, and 0.004 inch (0.10 millimeters), and |
| | designed for severe duty including HVOF applications, available under the |
| | trade designation DeWAL DW 501 from Rogers Corporation, Narragansett, |
| | RI. |
| CT 4 | A glass-silicone pressure sensitive adhesive tape designed for both grit |
| | blasting and plasma spray processes, having a fiberglass/silicone rubber |
| | backing with a thickness of 0.178 millimeters, a high temperature silicone |
| | adhesive with a thickness 0.089 millimeters, an overall tape thickness of |
| | 0.267 millimeters, available under the trade designation CHR TAPE 2975- |
| | 8R from Saint-Gobain Performance Plastics Composites Corporation - |
| | North America, Hoosick Falls, NY. |
| CT 5 | A heavy duty pressure sensitive tape used for thermal spray masking and |
| | high velocity oxygenated fuel (HVOF) processes, having a fiberglass- |
| | silicone backing with a thickness of 0.445 millimeters, a silicone adhesive |
| | with a thickness 0.089 millimeters, an overall tape thickness of 0.533 |
| | millimeters, available under the trade designation CHR TAPE H7575 |
| | from Saint-Gobain Performance Plastics Composites Corporation - North |
| | America, Hoosick Falls, NY. |
| IEx | A gel type strongly acidic cation exchange resin of the sulfonated |
| | polystyrene type, available under the trade designation AMBERLITE |
| | IR120 H from Alfa Aesar, Tewksbury, MA. |
| Nitric Acid | Nitric Acid GR ACS, having a concentration of between 50 and 70%, |
| | available from EMD Millipore Corporation, Billerica, MA. |
| ALN | Aluminum nitrate nonahydrate, 90-100%, having a molecular weight of |
| | 375.1 grams/mole, available under the trade designation from Sigma- |
| | Aldrich Corporation, Saint Louis, MO. |
| X-100 | 4-(1,1,3,3-Tetramethylbutyl)phenyl-polyethylene glycol, 90-100%, available |
| | under the trade designation TRITON X-100 from Sigma-Aldrich |
| | Corporation, Saint Louis, MO. |

### Test Methods

### Peel Adhesion Strength—Method A

The peel adhesion strength of a tape sample was evaluated generally according to ASTM D3330: “Standard Test Method for Peel Adhesion of Pressure-Sensitive Tape—Test Method F” with certain modifications to conditioning, peel rate, initial delay time, and measurement time as summarized below. An IMASS SP-2000 Slip/Peel Tester having a load cell force ranging from 10 grams to 10 kilograms (0.022 to 22 pounds-force) and equipped with a Variable Angle Peel Fixture was employed (IMASS, Incorporated, Accord, Mass.). Stainless steel panels measuring 2 inches wide by 5 inches long by 0.050 inch thick (5 centimeters by 12.7 centimeters by 1.27 millimeters) were wiped clean two times using methyl ethyl ketone (MEK) and a clean lint-free tissue followed by 2 times using heptane and a clean lint-free tissue. A tape sample measuring 1 inch wide by 6 inches long (2.5 centimeters by 15.2 centimeters) was provided. After removal of the release liner the tape sample was placed and centered along the length of the cleaned stainless steel panel such that one end of the tape sample extended at least 1 inch (2.5 centimeters) beyond one end of the panel to serve as a gripping tab. The entire length of the tape sample was then rolled down using one pass of a 4.5 pound (2.04 kg) rubber coated automatic roller to provide a test assembly of a stainless steel panel having a tape sample thereon. The test assembly was allowed to dwell for about 30 minutes at 73.4° F. (23″C) and 50% RH prior to evaluation. The conditioned test assembly was placed onto the IMASS Peel Tester. The gripping tab end of the tape was then used to peel the tape sample at angle of 90 degrees and a peel rate of 12 inches/minute (30.5 centimeters/second). The average peel adhesion strength was recorded in ounces (oz)/inch and also reported in Newtons/decimeter (N/dm). Between two and three tests were obtained from each tape sample.

### Peel Adhesion Strength—Method B

The peel adhesion strength of a silicone pressure sensitive adhesive to the top coating layer of a coated silicone rubber substrate was measured as described in the test method “Peel Adhesion Strength—Method A” with the following modifications. Coated silicone rubber substrates having various top layers thereon were adhered to the stainless steel test panel. If the coated silicone rubber substrate did not have an adhesive on the side opposite the top layer, then a double-sided tape was used to adhere the coated substrate to the test panel. A sample of a coated silicone rubber substrate that contained a silicone pressure sensitive adhesive on the side of the rubber substrate opposite that having the top coating layer was adhered to the first coated silicone rubber substrate such that the silicone pressure sensitive adhesive of the second sample was brought into intimate contact with the top coating layer of the first coated silicone rubber substrate, and then rolled down using 4.5 pound (2.04 kg) rubber coated automatic roller. In some instances samples were aged then allowed to equilibrate back to room temperature before testing. The aging conditions were one of the following. Condition A: two weeks at 120° F. (49° C.); Condition B: four weeks at 120° F. (49° C.); and Condition C: two weeks at 90° F. (32° C.) and 90% relative humidity (RH). The average peel adhesion strength was recorded in ounces (oz)/inch and also reported in Newtons/decimeter (N/dm).

### Peel Adhesion Strength—Method C

Peel adhesion strength was subjectively evaluated as follows. A sample of the Test Tape prepared as described in the test method “T-Peel Adhesion Strength—Method B” was applied with its adhesive surface in contact with the top coated side of a silicone rubber substrate and rubbed down by hand to provide a test article. The Test Tape was then peeled back at an angle of approximately 180 degrees. If removal of the Test Tape visually caused some elongation of the top coated silicone rubber substrate the test article was rated “Pass” indicating the bond was sufficiently strong. If removal of the Test Tape did not cause a slight elongation of the top coated rubber substrate then the test article was rated “Fail”. All evaluations were done at room temperature, with some test articles being tested after standing several days at room temperature.

### T-Peel Adhesion Strength—Method A

An uncured epoxy resin composition was applied onto the corona-treated surface of a silicone rubber sheet measuring 6 inches wide by 8 inches long (15.2 centimeters by 20.3 centimeters) and having a thickness ranging from 0.043 to 0.059 inch (1.1 to 1.5 millimeters) using a knife coating apparatus to provide a coated thickness of 0.003 inch (76 micrometers). The corona treatment of the silicone rubber was completed no more than 2 weeks prior to use. Prior to application, the last 1 inch (2.5 centimeters) of length at one end of the rubber sheet was taped off to enable separation of a second substrate from the first one. After application, the corona-treated surface of a second sample of the same silicone rubber sheet was pressed against the exposed uncured epoxy resin composition. This assembly was then cured using one of the following protocols: 1) for one hour at 212° F. (100° C.) in an oven (for the one-part compositions); 2) 24 hours at room temperature followed by 30 minutes at 176° F. (80° C.) (Example 7); or 3) for 24 hours at room temperature (Example 8). After curing, 0.5 inch (12.5 millimeters) was trimmed off each lengthwise edge of the resulting laminate structure. Next, five samples measuring 1 inch by 8 inches (2.54 centimeters by 20.3 centimeters) were cut and evaluated for peel adhesion strength at room temperature in a T-peel mode (180 degree angle of peel) using a tensile testing machine with a 200 pound-force load cell. The crosshead speed was 12 inches/minute (30.5 centimeters/minute). One free end (resulting from the taped off section) of the laminate sample was clamped in the upper jaw of the tensile testing machine and the remaining free end was clamped in the lower jaw. Data obtained from the first inch of peel length was ignored and the data from the next four inches was recorded. The average of three to five samples was reported in ounces/inch (Newtons/decimeter). The failure mode(s) was also recorded as follows: cohesive (the failure occurred within the epoxy resin composition) or substrate (the silicone rubber tore).

### T-Peel Adhesion Strength—Method B

A Test Tape article was prepared in the following manner. Two separate solutions were prepared, one containing Organo-Silica Sol at a concentration of 2.5% by weight in IPA and the other containing APS-2 at a concentration of 2.5% by weight in IPA. These were combined to give Organo-Silica Sol:APS-2 ratio of 95:5 (w:w) in IPA. This solution was used, along with a #10 wire wound Mayer Rod, to coat the corona treated side of a 0.001 inch (25 micrometers) thick polyester (PET) film which was then dried in a forced air oven at 220° F. (104° C.) for 5 minutes. A silicone pressure sensitive adhesive transfer tape (ATT), prepared as described in Example 11 and having one of its Release Liners removed, was then laminated to the coated side of the PET film such that the exposed adhesive surface of the ATT was brought into intimate contact with the coated surface of the PET film and air bubbles were excluded. A Test Tape article was thereby provided.

Various top layers were coated onto Silicone Rubber 1 using a #18 wire wound Mayer rod, then dried and cured for 5 minutes at 149° C. in a forced air oven. Silicone rubber substrates having various silica-containing top layers thereon were obtained.

Both the Test Tape article and the silicone rubber substrates having various silica top layers thereon were then cut into strips measuring approximately 1 inch (2.54 centimeters) wide×6 inches (15.2 centimeters) long and laminated together, by hand at room temperature using a 2 inch (5.1 centimeters) rubber hand roller, such that the exposed (after removal of the second Release Liner) surface of the silicone adhesive of the Test Tape article was brought into intimate contact with the silica layer of the coated rubber substrate.

The resulting multilayer test article was evaluated by peeling back about 1 inch (2.5 centimeters) of the Test Tape from the silicone rubber substrate to provide a tab portion on the Test Tape. The exposed portion of the silicone rubber substrate was attached to a hanger in a 350° F. (177° C.) forced air oven and allowed to equilibrate for 10 minutes. After 10 minutes a 300 gram weight was hung from the tab portion of the Test Tape using a metal binder clip and the Test Tape was allowed to peel away from the silicone rubber substrate at an angle of 180 degrees. The weight was observed through a window in the oven and its rate of peel determined visually. A rate of less than one inch per 10 seconds was defined as “Pass” while a rate of one inch or more per 10 seconds was defined as “Fail”. In addition, the failure mode (Cohesive, Adhesive, Mixed) was also recorded. A cohesive failure mode is most desirable with a Mixed failure mode being less so. An adhesive failure mode is unacceptable.

### Tensile Properties—Method A

Tensile properties were measured according to the test method ASTM 638-08: “Standard Test Method for Tensile Properties of Plastics.” Tensile test specimens were prepared by providing an assembly having in order from bottom to top, and lying flat on a benchtop: a first glass plate, a release liner over the glass plate, a U-shaped rubber spacer having a nominal thickness of 0.062 inch (1.57 millimeters) and an open area inside the U-shape, uncured epoxy resin inside the open area of the spacer, a release liner over the uncured epoxy, and a second glass plate. Metal binder clips were used to secure the assembly together. The assembly was placed in an oven at 212° F. (100° C.) for one hour. After curing a cured sample of epoxy resin was removed from the assembly and then cut into test specimens using an ASTM 638-08 Type V die and evaluated at a strain rate of 5 centimeters/minute using an INSTRON Model 1122 Tensile Tester (Instron, Norwood, Mass.). The modulus (pounds per square inch (psi) and megapascals (MPa)) and ultimate (at break) elongation (%) were reported.

### Tensile Properties—Method B

Tapes were tested in accordance with ASTM D-3759/D3759M-05 Standard Test Method for Breaking Strength and Elongation of Pressure-Sensitive Tape with the following modifications. For the non-extensible tape samples, Procedure A was followed with the following note: the tape samples were 1-inch (2.54 centimeter) wide. For the high extensible tape samples, Procedure C was followed using the following modification: crosshead speed was 10 inch/minute (254 millimeters/minutes). Two or three test specimens were evaluated and the average tensile elongation at break (%) was reported.

### Tensile Properties—Method C

The ultimate (breaking) tensile stress and strain for various silicone rubber substrates was determined as described in ASTM D412-15: “Standard Test Methods for Vulcanized Rubber and Thermoplastic Elastomers—Tension” using die “D”. Specimens were cut from the cured (crosslinked) slab using Die D and tested at 23° C. at a separation rate of 500 millimeters/minute test rate using an MTS Insight Tensiometer (MTS Systems Corporation, Eden Prairie, Minn.) and equipped with a 1 kiloNewton load cell. The accompanying software, MTS TestWorks 4 (v. 4.12F) was used to calculate the tensile elongation at break (%) as well as tensile toughness, which was taken as the area under the stress-strain curve and reported in megapascals.

### Cylindrical Mandrel Bend

An uncured epoxy resin composition was applied onto the corona-treated surface of a silicone rubber sheet (Silicone Rubber 1) measuring 2.5 inches wide by 6 inches long (6.4 centimeters by 15.2 centimeters) using a knife coating apparatus to provide a coated thickness of 0.012 inch (0.3 millimeters), and then cured in an oven at 212° F. (100° C.) for one hour. After open face curing, the sample was evaluated for crack formation upon sample bending using an ELCOMETER 1506 cylindrical mandrel bend tester (ELCOMETER, Incorporated, Rochester Hills, Mich.) equipped with a 2 millimeter diameter Mandrel. The 2.5 inch (6.4 centimeter) wide end of the cured epoxy resin sample was clamped into the lower jaw of the Mandrel testing apparatus. The testing apparatus was then assembled in such a way that the coated sample was pinched between a roller and the Mandrel bar; followed by rotating the roller over the mandrel bar such that the coated sample was bent into an inverted “U” shape around the Mandrel (i.e., at an angle of approximately 180 degrees). The sample was then released from the apparatus and inspected for crack formation or delamination along the portion of the material that had been bent. If any cracks were present or there was observed delamination between the silicone rubber sheet and cured epoxy resin composition the result was recorded as “Fail”; if no cracks were present anywhere on the bent surface and no delamination was observed the result was recorded as “Pass.”

### Shore A Hardness

Shore A hardness of silicone rubber materials was determined according to ASTM D2240-15: “Standard Test Method for Rubber Property—Durometer Hardness.”

### Tan Delta (Dynamic Mechanical Analysis (DMA))

Dynamic mechanical analysis (DMA) was conducted using an RSA-G2 SOLIDS ANALYZER (TA Instruments, New Castle, Del.) equipped with tensile grips. Samples were cut to approximately 0.25 inch (0.64 centimeter) wide by 2 inches (5.1 centimeters) long. The length was oriented along the “grain” or machine direction. An initial static axial force of 0.2 Newtons was applied to remove any slack in the sample. The static axial force was always 50% greater than the dynamic oscillatory force, so that the sample was never subjected to compressive-mode deformations during the experiment. Temperature was controlled using a nitrogen-purged force convection oven. Liquid nitrogen was used to achieve sub-ambient temperatures. The sample was loaded at an initial test temperature of 50° C., and during the experiment the temperature was stepped downward in 10° C. increments to a final temperature of −60° C., with 3 minutes of equilibration at each step. At each temperature step, the sample was subjected to tensile oscillations at frequencies from 0.1 Hz to 10 Hz, with a strain of 0.05%. Auto-strain was applied to keep the oscillatory force within the bounds of 0.1 Newton and 1 Newton. The samples were found to follow linear viscoelastic behavior within this range of strains, such that the DMA properties measured were not a function of the applied strain. Master curves were constructed at a reference temperature of 20° C. using time-temperature superposition (TTS) principles. Results were plotted as a function of frequency. The frequency-sweep results at 20° C. were held stationary, while the frequency-sweep results at other temperatures were then horizontally shifted along the frequency axis such that the storage modulus (E′) results were superimposed on each other to form the master curve. The tan delta (δ) (defined as the value of the ratio of (loss modulus/storage modulus) (E″/E′)) at 10 kiloHertz and 20° C. was then determined from the master curve results. A higher tan delta value was taken as indicative of a greater toughness which is believed to contribute to resistance to erosion and destruction when exposed to HVOF spraying processes.

### Tear Resistance

The tear resistance of various silicone rubber substrates was tested according to ASTM D624: “Standard Test Method for Tear Strength of Conventional Vulcanized Rubber and Thermoplastic Elastomers” using Die B to provide test specimens of cured (crosslinked) material. These were evaluated at a rate of 500 millimeters/minute using a MTS Insight Tensiometer (MTS Systems Corporation, Eden Praire, Minn.) equipped with a 1 kiloNewton load cell. Data analysis was carried with the accompanying software, MTS TestWorks 4 (v. 4.12F). Three test specimens were evaluated and an average tear resistance was reported in kiloNewtons/meter.

### HVOF Spray

Type 304 stainless steel panels, measuring 14 inches long by 12 inches wide by 0.25 inch thick (35.6 centimeters by 30.5 centimeters by 0.64 centimeters) and having a 2B finish, were cleaned by wiping 3 to 5 times with methyl ethyl ketone using a lint free tissue then 3 to 5 times with heptanes using a lint free tissue. Two tape specimens measuring 1 inch by 2.5 inches (2.5 centimeters by 6.4 centimeters) were provided. They were placed at least two inches apart onto the cleaned stainless steel panel and rolled down with a rubber roller using hand pressure and then a hard, plastic squeegee to ensure intimate contact between the tape specimen and the stainless steel substrate as well as to remove air bubbles. The resulting test assembly of stainless steel test panel with two tape specimens thereon was allowed to dwell for approximately 4 days at room temperature. The test assembly was then etched using a grit blast process at a pressure of 35 pounds/square inch (241 Kilopascals), a standoff distance of between 3 and 4 inches, an abrasive grit of 36-grit virgin Aluminum Oxide (Illinois Valley Minerals, LLC, Tonica, Ill.), and a consistent sweeping hand motion with a Model PF-3648 PRO FINISH CABINET (available from Empire Abrasive Equipment Company, Langhorne, Pa.) to abrade the metal surface.

After etching (grit blasting) the test assembly was exposed to a powder of tungsten carbide:cobalt (88:12/w:w) particles having a nominal particle size of −45+5 micrometers (available under the trade designation DIAMALLOY 2004 from Oerlikon Metco, Pfaffikon, Switzerland) by means of a HVOF spray process using a DIAMOND JET Model DJ9W, natural gas fueled, water cooled unit, equipped with a DJC Control Unit, a 9MP-DJ Closed Loop Powder Feed Unit, a DJ8-9 Powder Injector, a DJ2701 Air Cap, and a DJ7-9 style 2700 Nozzle (all available from Oerlikon Metco, Pfaffikon, Switzerland) positioned at an angle of 75 to 88 degrees with respect to the test panel, and a powder feed rate of 5 pounds/hour (2.27 kilograms/hour) to apply approximately 0.0004 inches (10 micrometers) of material per pass. The spray pattern was controlled robotically with a Model ARC MATE 120i equipped with a SYSTEM R-J3 Model F-48941 CONTROLLER (available from FANUC America Corporation, Detroit, Mich.) programmed to run at a traverse speed of 1 meter/second and in increments of 4 millimeters such that the entire surface of the test assembly was completely spray coated. A cycle was defined as the complete coating of the test assembly in this manner. After between 5 and 8 cycles the tape specimen was evaluated to determine if the tape had been removed, such as by delamination, or was eroded so severely that it no longer prevented the underlying stainless steel panel from being coated or damaged by the spraying process. If neither of these conditions was observed the tape was deemed to have passed the number of cycles completed to that point, and the HVOF spraying process was resumed. Up to 28 cycles were run. In addition, the amount of rubber substrate worn away by the HVOF spraying process was also recorded. The results for the individual tape specimens and the average of the two specimens was reported. Groups of tape specimens were tested on the same day to permit comparison within the group. Although groups run on different days were found to exhibit slight variations from each other the general trends were still found to hold.

### HVOF Overlap Spray

Type 304 stainless steel panels, measuring 14 inches long by 12 inches wide by 0.25 inch thick (35.6 centimeters by 30.5 centimeters by 0.64 centimeters) and having a 2B finish, were cleaned by wiping 3 to 5 times with methyl ethyl ketone using a lint free tissue then 3 to 5 times with heptanes using a lint free tissue.

Two tape specimens measuring 1 inch by 4 inches (2.5 centimeters by 10.2 centimeters) were provided. The first tape specimen was placed onto the cleaned stainless steel panel and the second tape specimen was placed in an overlapping position adjacent to the first tape specimen such that it overlapped the first tape specimen by about 1.5 inches (3.8 centimeters) along the length of the first specimen. Both tape specimens were simultaneously rolled down with a rubber roller using hand pressure and then a hard, plastic squeegee to ensure intimate contact between the tape specimens and the stainless steel substrate as well as to minimize the gap between the two specimens at the overlap seam and remove air bubbles. A second pair of tape specimens was applied in the same manner at least two inches from the first pair on the same stainless steel substrate. The resulting test assembly of stainless steel test panel with tape specimens thereon was allowed to dwell for approximately 4 days at room temperature. The test assembly was then etched using a grit blast process at a pressure of 35 pounds/square inch (241 Kilopascals), a standoff distance of between 3 and 4 inches, an abrasive grit of 36-grit virgin Aluminum Oxide (Illinois Valley Minerals, LLC, Tonica, Ill.), and a consistent sweeping hand motion with a Model PF-3648 PRO FINISH CABINET (available from Empire Abrasive Equipment Company, Langhorne, Pa.) to abrade the metal surface.

After etching (grit blasting) the test assembly was exposed to a powder of tungsten carbide:cobalt (88:12/w:w) particles having a nominal particle size of −45+5 micrometers (available under the trade designation DIAMALLOY 2004 from Oerlikon Metco, Pfaffikon, Switzerland) by means of a HVOF spray process using a DIAMOND JET Model DJ9W, natural gas fueled, water cooled unit, equipped with a DJC Control Unit, a 9MP-DJ Closed Loop Powder Feed Unit, a DJ8-9 Powder Injector, a DJ2701 Air Cap, and a DJ7-9 style 2700 Nozzle (all available from Oerlikon Metco, Pfaffikon, Switzerland) positioned at an angle of 75 to 88 degrees with respect to the test panel, and a powder feed rate of 5 pounds/hour (2.27 kilograms/hour) to apply approximately 0.0004 inches (10 micrometers) of material per pass. The spray pattern was controlled robotically with a Model ARC MATE 120i equipped with a SYSTEM R-J3 Model F-48941 CONTROLLER (available from FANUC America Corporation, Detroit, Mich.) programmed to run at a traverse speed of 1 meter/second and in increments of 4 millimeters such that the entire surface of the test assembly was completely spray coated. A cycle was defined as the complete coating of the test assembly in this manner. After between 5 and 7 cycles the tape specimens were evaluated to determine if the tape had been removed, such as by delamination, or was eroded so severely that it no longer prevented the underlying stainless steel panel from being coated or damaged by the spraying process. If neither of these conditions was observed the tape was deemed to have passed the number of cycles completed to that point, and the HVOF spraying process was resumed. Up to 28 cycles were run. The results for both pairs of overlapping tape specimens and the average of the two pairs was reported. Groups of tape specimens were tested on the same day to permit comparison within the group. Although groups run on different days were found to exhibit some variations from each other the general trends were still found to hold.

### Corona Treatment of Silicone Substrates

Silicone rubber substrates were sometimes corona treated under an air atmosphere at a power level of 0.2 kilowatt and a feed rate of 30 feet/minute (9.1 meters/minute) to provide a total dosage of 0.32 Joule/square centimeter using a Model SS1908 Corona Treater from Enercon Industries Corporation (Menomonee Falls, Wis.).

### EXAMPLES

### Examples 1-3 and Comparative Example 1 (CE-1)

One-part epoxy resin bonding compositions were prepared using the materials and amounts shown in Table 1 as follows. The materials, except for FXR 1081, were added to a MAX 60 SPEEDMIXER cup (FlackTek, Incorporated, Landrum, S.C.) and mixed at 1,500 rpm for one minute using a DAC 600 FVZ SPEEDMIXER (FlackTek, Incorporated, Landrum, S.C.). To each mixture was then added FXR 1081 followed by further mixing at 1,500 rpm for one minute to obtain uncured epoxy resin bonding compositions.

TABLE 1
Uncured Epoxy Resin Bonding Compositions A, B, and CR-A

| | Material (weight %) | | | | | | | |
|---|---|---|---|---|---|---|---|---|
| Epoxy Resin | | | | | BPBA | | | |
| Composition | PY4122 | MX150 | OFS6040 | L07N | Solution | CE10P | FXR1081 | TMPMP |
| A | 53.00 | 0.00 | 2.00 | 0.00 | 3.00 | 8.00 | 7.00 | 27.00 |
| B | 38.11 | 11.83 | 1.77 | 3.54 | 0.00 | 8.81 | 8.88 | 27.06 |
| CR-A | 54.08 | 0.00 | 0.00 | 0.00 | 3.06 | 8.16 | 7.14 | 27.55 |

CR: Comparative Epoxy Resin

The peel adhesion strengths between various silicone rubbers and cured Epoxy Resin Compositions A and B, and cured Comparative Epoxy Resin Composition A were evaluated according to the test method “T-Peel Adhesion Strength—Method A” described above. The results are shown in Table 2 below.

TABLE 2
T-Peel Adhesion Strengths—Method A

| | | | | | | | T-Peel | |
|---|---|---|---|---|---|---|---|---|
| | Epoxy Resin | | Toughening | Silicone | Silicone | Surface | oz/in. | Failure |
| Ex. | Composition | Silane | Agent | Rubber | Cure Type | Treatment | (N/dm) | Mode |
| 1 | A | yes | no | 1 | Platinum | Corona | 76.5 | Cohesive |
| | | | | | | | (83.7) | |
| CE-1 | CR-A | no | no | 1 | Platinum | Corona | 24.2 | Cohesive |
| | | | | | | | (26.5) | |
| 2 | B | yes | yes | 1 | Platinum | Corona | 114.3 | Cohesive |
| | | | | | | | (125.1) | |
| 3 | B | yes | yes | 2 | Peroxide | Corona | 220.5 | Substrate |
| | | | | | | | (241.3) | |

Examples 2 and 3, which contained toughening agent, silane-functionalized adhesion promoter, and a flexible epoxy component exhibited the highest peel adhesion strengths. These results were observed on two different silicone rubber substrates. Example 1, which contained silane-functionalized adhesion promoter but not toughening agent, exhibited significantly higher peel adhesion strength relative to Comparative Example 1 which did not contain toughening agent or silane-functionalized adhesion promoter.

Examples 1, 2, and Comparative Example 1 were also evaluated for their tensile and crack resistance properties according to the “Tensile Properties—Method A” and “Cylindrical Mandrel Bend” test methods described above. The results are shown in Table 3 below. Comparative Example 1 failed the Mandrel Test due to delamination of the film from the silicone surface.

TABLE 3
Tensile and Mandrel Bend Properties

| | Epoxy Resin | Tensile Modulus | Tensile | Mandrel |
|---|---|---|---|---|
| Example | Composition | psi (MPa) | Elongation (%) | Test |
| 1 | A | 155 (1.1) | 252 | Pass |
| CE-1 | CR-A | 467 (3.2) | 246 | Fail |
| 2 | B | 133 (0.9) | 295 | Pass |

### Examples 4-6 and Comparative Examples 2 and 3 (CE-2 and CE-3)

One-part epoxy resin bonding compositions were prepared as described for Examples 1-3 and Comparative Example 1 using the materials and amounts shown in Table 4.

TABLE 4
Uncured Epoxy Resin Bonding Compositions C-E, CR-B, and CR-C

| | Material (weight %) | | | | | | | | |
|---|---|---|---|---|---|---|---|---|---|
| Epoxy Resin | | | | BPBA | | | | | |
| Composition | PY4122 | EPON828 | OFS6040 | Solution | CE10P | FXR1081 | TMPMP | ETTMP700 | PEMP |
| C | 0.00 | 43.25 | 2.00 | 3.00 | 8.00 | 7.00 | 36.75 | 0.00 | 0.00 |
| D | 61.90 | 0.00 | 2.00 | 3.00 | 0.00 | 7.00 | 26.10 | 0.00 | 0.00 |
| E | 0.00 | 36.80 | 2.00 | 3.00 | 0.00 | 7.00 | 0.00 | 51.20 | 0.00 |
| CR-B | 0.00 | 50.50 | 2.00 | 3.00 | 0.00 | 7.00 | 37.50 | 0.00 | 0.00 |
| CR-C | 0.00 | 52.30 | 2.00 | 3.00 | 0.00 | 7.00 | 0.00 | 0.00 | 35.70 |

CR: Comparative Epoxy Resin

The tensile properties of cured Epoxy Resin Compositions C, D, and E, and cured

Comparative Epoxy Resin Compositions B and C (CR-B and CR-C) were evaluated for their tensile and crack resistance properties according to the “Tensile Properties—Method A” and “Cylindrical Mandrel Bend” test methods described above. The results are shown in Table 5 below.

TABLE 5
Tensile and Mandrel Bend Properties

| | Epoxy Resin | Tensile Modulus | | Tensile | Mandrel |
|---|---|---|---|---|---|
| Example | Composition | psi (MPa) | | Elongation (%) | Test |
| 4 | C | 9838 | (68) | 214 | Pass |
| 5 | D | 148 | (1.0) | 203 | Pass |
| 6 | E | 477 | (3.3) | 135 | Pass |
| CE-2 | CR-B | 112,279 | (774) | 8 | Fail |
| CE-3 | CR-C | 113,620 | (783) | 6 | Fail |

For Examples 4, 5, and 6, the epoxy resin compositions were formulated to provide a flexible cured composition. In Example 4, a monofunctional epoxy diluent was introduced into the composition which lowered crosslink density and increased flexibility. In Example 5, a more flexible epoxy was used; and in Example 6 a more flexible thiol was used. Comparative Examples 2 and 3 were formulated using a less flexible epoxy and a less flexible thiol. In addition, neither one contained a flexibilizing diluent (i.e., a monofunctional epoxy resin). Comparative Examples 2 and 3 failed the “Cylindrical Mandrel Bend” test due to cracking of the film on the surface of the silicone.

### Examples 7 and 8

Two-part, room temperature curing epoxy resin bonding compositions were prepared using the materials and amounts shown in Tables 6 and 7 and provided as Part A (Base component) and Part B (Accelerator component). The materials were added to a MAX 60 SPEEDMIXER cup and mixed at 1,500 rpm for one minute using a DAC 600 FVZ SPEEDMIXER. The accelerator and base materials were prepared separately.

TABLE 6
Base Component (Part A)

| | Material (weight %) | | | |
|---|---|---|---|---|
| Example | PY4122 | MX150 | OFS6040 | CE10P |
| 7 | 65.0 | 18.5 | 2.8 | 13.7 |
| 8 | 65.0 | 18.5 | 2.8 | 13.7 |

TABLE 7
Accelerator Component (Part B)

| | Material (weight %) | | |
|---|---|---|---|
| Example | TMPMP | K54 | DBU |
| 8 | 96.5 | 3.5 | 0.0 |
| 9 | 96.5 | 0.0 | 3.5 |

The Base and Accelerator components were mixed in a 70:30/Base:Accelerator (w:w) ratio. T-Peel adhesion strength, tensile properties, and crack resistance of the cured epoxy resin compositions were evaluated according to the “T-Peel Adhesion Strength—Method A”, “Tensile Properties—Method A”, and “Cylindrical Mandrel Bend” test methods described above. Example 7 was cured 24 hours at room temperature to give a solid film which was then post-cured 30 minutes at 80° C., while Example 8 was cured for 24 hours at room temperature only. The results are shown in Tables 8 and 9 below. Both examples exhibited good bonding to the silicone substrates.

TABLE 8
T-Peel Adhesion Strength—Method A

| | | Toughen- | | Silicone | | T-Peel | |
|---|---|---|---|---|---|---|---|
| | | ing | Silicone | Cure | Surface | oz/inch | Failure |
| Ex. | Silane | Agent | Rubber | Type | Treatment | (N/dm) | Mode |
| 7 | yes | yes | 1 | Platinum | Corona | 118.9 | Co- |
| | | | | | | (130.1) | hesive |
| 9 | yes | yes | 1 | Platinum | Corona | 73.7 | Co- |
| | | | | | | (80.7) | hesive |

TABLE 9
Tensile and Mandrel Bend Properties

| | Tensile | | |
|---|---|---|---|
| | Modulus | Tensile | |
| | psi | Elongation | Mandrel |
| Example | (MPa) | (%) | Test |
| 7 | 60.0 (0.4) | 243 | Pass |
| 8 | 103.1 (0.7) | 156 | Pass |

### Example 9 and Comparative Example 4 (CE-4)

For Example 9, epoxy composition F, a one-part epoxy resin barrier composition, was prepared as described for Example 1 using the materials and amounts shown in Table 10. Composition F was then coated onto one side of a Silicone Rubber 1 substrate, which had been corona treated within one hour prior to coating, using a #8 wire wound Mayer rod and cured in a forced air oven for 25 minutes at 175° F. (79° C.). After about 48 hours, the epoxy coated side of the silicone rubber was laminated to a surface of 91022 silicone adhesive transfer tape which had been corona treated just prior to use. The lamination was carried out at a speed of 10 feet/minute (3 meters/minute) and a pressure of 30 pounds/square inch (207 kilopascals) on a 24 inch two roll W-G Laminator (Warman International, Incorporated, Madison, Wis.).

TABLE 10
Uncured Epoxy Resin Bonding Composition F

| Epoxy Resin | Material (weight %) | | | | | | | |
|---|---|---|---|---|---|---|---|---|
| Composition | EPON828 | MX150 | OFS6040 | L07N | CE10P | FXR1081 | ETTMP700 | Total |
| F | 26.15 | 8.09 | 1.21 | 2.42 | 6.12 | 6.07 | 49.94 | 100 |

For Comparative Example CE-4, SR500 was coated directly onto one side of a Silicone Rubber 1 substrate, which had been corona treated within one hour prior to coating, using a #8 wire wound Mayer rod and then dried in a forced air oven for 2 minutes at 200° F. (93° C.). After about 24 hours, the SR500 coated side of the silicone rubber was laminated to a surface of 91022 silicone adhesive transfer tape which had been corona treated just prior to use as described for Example 9.

The resulting tape articles having in order a silicone rubber substrate, a cured epoxy resin layer or cured silicone layer, and a silicone adhesive layer were evaluated according to the “Peel Adhesion Strength—Method A” test method described above both before and after aging. The aging conditions were one week at 150° F. (66° C.) in a forced air oven followed by 9 days at 73° F. (23° C.) and 50% RH. The results are shown in Table 11 below.

TABLE 11
Peel Adhesion Strength-Method A

| | | Peel | Retention |
|---|---|---|---|
| | Initial Peel | Adhesion | of Peel |
| | Adhesion | Strength | Adhesion |
| | Strength | After Aging | Strength |
| | oz/inch | oz/inch | After Aging |
| Example | (N/dm) | (N/dm) | (%) |
| 9 | 47.5 | 41.5 | 87 |
| | (52.0) | (45.4) | |
| CE-4 | 48.4 | 27.4 | 57 |
| | (53.0) | (30.0) | |

Example 9 exhibits a significantly greater retention of peel adhesion strength after aging relative to Comparative Example 4. This appears to be due to the ability of the epoxy resin layer to act as a barrier layer against any migrating components from the silicone adhesive layer.

### Example 10

Epoxy composition G, a one-part epoxy resin composition, was prepared using the materials and amounts shown in Table 12 as described for Example 1. Epoxy composition G was then cured and evaluated as described in the test methods “Tensile Properties—Method A” and “Cylindrical Mandrel Bend”. The results are shown in Table 13.

TABLE 12
Uncured Epoxy Resin Bonding Composition

| Epoxy Resin | Material (weight %) | | | | | | |
|---|---|---|---|---|---|---|---|
| Composition | PY4122 | OFS6040 | L07N | FXR1081 | TMPMP | BYK378 | Total |
| G | 64.09 | 1.77 | 3.54 | 4.5 | 26.0 | 0.1 | 100 |

TABLE 13
Tensile and Mandrel Bend Properties

| | Tensile | | |
|---|---|---|---|
| | Modulus | Tensile | |
| | psi | Elongation | Mandrel |
| Example | (MPa) | (%) | Test |
| 10 | 83.2 (0.6) | 407 | Pass |

### Example 11

A sample of Silicone Rubber 1 was heat treated in an oven at 380° F. (193° C.) for 15 minutes, allowed to cool to room temperature, and corona treated on one side no more than 24 hours before use. The corona treated surface of Silicone Rubber 1 was coated with Composition G, prepared as described in Example 10, using a #24 wire wound Mayer rod, and cured in a forced air oven for 6 minutes at 120° C. A silicone rubber substrate, corona treated on one side, and having a cured epoxy layer on the treated side was obtained.

A room temperature vulcanizing (RTV) silicone composition I was prepared using the materials and amounts shown in Table 14 as follows. The materials were added, in order, to a MAX 300 SPEEDMIXER cup and mixed using a DAC 600 FVZ, SPEEDMIXER for 30 seconds at 2350 rpm. The resulting mixture has been described in its product literature as a pourable, addition curing, two component silicone rubber having an approximate viscosity at 23° C. of 30,000 centipoise.

TABLE 14
RTV Silicone Composition

| | Material (weight %) | | |
|---|---|---|---|
| RTV Silicone | RTV | RTV | Cure |
| Composition | Part A | Part B | Inhibitor |
| I | 88.16 | 8.81 | 3.03 |

The exposed surface of the silicone rubber substrate, having a cured epoxy layer on the opposite side, was coated with the RTV silicone composition I using a #3 wire wound Mayer rod and cured in a forced air oven for 3 minutes at 120° C. The target cured coating weight was 7 grains/24 square inches (29.3 grams/square meter). The resulting cured RTV silicone layer has been described in its product literature as having a Shore A hardness of 43, tensile strength greater than 650 pounds/square inch (4.5 megapascals), an elongation at break greater than 300%, and a tear strength of greater than 140 pounds/inch (245 Newtons/centimeter) after 24 hours at 23° C.

The resulting coated article having a cured RTV silicone layer on one side of the silicone rubber substrate and a cured epoxy layer on the opposite side was thereby provided.

An aminosilane-treated organo-silica sol composition J, was prepared using the materials and amounts shown in Table 15 as follows. The materials were combined, mixed using a magnetic stirrer, and used about one week later.

TABLE 15
OrganoSilica Sol Composition

| | Material (weight %) | | |
|---|---|---|---|
| OrganoSilica Sol | Organo-Silica | | |
| Composition | Sol | APS-1 | IPA |
| J | 7.92 | 0.13 | 91.95 |

The exposed surface of the RTV silicone layer was then coated with the aminosilane-treated organo-silica sol composition J using a #18 wire wound Mayer rod, then dried for 5 minutes at 149° C. in a forced air oven.

A silicone rubber substrate having on one side a cured epoxy layer and on the opposite side a cured RTV silicone layer and having an organo-silica layer on the side of the RTV opposite that in contact with the silicone rubber substrate was obtained.

A solution of dibenzoyl peroxide in toluene, Composition K, was prepared using the materials and amounts shown in Table 16 as follows. The materials were combined and mixed on a two-speed reciprocal shaker (Eberbach, Ann, Arbor, Mich.) on the low setting for 20 minutes.

TABLE 16
Dibenzoyl Peroxide Solution

| Dibenzoyl | Material (weight %) | |
|---|---|---|
| Peroxide | Benzoyl | |
| Solution | Peroxide | Toluene |
| K | 10.40 | 89.60 |

A solution of an uncured silicone pressure sensitive adhesive solution in toluene, Composition L, was prepared using the materials and amounts shown in Table 17 as follows. The materials were added to a glass jar which was then sealed and placed on roller mixer for at least 16 hours. Next, a just prepared dibenzoyl peroxide solution, composition K, was added to composition L and mixed using an air-driven mixer for about 5 minutes. The resulting solution was coated onto the silicone treated side of a Release Liner using a notch bar coater having a gap setting of 0.0075 inches (191 micrometers) greater than the thickness of the Release Liner and dried for 3 minutes at 176° F. (80° C.) then cured at 310° F. (154° C.) for 3 minutes in a forced air oven. A second Release Liner was applied with its silicone treated surface in contact with the exposed, cured PSA surface to provide a silicone pressure sensitive adhesive transfer tape (ATT).

TABLE 17
Silicone Pressure Sensitive Adhesive (PSA)

| | Material (weight %) | | | |
|---|---|---|---|---|
| Silicone | | | Benzoyl | |
| Pressure | | | Peroxide | |
| Sensitive | Silicone | Silicone | Solution | |
| Adhesive | PSA | Resin | (Composition K) | Toluene |
| L | 80.41 | 1.64 | 8.87 | 9.09 |

One of the Release Liners was removed from PSA transfer tape thus prepared and the exposed surface of the PSA was corona treated in an air atmosphere at a power level of 0.2 kilowatt and a rate of 30 feet/minute (9.1 meters/minute) to provide a total dosage of 0.32 Joule/square centimeter using a Model SS1908 Corona Treater (Enercon Industries Corporation, Menomonee Falls, Wis.). The PSA was corona treated no more than 10 minutes before use.

The exposed, corona treated side of the PSA transfer tape was then laminated onto the epoxy layer of the silicone rubber substrate prepared above having on one side a cured epoxy layer and on the opposite side a cured RTV silicone layer and having an organo-silica layer on the side of the RTV opposite that in contact with the silicone rubber substrate. The lamination was carried out at a speed of 10 feet/minute (3 meters/minute) and a pressure of 30 pounds/square inch (207 kilopascals) on a 24 inch two roll W-G Laminator (Warman International, Incorporated, Madison, Wis.). In this manner a pressure sensitive adhesive tape article was obtained having the following layers: a silicone rubber substrate having on one side a cured epoxy layer in contact with the silicone substrate and a silicone pressure sensitive adhesive layer on the opposite side of the epoxy layer, and on the opposite side of the silicone rubber substrate a cured RTV silicone layer and an organo-silica layer on the side of the RTV opposite that in contact with the silicone rubber substrate.

### Comparative Example 5 (CE-5)

Example 11 was repeated with the following modifications. No RTV silicone or organo-silica layers were used. Instead, the exposed surface of the silicone rubber substrate, opposite the side having the cured epoxy layer thereon, was corona treated within 1 hour prior to use. SR500 was coated directly onto exposed, treated surface of silicone rubber substrate using a #8 wire wound Mayer rod, then dried in a forced air oven for 2 minutes at 200° F. (93° C.). After lamination of the PSA transfer tape to the epoxy layer the sample was allowed to stand for about 48 hours before use.

### Examples 12-22

Example 11 was repeated with the following modifications. No RTV silicone or organo-silica layers were used.

A summary of the constructions of Examples 11-22 and Comparative Example 5 is shown in Table 18.

TABLE 18
Constructions of Examples 11-22 and Comparative Example 5

| | | | Flexible | | | |
|---|---|---|---|---|---|---|
| | | | Intermediate | Elastomeric | | |
| Example | Liner | PSA | Layer | Backing Layer | Primer Layer | Top Layer |
| 11 | Release | Silicone | Epoxy | Silicone Rubber 1 | RTV Silicone | Organo-Silica |
| | Liner | | | | | |
| CE-5 | Release | Silicone | Epoxy | Silicone Rubber 1 | None | SR500 |
| | Liner | | | | | |
| 12 | Release | Silicone | Epoxy | Silicone Rubber 2 | None | None |
| | Liner | | | | | |
| 13 | Release | Silicone | Epoxy | Silicone Rubber 3 | None | None |
| | Liner | | | | | |
| 14 | Release | Silicone | Epoxy | Silicone Rubber 4 | None | None |
| | Liner | | | | | |
| 15 | Release | Silicone | Epoxy | Silicone Rubber 5 | None | None |
| | Liner | | | | | |
| 16 | Release | Silicone | Epoxy | Silicone Rubber 6 | None | None |
| | Liner | | | | | |
| 17 | Release | Silicone | Epoxy | Silicone Rubber 7 | None | None |
| | Liner | | | | | |
| 18 | Release | Silicone | Epoxy | Silicone Rubber 8 | None | None |
| | Liner | | | | | |
| 19 | Release | Silicone | Epoxy | Silicone Rubber 9 | None | None |
| | Liner | | | | | |
| 20 | Release | Silicone | Epoxy | Silicone Rubber 10 | None | None |
| | Liner | | | | | |
| 21 | Release | Silicone | Epoxy | Silicone Rubber 11 | None | None |
| | Liner | | | | | |
| 22 | Release | Silicone | Epoxy | Silicone Rubber 12 | None | None |
| | Liner | | | | | |

The tape articles of Examples 11-22 and Comparative Examples 5-9 were evaluated as described in the test methods above and reported in Table 19 below. In addition, properties of the rubber substrates are also reported. Comparative Examples 6-10 were Commercial Tapes 1-5 (CT1-CT5) respectively.

TABLE 19
Tape and Rubber Substrate Properties

| | Tape Properties | | | | | | | |
|---|---|---|---|---|---|---|---|---|
| | HVOF | | Tape | | | | | |
| | Spray | HVOF | Elongation | Silicone Rubber Substrate Properties | | | | |
| | Cycles | Spray | at Break | Rubber | | | | Tensile |
| | Passed | Erosion | (Method | Elongation | Tear | | | Toughness |
| | (each tape | inches | B) | at Break | Resistance | Tan | Shore A | (MPa) |
| Ex. | specimen) | (mm) | (%) | (%) | (kN/m) | delta | Hardness | (Method C) |
| 11 | 25 | 0.0070 | 1043 | 780 | 49.0 | 0.099 | 62 | 38.7 |
| | | (0.18) | | | | | | |
| 12 | 25 | 0.0082 | 881 | 640 | 39.2 | 0.123 | 58 | 29.3 |
| | | (0.21) | | | | | | |
| 13 | 25 | 0.0091 | 1022 | 700 | 56.0 | 0.096 | 72 | 36.4 |
| | | (0.23) | | | | | | |
| 14 | 25 | 0.0103 | 719 | 600 | 52.0 | 0.105 | 77 | 29.3 |
| | | (0.26) | | | | | | |
| 15 | 25 | 0.0018 | 831 | 740 | 51.0 | 0.122 | 65 | 37.9 |
| | | (0.05) | | | | | | |
| 16 | 25 | 0.0100 | 404 | 410 | 20.3 | 0.091 | 69 | 21.2 |
| | | (0.25) | | | | | | |
| 17 | 25 | 0.0085 | 600 | 625 | 30.3 | 0.097 | 64 | 30.5 |
| | | (0.22) | | | | | | |
| 18 | 25 | 0.0095 | 962 | 730 | 37.2 | 0.098 | 62 | 36.8 |
| | | (0.24) | | | | | | |
| 19 | 25 | 0.0040 | 908 | 1035 | 40.6 | 0.110 | 50 | 57.0 |
| | | (0.10) | | | | | | |
| 20 | 25 | 0.0088 | 1049 | 900 | 46.6 | 0.090 | 61 | 48.8 |
| | | (0.22) | | | | | | |
| 21 | 25 | 0.0098 | 689 | 600 | 23.8 | 0.081 | 52 | 30.9 |
| | | (0.25) | | | | | | |
| 22 | 25 | 0.0141 | 168 | 340 | 26.0 | 0.048 | 46 | 13.4 |
| | | (0.36) | | | | | | |
| CE | ND | ND | 5 | ND | ND | ND | ND | ND |
| 6 | | | | | | | | |
| CE | ND | ND | 12 | ND | ND | ND | ND | ND |
| 7 | | | | | | | | |
| CE | ND | ND | 6 | ND | ND | ND | ND | ND |
| 8 | | | | | | | | |
| CE | <8 | ND | 4 | ND | ND | ND | ND | ND |
| 9 | | | | | | | | |
| CE | <24* | 0.0140 | 4 | ND | ND | ND | ND | ND |
| 10 | | (0.36) | | | | | | |

ND: not determined
*visual appearance on top surface appeared acceptable but tape could not be cleanly removed and damage was observed on the underlying stainless steel panel.

The tape articles of Example 11 and Comparative Example 5 were further evaluated as described in the test method “HVOF Overlap Spray”. The results are shown in Table 20.

TABLE 20
HVOF Overlap Spray Properties

| | | | Average |
|---|---|---|---|
| | Sample #1 | Sample #2 | Number of |
| | Spray | Spray | Spray |
| | Cycles | Cycles | Cycles |
| Example | Passed | Passed | Passed |
| 11 | 21 | 21 | 21 |
| CE-5 | 13 | 9 | 11 |

The tape article of Example 11 was further aged and evaluated for peel adhesion per the test method “Peel Adhesion Strength—Method B”. The results are shown in Table 21.

TABLE 21
Peel Adhesion Strength-Method B

| | | Aging: | Aging: | Aging: |
|---|---|---|---|---|
| | Initial | Condition A | Condition B | Condition C |
| | oz/inch | oz/inch | oz/inch | oz/inch |
| Example | (N/dm) | (N/dm) | (N/dm) | (N/dm) |
| 11 | 25.7 | 22.0 | 20.1 | 21.5 |
| | (28.1) | (24.1) | (22.0) | (23.5) |

### Examples 23-27

Solutions were prepared as follows: APS-1 was diluted to 2.5 and 5.0 weight percent in IPA and mixed using a magnetic stirrer. Organo-Silica Sol was separately diluted to 2.5 and 5.0 weight percent in IPA and mixed using a magnetic stirrer. The 2.5 weight percent and 5.0 weight percent APS-1 solutions were combined with the corresponding 2.5 weight percent and 5.0 weight percent Organo-Silica Sol solutions in the ratios and solution weight percentages shown in Table 22 and mixed using a magnetic stirrer. The resulting mixtures were coated onto separate samples of Silicone Rubber 1 having a nominal thickness of 0.025 inch (0.64 millimeters) using a #18 wire wound Mayer rod, then dried and cured for 5 minutes at 149° C. in a forced air oven for 5 minutes. Silicone rubber substrates with a top layer coating were thereby provided. These were evaluated as described in the test methods “Peel Adhesion Strength—Method C” and “T-Peel Adhesion Strength—Method B”. The results are shown in Table 22.

TABLE 22
Peel Adhesion Strengths

| | | | | T-Peel Adhesion | |
|---|---|---|---|---|---|
| | | | Peel | Strength | |
| | Organo-Silica Sol/ | Weight | Adhesion | (Method B) | |
| | APS-1 Ratio | Percent | Strength- | | Failure |
| Example | (w:w) | Solids | Method C | Result | Mode |
| 23 | 100% Organo-Silica | 5.0 | ND | Pass | Cohesive |
| 24 | 97.5:2.5 | 2.5 | Pass | Pass | Cohesive |
| 25 | 97.5:2.5 | 5.0 | Pass | Pass | Cohesive |
| 26 | 95:5 | 2.5 | Pass | Pass | Cohesive |
| 27 | 95:5 | 5.0 | Pass | Pass | Cohesive |

### Examples 28 and 29

N1115 was mixed with deionized water to form a 5 weight percent solids solution. Approximately 20 grams of IEx was added to approximately 100 grams of the N1115 solution. The pH of the resulting solution was 4.2-5.0. This was filtered to remove the IEx particles. Nitric acid was then added to obtain a solution pH of 2.0-3.0. Next, 80 grams of this pH adjusted solution was combined with 0.2 grams of ES, followed by addition of 2.0 grams of a solution of 10 weight percent aluminum nitrate in deionized water. This solution was coated onto the corona treated (air) side of a sample of 0.025 inch (0.63 millimeters) thick Silicone Rubber 1 substrate using a #18 wire wound Mayer rod, then dried and cured at 149° C. in a forced air oven for 5 minutes. A coated article having a Silicone Rubber 1 substrate with a top layer coating was thereby provided. This was evaluated as described in the test methods “Peel Adhesion Strength—Method C” and “T-Peel Adhesion Strength—Method B”. The results are shown in Table 23.

TABLE 23
Peel Adhesion Strengths

| | Peel Adhesion | | T-Peel | |
|---|---|---|---|---|
| | Strength | | Adhesion | |
| | (Method C) | | Strength | Failure |
| Example | Time | Result | (Method B) | Mode |
| 28 | 1 day | Pass | Pass | Cohesive |
| 29 | 18 days | Pass | Pass | Cohesive |

### Examples 30-32

Three identical stock solutions (A1-A3) were prepared by mixing 264 grams deionized water and 0.58 grams of ammonium hydroxide (29% concentration) and stirring magnetically. Aliquots B1-B3, 40 grams each, of stock solutions A1-A3 were set aside. To the remainder of stock solutions A1-A3 were added 0.82 grams of X-100 followed by magnetic stirring. Next, 37.1 grams of N1115 was added to each solution with magnetic stirring to provide solutions C1-C3. To aliquots B1-B3 were add 0.24 grams, 0.48 grams, and 0.96 grams respectively of APS-2 which were then stirred magnetically stirred to provide solutions D1-D3. Next, solutions D1-D3 were added to solutions C1-C3 respectively to provide three different top layer coating solutions, E1-E3, having the N1115:APS-2 weight ratios shown in Table 24. These were then coated using a #18 wire wound Mayer rod onto the corona treated (air) side of a sample of 0.025 inch (0.63 millimeters) thick Silicone Rubber 1 substrate, then dried and cured at 149° C. in a forced air oven for 5 minutes. Coated articles having a Silicone Rubber 1 substrate with a top layer coating were thereby provided. These were evaluated as described in the test method “T-Peel Adhesion Strength—Method B”. The results are shown in Table 24.

### Example 33

Example 31 was repeated with the following modification. N2326 was used in place of N1115. The resulting top layer coated Silicone Rubber 1 substrate was evaluated as described in the test method “T-Peel Adhesion Strength—Method B”. The results are shown in Table 24.

TABLE 24
T-Peel Adhesion Strength-Method B

| | | T-Peel Adhesion | |
|---|---|---|---|
| | | Strength | |
| | Silica:APS-2 | (Method B) | |
| Example | (w:w) | Result | Failure Mode |
| 30 | N1115:APS-2/ | Pass | Cohesive |
| | 98:2 | | |
| 31 | N1115:APS-2/ | Pass | Cohesive |
| | 96:4 | | |
| 32 | N1115:APS-2/ | Pass | Cohesive |
| | 92:8 | | |
| 33 | N2326:APS-2/ | Pass | Cohesive |
| | 96:4 | | |

### Examples 34 and 35

APS-1 and TMOS were individually diluted to 10% solids by weight in methanol. The TMOS/methanol solution and APS-1/methanol solution were combined and magnetically stirred to provide a solution having a ratio of TMOS:APS-1/90:10 (w:w). A similar procedure was used to prepare an 80/20 example. Stirred magnetically. The resulting solutions, were then coated using a No. 12 wire wound Mayer rod onto the corona treated (air) side of a sample of 0.025 inch (0.63 millimeter) thick Silicone Rubber 1 substrate, and dried and cured at 100° C. for 5 minutes. The resulting top layer coated Silicone Rubber 1 substrates were evaluated as described in the test method “Peel Adhesion Strength—Method B” with the following modification. The Test Tape article, described in the test method “T-Peel Adhesion Strength—Method B”, was applied to the first coated silicone rubber substrate attached to the stainless steel panel. The results are shown in Table 25.

TABLE 25
Peel Adhesion Strength-Method B*

| | | Peel Adhesion |
|---|---|---|
| | | Strength |
| | TMOS:APS-1 | (Method B*) |
| Example | (w:w) | oz/inch (N/dm) |
| 34 | 90:10 | 52.1 (57.0) |
| 35 | 80:20 | 48.3 (52.9) |

*using Test Tape article from “T-Peel Adhesion Strength-Method B”

### Examples 36-39

Organo-Silica Sol, ES, VS and TMOS were individually diluted with IPA to give solutions A-D respectively, each containing 5 weight percent by solids. A blend of EPON 828 and GPM-800L0 in a ratio of 10:9 (w:w) was combined at 5 weight % solids in toluene to provide mixture E. K61B was diluted with toluene to provide a 5% by weight solution, F. Mixture E and solution F were combined in a ratio of 97:3 (w:w) to provide an epoxy/mercaptan solution, G. SR 500 was diluted with toluene to provide a 5% by weight solution, H. A binder resin solution I was prepared by diluting Silicone PSA with toluene to give a 5 weight percent by solids solution. To binder resin solution I was added 2.0 percent by solid weight of dibenzoyl peroxide (DBPO) to give a curable binder resin solution J. Solutions A-D, G, H, and J were used in the amounts shown in Table 26. The resulting solutions were coated using a #18 wire wound Mayer rod onto one side of a sample of 0.025 inch (0.63 millimeters) thick Silicone Rubber 1 substrate, then dried and cured at 149° C. in a forced air oven for 5 minutes. Silicone Rubber 1 substrates having top layer coatings were thereby provided. These were evaluated as described in the test method “T-Peel Adhesion Strength—Method B”. The results are shown in Table 26.

TABLE 26
Peel Adhesion Strengths

| | | Peel | | T-Peel Adhesion | |
|---|---|---|---|---|---|
| | | Adhesion | | Strength | |
| | | Strength | | (Method B) | |
| | Composition | (Method C) | | | Failure |
| Examples | (w:w:w) | Time | Result | Result | Mode |
| 36 | Organo-Silica Sol: | 9 days | Pass | Pass | Cohesive |
| | ES:SR500 | | | | |
| | 86.5:4.5:9.0 | | | | |
| 37 | Organo-Silica Sol: | 4 days | Pass | Pass | Cohesive |
| | ES:TMOS | | | | |
| | 86.5:4.5:9.0 | | | | |
| 38 | Organo-Silica Sol: | 7 days | Pass | Pass | Cohesive |
| | ES:EM | | | | |
| | 86.5:4.5:9.0 | | | | |
| 39 | Organo-Silica Sol: | 3 days | Pass | Pass | Cohesive |
| | VS:PSA | | | | |
| | 86.5:4.5:9.0 | | | | |

The referenced descriptions contained in the patents, patent documents, and publications cited herein are incorporated by reference in their entirety as if each were individually incorporated. Various unforeseeable modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only, with the scope of the disclosure intended to be limited only by the claims set forth herein as follows.

1. A tape comprising:
an elastomeric backing layer having two major surfaces, wherein the backing layer comprises a high consistency silicone rubber elastomer;
a flexible intermediate layer disposed on a first major surface of the backing layer, wherein the flexible intermediate layer comprises a cured epoxy-based material; and
a pressure sensitive adhesive layer disposed on the flexible intermediate layer, wherein the pressure sensitive adhesive layer comprises a silicone pressure sensitive adhesive;
wherein the tape has a tensile elongation of at least 100%, according to the Tensile Properties—Method B Test.

2. The tape of claim 1 which is a masking tape.

3. The tape of claim 1, wherein the elastomeric backing layer is a non-fiber reinforced backing layer.

4. The tape of claim 1, wherein the flexible intermediate layer provides a barrier and/or a primer function.

5. The tape of claim 1, wherein the flexible intermediate layer comprises one or more layers.

6. The tape of claim 1, wherein the flexible intermediate layer comprises a cured epoxy-based material prepared from a curable epoxy/thiol resin composition.

12. The tape of claim 11, wherein the primer layer comprises a silicone.

13. The tape of claim 1, wherein the top layer comprises an inorganic oxide matrix and an optional organic binder.

14. The tape of claim 13, wherein the inorganic oxide matrix comprises a silica network.

15. The tape of claim 14, wherein the silica network is formed from silica nanoparticles and a coupling agent.

16. The tape of claim 13, wherein the inorganic oxide matrix comprises the product of hydrolysis and condensation of a hydrolyzable organosilicate in the presence of hydrolyzable organosilane.

17. A tape comprising:
an elastomeric backing layer having two major surfaces, wherein the backing layer comprises a high temperature resistant and flame resistant elastomer;
a pressure sensitive adhesive layer disposed on a first major surface of the elastomeric backing layer, wherein the pressure sensitive adhesive layer comprises a silicone pressure sensitive adhesive; and
a top layer comprising an inorganic oxide network disposed on a second major surface of the elastomeric backing layer.

18. A tape comprising:
an elastomeric backing layer having two major surfaces, wherein the backing layer comprises a high consistency silicone rubber elastomer;
a first pressure sensitive adhesive layer disposed on a first major surface of the elastomeric backing layer, wherein the first pressure sensitive adhesive layer comprises a silicone pressure sensitive adhesive; and
a second pressure sensitive adhesive layer disposed on a second major surface of the elastomeric backing layer, wherein the second pressure sensitive adhesive layer comprises a silicone pressure sensitive adhesive;
wherein the tape has a tensile elongation of at least 100%, according to the Tensile Properties—Method B Test.

19. The tape of claim 17, wherein the tape possesses resistance to flames and high temperature breakdown.

20. The tape of claim 19, wherein the tape possesses resistance to flames, high temperature breakdown, high velocity particles and gases, and high gas pressures that occur when used during an HVOF thermal spray coating process.
